(19) United States
(12) Patent Application Publication
(10) Pub. No.: US 2024/0231169 A1
(43) Pub. Date: Jul. 11, 2024

(54) OPTOELECTRONICALLY DYNAMIC ELEMENT COMPRISING NON-AQUEOUS ZINC-BASED ELECTROLYTE FOR REVERSIBLE ZINC ELECTRODEPOSITION

(71) Applicants: Board of Regents of the Nevada System of Higher Education, on behalf of the University of Nevada, Reno, NV (US); Tynt Technologies, Inc., Boulder, CO (US)

(72) Inventors: Christopher J. Barile, Reno, NV (US); Nikhil C. Bhoumik, Reno, NV (US); Tyler Hernandez, Boulder, CO (US)

(73) Assignees: Board of Regents of the Nevada System of Higher Education, on behalf of the University of Nevada, Reno, NV (US); Tynt Technologies, Inc., Boulder, CO (US)

(21) Appl. No.: 18/405,478

(22) Filed: Jan. 5, 2024

Related U.S. Application Data
(60) Provisional application No. 63/437,621, filed on Jan. 6, 2023.

(51) Int. Cl. G02F 1/155; G02F 1/163

(52) U.S. Cl. CPC G02F 1/155; G02F 1/163

(57) ABSTRACT

Disclosed herein are optoelectronically dynamic elements (e.g., windows, films, lenses, flat-panel displays, polymer-based electronics, thin film photovoltaics, glass doors, tools/devices used in X-ray diffraction and scanning electron microscopy analysis, among others) comprising non-aqueous zinc-based electrolytes that facilitate reversible zinc electrodeposition on the element. The disclosed non-aqueous zinc-based electrolytes are used in combination with a transparent working electrode and a counter electrode and facilitate depositing layers of zinc on the transparent working electrode so as to rapidly form an opaque zinc-containing coating on the working electrode upon application of a suitable voltage. The opaque zinc-containing coating can be rapidly stripped from the working electrode transitioning it back to a transparent state upon application of a suitable voltage. Also disclosed are methods of making and using the disclosed non-aqueous zinc-based electrolyte and elements described herein.

### CROSS REFERENCE TO RELATED APPLICATION

This application claims the benefit of and priority to U.S. Provisional Patent Application No. 63/437,621 filed on Jan. 6, 2023, the entirety of which is incorporated herein by reference.

### ACKNOWLEDGMENT OF GOVERNMENT SUPPORT

This invention was made with government support under Grant No. DE-EE0009701 awarded by the Department of Energy. The government has certain rights in the invention.

### FIELD

The present disclosure is directed to optoelectronically dynamic elements comprising non-aqueous zinc-based electrolytes that facilitate the reversible electrodeposition of zinc metal on transparent conducting electrodes with excellent optical contrast and enhanced cycle life.

### BACKGROUND

Buildings are responsible for about 40% of U.S. energy consumption. Dynamic windows that switch between transparent and opaque states on demand are a technology that can significantly increase the energy efficiency of buildings. Studies have shown that replacing current low-emissivity static windows with current electronically-controlled dynamic windows results in an average of 20% reduction in energy use in buildings through lighting, heating, and cooling savings. Dynamic windows also could be used to increase the energy efficiency of automobiles, which is especially important for battery-powered electric vehicles. Current materials used in dynamic windows, however, have drawbacks that have minimized the ability to harness this type of technology on large scale and/or in certain application. Such drawbacks can include, but are not limited to, slow switching between transparent and opaque states, low durability, high manufacturing cost, and poor shelf life.

There exists a need in the art for new electrolytes that can be used for dynamic materials (e.g., windows and the like) and that address drawbacks associated with current materials.

### SUMMARY

Disclosed herein is an optoelectronically dynamic element, comprising: a transparent working electrode comprising a first working electrode surface and a second working electrode surface; a counter electrode comprising a metal and a first counter electrode surface and a second counter electrode surface; and a non-aqueous zinc-based electrolyte positioned between the first working electrode surface and the first counter electrode surface, the non-aqueous zinc-based electrolyte comprising (i) a polar aprotic solvent and (ii) a zinc salt and/or ions thereof, wherein (i) the first working electrode surface faces the first counter electrode surface, and (ii) wherein the transparent working electrode comprises an opaque zinc-containing coating deposited directly or indirectly on the first working electrode surface when a voltage ranging from −3.0V to −0.1V is applied to the optoelectronically dynamic element.

Methods of making and using the non-aqueous zinc-based electrolytes according to the present disclosure are also disclosed.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 provides a schematic illustration of an optoelectronically dynamic element and the components that form the element, along with a summary of the electrochemical reactions that takes place at the working electrode and counter electrode components according to aspects of the present disclosure.

FIG. 2 provides a schematic illustration of an optoelectronically dynamic element comprising a conductive metal oxide material according to certain aspects of the present disclosure.

FIG. 3 provides a schematic illustration of the formation and stripping of the reversible opaque zinc-containing coating on a working electrode in an optoelectronically dynamic element according to aspects of the disclosure.

FIGS. 4A and 4B show cyclic voltammograms (FIG. 4A) and corresponding transmission results at 600 nm (FIG. 4B) of Pt-modified ITO electrodes at a scan rate of 25 mV s⁻¹ in DMSO electrolytes containing (i) 100 mM ZnBr₂, (ii) 100 mM Zn(CH₃COO)₂, or (iii) 100 mM NACH₃COO.

FIGS. 5A and 5B show cyclic voltammograms (FIG. 5A) and corresponding transmission results at 600 nm (FIG. 5B) of Pt-modified ITO electrodes at a scan rate of 25 mV s⁻¹ in DMSO electrolytes containing (i) 100 mM ZnBr₂ and 100 mM Zn(CH₃COO)₂, (ii) 100 mM Zn(CH₃COO)₂ and 100 mM NACH₃COO, or (iii) 100 mM ZnBr₂ and 100 mM NACH₃COO.

FIGS. 6A and 6B show cyclic voltammograms (FIG. 6A) and corresponding transmission results at 600 nm (FIG. 6B) of Pt-modified ITO electrodes at a scan rate of 25 mV s⁻¹ in DMSO electrolytes containing (i) 100 mM ZnBr₂, 100 mM Zn(HCOO)₂, and 133 mM NaHCOO; (ii) 100 mM ZnBr₂, 100 mM Zn(HCOO)₂, and 133 mM NaCH₃COO; and (iii) 100 mM ZnCl₂, 100 mM Zn(CH₃COO)₂, and 133 mM NACH₃COO.

FIGS. 7A and 7B show cyclic voltammograms (FIG. 7A) and corresponding transmission results at 600 nm (FIG. 7B) of Pt-modified ITO electrodes at a scan rate of 25 mV s⁻¹ in DMSO electrolytes containing 300 mM ZnBr₂, 300 mM Zn(CH₃COO)₂, and 400 mM NACH₃COO; or 300 mM ZnBr₂, 300 mM Zn(CH₃COO)₂, and 400 mM NaCH₃CH₂COO.

FIGS. 8A-8D show scanning electron micrographs of Zn electrodeposits produced from a DMSO electrolyte containing 300 mM ZnBr₂, 300 mM Zn(CH₃COO)₂, and 400 mM NaCH₃CH₂COO using chronoamperometry at −0.9 V until the electrode transmission is equal to 10% (FIGS. 8A and 8B) and 1% (FIGS. 8C and 8D).

FIGS. 9A-9D show results for transmission (FIG. 9A), outdoor reflectance (FIG. 9B), indoor reflectance (FIG. 9C) of a two-electrode optoelectronically dynamic element (e.g., a Zn dynamic window) using a DMSO electrolyte containing 300 mM ZnBr₂, 300 mM Zn(CH₃COO)₂, and 400 mM NACH₃COO after tinting at −0.9 V for 0 seconds, 5 seconds, 10 seconds, 30 seconds, and 300 seconds; transmission of the same window after 300 seconds of tinting over time with the device at rest (FIG. 9D).

FIGS. 10A and 10B show transmission at 600 nm (FIG. 10A) and chronoamperometry (FIG. 10B) of a Zn dynamic window using a DMSO electrolyte containing 300 mM ZnBr₂, 300 mM Zn(CH₃COO)₂, and 400 mM NACH₃COO during tinting at −0.9 V for 300 seconds followed by lightening at +1.0 V for 200 seconds.

FIG. 11 shows haze percent of a Zn dynamic window using a DMSO electrolyte containing 300 mM ZnBr₂, 300 mM Zn(CH₃COO)₂, and 400 mM NACH₃COO during metal electrodeposition at −0.9 V followed by metal stripping at 1.0 V.

FIGS. 12A-12C show transmission (FIG. 12A) and reflectance (FIG. 12B) of a Zn dynamic window using a DMSO electrolyte containing 300 mM ZnBr₂, 300 mM Zn(CH₃COO)₂, and 400 mM NACH₃COO after tinting at −0.9 V for 0 seconds (clear) and 300 seconds (dark); and wherein FIG. 12C shows a schematic of insulated glass unit that was utilized to model the solar heat gain coefficients and visible light transmission values of the Zn DMSO dynamic glass if it were to be incorporated into a practical window.

FIGS. 13A-13D show scanning electron micrographs of Zn electrodeposits produced from the DMSO electrolyte containing 300 mM ZnBr₂, 300 mM Zn(CH₃COO)₂, and 400 mM NACH₃COO using chronoamperometry at −0.9 V until the electrode transmission is equal to 10% (FIGS. 13A and 13B) and 1% (FIGS. 13C and 13D).

FIG. 14 shows atomic force micrographs of Zn electrodeposits produced from the DMSO electrolyte using chronoamperometry at −0.9 V until the electrode transmission is equal to 10%.

FIGS. 15A and 15B show maxima and minima transmission at 600 nm (FIG. 15A) and voltages for stripping and deposition (FIG. 15B) of a two-electrode Zn dynamic window during 10,800 switching cycles using a DMSO electrolyte containing 300 mM ZnBr₂, 300 mM Zn(CH₃COO)₂, and 400 mM NACH₃COO (FIG. 15A), wherein during each cycle, the window was switched for 30 seconds for Zn electrodeposition followed by 60 seconds for Zn stripping; the voltages used for stripping and deposition during each cycle are shown in FIG. 15B.

FIGS. 16A-16D show maxima and minima transmission at 600 nm (FIGS. 16A and 16C), voltages for stripping and deposition (FIG. 16B), and transmission at 550 nm (FIG. 16D) of a two-electrode Zn dynamic window during (i) 2,500 switching cycles using a DMSO electrolyte containing 300 mM ZnBr₂, 300 mM Zn(CH₃COO)₂, and 400 mM NACH₃COO (FIG. 16A), wherein during each cycle, the window was switched for 45 seconds for Zn electrodeposition followed by 90 seconds for Zn stripping; and (ii) 1,000 switching cycles using a DMSO electrolyte containing 300 mM ZnBr₂, 300 mM Zn(CH₃COO)₂, and 400 mM NACH₃COO (FIG. 16A), wherein during each cycle, the window was switched for 300 seconds for Zn electrodeposition at −0.9 V followed by chronopotentiometry at +5 mA for 10 seconds and chronoamperometry at +1.0 V for 80 seconds for Zn stripping (FIGS. 16C and 16D).

FIGS. 17A-17F show scanning electron micrographs and associated transmission and voltage parameters of Zn electrodeposits produced from the DMSO electrolyte containing 300 mM ZnBr₂, 300 mM Zn(CH₃COO)₂, and 400 mM NACH₃COO using chronoamperometry at −0.9 V until the electrode transmission is equal to 10% after 10,800 cycles (FIGS. 17A and 17B) in a dynamic window using the parameters described in FIG. 4 or after 500 cycles (FIGS. 17C and 17D) in a dynamic window using the parameters described in FIGS. 17E and 17F.

FIG. 18 shows the cyclic voltammograms of Pt-modified ITO electrodes at a scan rate of 25 mV s⁻¹ in DMSO electrolytes containing 50 mM ZnBr₂, 50 mM Zn(CH₃COO)₂, and 67 mM NACH₃COO; or 6 mM ZnBr₂, 6 mM Zn(CH₃COO)₂, and 8 mM NACH₃COO.

FIGS. 19A and 19B show transmission at 600 nm of windows as a function of various Zn electrodeposition voltages applied for 30 s, wherein Zn stripping was elicited in all cases by applying +1 V for 50 s; the DMSO electrolytes contain 300 mM ZnBr₂, 300 mM Zn(CH₃COO)₂, and 400 mM NACH₃COO (FIG. 19A); or 50 mM ZnBr₂, 50 mM Zn(CH₃COO)₂, and 67 mM NACH₃COO (FIG. 19B).

FIGS. 20A and 20B show the chronoamperometry of dynamic windows as a function of various Zn electrodeposition voltages applied for 30 s, wherein Zn stripping was elicited in all cases by applying +1 V for 50 s; the DMSO electrolytes contained 300 mM ZnBr₂, 300 mM Zn(CH₃COO)₂, and 400 mM NACH₃COO (FIG. 20A); or 50 mM ZnBr₂, 50 mM Zn(CH₃COO)₂, and 67 mM NACH₃COO (FIG. 20B).

FIG. 21 shows transmission at 600 nm at the edge and center of a Zn dynamic window during five switching cycles using a DMSO electrolyte containing 50 mM ZnBr₂, 50 mM Zn(CH₃COO)₂, and 67 mM NACH₃COO, wherein during each cycle, the window was switched at −0.9 V for 60 seconds for Zn electrodeposition followed by +1 V at 60 seconds for Zn stripping.

FIG. 22 shows the transmission at 600 nm of a 4 cm×14 cm window switched at −1.1 V for Zn electrodeposition followed by +1 V for Zn stripping using an electrolyte containing 50 mM ZnBr₂, 50 mM Zn(CH₃COO)₂, and 67 mM NACH₃COO in DMSO, wherein electrical connection was only made to the ITO working electrode on one short edge of the rectangular device, effectively mimicking the switching uniformity of a 28 cm by 28 cm device and the transmission during switching was measured at three spots across the window: (1) adjacent to the electrical connection edge (black), (2) in the middle of the device (red), and (3) on the far edge of the device away from the electrical connection (blue).

FIGS. 23A and 23B show cyclic voltammograms (FIG. 23A) and corresponding transmission at 600 nm (FIG. 23B) of a Pt-modified ITO electrode at a scan rate of 25 mVs⁻¹ in a dimethylformamide (DMF) electrolyte containing (i) 100 mM ZnBr₂ and 100 mM Zn(CH₃COO)₂ with 100 mM NACH₃COO, (ii) 300 mM ZnBr₂, 300 mM Zn(CH₃COO)₂, and 400 mM NACH₃COO, and (iii) 100 mM ZnBr₂, 100 mM ZnCl₂, 100 mM Zn(CH₃COO)₂, and 100 mM HCOONa.

FIGS. 24A and 24B show cyclic voltammograms (FIG. 24A) and corresponding transmission at 600 nm (FIG. 24B) of a Pt-modified ITO electrode at a scan rate of 25 mVs⁻¹ in a DMSO electrolyte containing (i) 20 mM ZnSO₄, and (ii) 100 mM Zn(CH₃COO)₂, and in a (iii) DMSO: DMF (1:1) electrolyte containing 300 mM ZnBr₂, 300 mM Zn(CH₃COO)₂, and 400 mM NACH₃COO with 1% hydroxyethylcellulose (HEC).

FIGS. 25A and 25B show cyclic voltammograms (FIG. 25A) and corresponding transmission at 600 nm (FIG. 25B) of Pt-modified ITO electrodes at a scan rate of 25 mVs⁻¹ in (i) a N-methyl-2-pyrrolidone (NMP) electrolyte containing 100 mM ZnBr₂, 100 mM Zn (CH₃COO)₂, and 100 mM Zn(HCOO)₂, and in a sulfolane electrolyte containing (ii) 100 mM ZnBr₂, and (iii) 300 mM ZnBr₂, 300 mM Zn(CH₃COO)₂, and 400 mM NaCH₃COO.

FIGS. 26A and 26B show cyclic voltammograms (FIG. 26A) and corresponding transmission at 600 nm (FIG. 26B) of a Pt-modified ITO electrode at a scan rate of 25 mVs⁻¹ in a hexamethylphosphoramide (HMPA) electrolyte containing (i) 300 mM ZnBr₂, 100 mM Zn(CH₃COO)₂, and 400 mM Na(HCOO), (ii) 300 mM ZnBr₂, 100 mM Zn(CH₃COO)₂, and 400 mM NACH₃COO, (iii) 300 mM ZnBr₂, 100 mM Zn(CH₃COO)₂, and 400 mM NaCH₃CH₂COO, and (iv) 300 mM ZnBr₂, 100 mM Zn(CH₃COO)₂, and 400 mM NaCH₃CH₂CH₂COO.

FIGS. 27A and 27B show cyclic voltammograms (FIG. 27A) and corresponding transmission at 600 nm (FIG. 27B) of a Pt-modified ITO electrode at a scan rate of 25 mVs⁻¹ in a dimethoxyethane (DME) electrolyte containing 50 mM ZnBr₂ (solid line), 100 mM ZnBr₂ (dash line) and 300 mM ZnBr₂, 200 mM Na acetate with 200 mM Zn acetate (dot line).

FIGS. 28A and 28B show cyclic voltammograms (FIG. 28A) and corresponding transmission at 600 nm (FIG. 28B) of Pt-modified ITO electrodes at a scan rate of 25 mVs⁻¹ in a bis(2-methoxyethyl) ether electrolyte containing (i) 300 mM ZnBr₂, (ii) 300 mM ZnBr₂ and 400 mM Na(CH₃COO), (iii) 100 mM ZnBr₂, 100 mM Zn(CH₃COO)₂, and 100 mM Na(HCOO), (iv) 300 mM ZnBr₂, 300 mM Zn(CH₃COO)₂, and 400 mM Na(HCOO), and (v) 100 mM ZnBr₂, 100 mM ZnCl₂, 100 mM Zn(CH₃COO)₂, 50 mM NaCl, and 300 mM Na(HCOO).

FIGS. 29A and 29B show cyclic voltammograms (FIG. 29A) and corresponding transmission at 600 nm (FIG. 29B) of a Pt-modified ITO electrode at a scan rate of 25 mVs⁻¹ in a triethylene glycol dimethyl ether electrolyte containing (i) 100 mM ZnBr₂, (ii) 100 mM ZnCl₂, 100 mM Zn(CH₃COO)₂, and 100 mM NACH₃COO, and (iii) 100 mM ZnBr₂, 100 mM Zn(CH₃COO)₂, and 100 mM NaCH₃COO.

FIGS. 30A and 30B show cyclic voltammograms (FIG. 30A) and corresponding transmission at 600 nm (FIG. 30B) of a Pt-modified ITO electrode at a scan rate of 25 mVs⁻¹ in a tetraethylene glycol dimethyl ether electrolyte containing (i) 100 mM ZnBr₂, and (ii) 100 mM ZnBr₂, 100 mM Zn(CH₃COO)₂, and 100 mM NaCH₃COO.

FIGS. 31A and 31B show cyclic voltammograms (FIG. 31A) and corresponding transmission at 600 nm (FIG. 31B) of a Pt-modified ITO electrode at a scan rate of 25 mVs⁻¹ in a tetramethylurea electrolyte containing (i) 300 mM ZnBr₂ and 100 mM Zn(CH₃COO)₂, (ii) 300 mM ZnBr₂, 300 mM Zn(CH₃COO)₂, and 400 mM NACH₃COO, and (iii) Pt-modified FTO electrode at a scan rate of 25 mVs⁻¹ in a tetramethylurea electrolyte containing 300 mM ZnBr₂, 300 mM Zn(CH₃COO)₂, and 400 mM NACH₃COO.

FIGS. 32A and 32B show cyclic voltammograms (FIG. 32A) and corresponding transmission at 600 nm (FIG. 32B) of a Pt-modified ITO electrode at a scan rate of 25 mVs⁻¹ in (i) an acetonitrile electrolyte containing 100 mM ZnBr₂, 100 mM Zn(CH₃COO)₂, and 100 mM NACH₃COO, and (ii) a DMSO:acetonitrile (1:1) electrolyte containing 50 mM ZnBr₂, 50 mM Zn(CH₃COO)₂, and 100 mM NACH₃COO.

FIGS. 33A and 33B show cyclic voltammograms (FIG. 33A) and corresponding transmission at 600 nm (FIG. 33B) of Pt-modified ITO electrodes at a scan rate of 25 mV s⁻¹ in a bis(2-ethoxyethyl) ether electrolyte containing 300 mM ZnBr₂, 100 mM Zn(CH₃COO)₂, and 400 mM Na(HCOO).

FIGS. 34A and 34B show cyclic voltammograms (FIG. 34A) and corresponding transmission at 600 nm (FIG. 34B) of a Pt-modified ITO electrode at a scan rate of 25 mV s⁻¹ in a bis(2-ethoxyethyl) ether electrolyte containing 300 mM ZnBr₂ and 400 mM Na(CH₃COO).

FIGS. 35A and 35B show cyclic voltammograms (FIG. 35A) and corresponding transmission at 600 nm (FIG. 35B) of a Pt-modified ITO electrode at a scan rate of 25 mV s⁻¹ in a bis(2-ethoxyethyl) ether electrolyte containing 300 mM ZnBr₂, 300 mM Zn(CH₃COO)₂, and 400 mM Na(CH₃COO).

FIGS. 36A and 36B show cyclic voltammograms (FIG. 36A) and corresponding transmission at 600 nm (FIG. 36B) of a Pt-modified ITO electrode at a scan rate of 25 mV s⁻¹ in a bis(2-ethoxyethyl) ether electrolyte containing 100 mM ZnBr₂, 100 mM ZnCl₂, 100 mM Zn(CH₃COO)₂, 50 mM NaCl, and 300 mM Na(HCOO).

FIGS. 37A and 37B show results from bistability measurements using a Zn-proprionitrile (PrCN) electrolyte composed of 300 mM ZnCl₂, 200 mM LiCl, and 25 mM NaCH₃CH₂COO with 0.5 wt. % PEG, wherein transmission at 600 nm of Zn electrodeposits on the ITO working electrode in a cuvette containing the Zn—PrCN electrolyte over time (FIG. 37A) at 21° C. and 85° C. And the electrolyte was dried to <0.1 ppm H₂O; FIG. 37B shows how the time it takes the working electrode to achieve 30% transmission at 600 nm varies with the water content of the Zn—PrCN electrolyte in a cuvette at 85° C. The electrolyte represented by the rightmost datum point in FIG. 37B had a water content of 50 ppm.

FIGS. 38A and 38B show corresponding transmission at 600 nm (FIG. 38A) and auto-dissolution behavior of zinc films deposited at −0.9 V for 300 seconds from Zn—PrCN electrolytes, and (FIG. 38B) cyclic voltammograms of Pt-modified ITO electrodes at a scan rate of 20 mV s-1 in electrolytes containing (i) 300 mM ZnBr₂ with 200 mM LiCl and 400 mM Na Acetate in DMSO (black solid line), and (ii) 300 mM ZnBr₂ along with 300 mM Zn Acetate and 400 mM Na Acetate in propionitrile (dash line).

FIGS. 39A and 39B show cyclic voltammograms (FIG. 39A) and corresponding transmission at 600 nm (FIG. 39B) of Pt-modified ITO electrodes at a scan rate of 20 mV s⁻¹ in PrCN electrolytes containing 300 mM ZnCl₂, 200 mM LiCl, 25 mM NaCH₃CH₂COO without (solid line) and with 0.5 wt. % PEG (dash line) or 300 mM ZnCl₂, 200 mM LiCl, and 15 mM (t-Bu₄)N(PF₆) (dot line), wherein testing was conducted at 21° C.

FIGS. 40A-40C are scanning electron micrographs of Zn electrodeposits produced from PrCN electrolytes containing 300 mM ZnCl₂, 200 mM LiCl, and 25 mM NaCH₃CH₂COO (FIG. 40A), 300 mM ZnCl₂, 200 mM LiCl, and 15 mM (t-Bu₄)N(PF₆) (FIG. 40B), or 300 mM ZnCl₂, 200 mM LiCl, 25 mM NaCH₃CH₂COO, and 0.5 wt. % PEG (FIG. 40C) using chronoamperometry at −1.0 V until the electrode transmission is equal to 10%, wherein testing was conducted at 21° C.

FIGS. 41A and 41B show cyclic voltammograms (FIG. 41A) and corresponding transmission at 600 nm (FIG. 41B) of Pt-modified ITO electrodes at a scan rate of 20 mV s⁻¹ in CH₃CH₂CN electrolytes containing only (i) 150 mM ZnCl₂ (black solid line), (ii) 300 mM ZnCl₂, 200 mM LiCl (dash line), (iii) 150 mM ZnCl₂, 25 mM Na propionate (dot line).

FIGS. 42A and 42B show cyclic voltammograms (FIG. 42A) and corresponding transmission at 600 nm (FIG. 42B) of Pt-modified ITO electrodes at a scan rate of 20 mV s⁻¹ in CH₃CH₂CN electrolytes containing only (i) 50 mM ZnCl₂, 15 mM (t-Bu₄)N(PF₆) (solid line), (ii) 300 mM ZnCl₂, 200 mM LiCl, 15 mM (t-Bu₄)N(PF₆) with 0.5% PEG (dash line).

FIGS. 43A and 43B show cyclic voltammograms (FIG. 43A) and corresponding transmission at 600 nm (FIG. 43B) of Pt-modified ITO electrodes at a scan rate of 20 mV s⁻¹ in CH₃CH₂CN electrolytes containing only (i) 50 mM ZnCl₂, 25 mM Na formate (solid line); (ii) 50 mM ZnCl₂, 25 mM Na Acetate (dash line); (iii) 50 mM ZnCl₂, 25 mM LiClO₄ (dot line); (iv) 50 mM ZnCl₂, 25 mM tetramethylammonium chloride (dash dot line); (v) 50 mM ZnCl₂, 25 mM tetrabutylammonium chloride (dash dot dot line); (vi) 50 mM ZnCl₂, 25 mM NaCl (short dash line).

FIGS. 44A and 44B show cyclic voltammograms (FIG. 44A) and corresponding transmission at 600 nm (FIG. 44B) of Pt-modified ITO electrodes at a scan rate of 20 mV s⁻¹ in CH₃CH₂CN electrolytes containing only (i) 300 mM ZnCl₂, 200 mM LiCl, 50 mM LiClO₄ (solid line); (ii) 300 mM ZnCl₂, 200 mM LiCl, 250 mM LiCF₃SO₃ (dash line); (iii) 300 mM ZnCl₂, 50 mM LiClO₄, 20 mM Zn(BF₄)₂ (dot line); (iv) 300 mM ZnCl₂, 100 mM LiCl, 10 mM Na Acetate (dash dot line); (v) 300 mM ZnCl₂, 200 mM LiCl, 50 mM LiPF₆ (dash dot dot line).

FIGS. 45A and 45B show chronoamperometry (FIG. 45A) and transmission at 600 nm (FIG. 45B) and of a Zn dynamic window using a PrCN electrolyte containing 300 mM ZnCl₂, 200 mM LiCl, and 25 mM NaCH₃CH₂COO during tinting at −1 V for 300 seconds followed by lightening at +1.8 V for 200 seconds.

FIGS. 46A-46C show transmission (FIG. 46A), outdoor reflectance (FIG. 46B), and indoor reflectance (FIG. 46C) of a two-electrode Zn dynamic window using a PrCN electrolyte containing 300 mM ZnCl₂, 200 mM LiCl, 25 mM NaCH₃CH₂COO, and 0.5 wt. % PEG after tinting at −1 V for 0 seconds (black), 10 seconds (red), 20 seconds (blue), 30 seconds (green), 40 seconds (purple), and 300 seconds (dark yellow), wherein testing was conducted at 21° C.

FIG. 47 shows cyclic voltammograms of Pt-modified ITO electrodes at a scan rate of 20 mV s⁻¹ in PrCN electrolytes containing 100 mM LiCl and 25 mM NaCH₃CH₂COO, 50 mM ZnCl₂, 100 mM LiCl, and NaCH₃CH₂COO, or 70 mM ZnCl₂, 100 mM LiCl, and 25 mM NaCH₃CH₂COO.

FIGS. 48A and 48B show transmission at 600 nm (FIG. 48A) and current density values (FIG. 48B) of dynamic windows as a function of various Zn electrodeposition voltages applied for 40 seconds. Zn stripping was elicited in all cases by applying +1.2 V for 60 seconds. The PrCN electrolyte contained 70 mM ZnCl₂, 100 mM LiCl, and 25 mM NaCH₃CH₂COO, wherein testing was conducted at 21° C.

FIG. 49 shows transmission at 600 nm at the center and edge of a two-electrode Zn dynamic window during ten switching cycles using a PrCN electrolyte containing 70 mM ZnCl₂, 100 mM LiCl, and 25 mM NaCH₃CH₂COO, wherein, during each cycle, the window was switched at −1.2 V for 30 seconds for Zn electrodeposition followed by +1.2 V at 90 seconds for Zn stripping.

FIG. 50 shows the chronoamperometry of a Zn dynamic window during switching at −1.2 V for 30 seconds for Zn electrodeposition followed by +1.2 V at 90 seconds for Zn stripping.

FIGS. 51A and 51B show maxima (black solid line) and minima (black dash line) transmission at 600 nm of a two-electrode Zn dynamic window during 1,190 switching cycles using a propionitrile electrolyte containing 300 mM ZnCl₂, 200 mM LiCl, 25 mM Na Propionate with 0.5% PEG (FIG. 51A). During each cycle, the window was switched for 20 seconds for Zn electrodeposition followed by 60 seconds for Zn stripping at room temperature (FIG. 51B) or for 60 seconds for Zn stripping at 85° C. In both cases, the voltages used for stripping and deposition were +1.8 V and −1 V respectively.

FIG. 52 shows the scanning electron micrograph of Zn electrodeposits produced from the PrCN electrolyte containing 300 mM ZnCl₂, 200 mM LiCl, 25 mM NaCH₃CH₂COO, and 0.5 wt. % PEG after 1,100 cycles in a dynamic window using the parameters described in FIG. 51A (ending on deposition) using chronoamperometry at −1.0 V until the electrode transmission is equal to 10%.

FIGS. 53A and 53B show cyclic voltammograms (FIG. 53A) and corresponding transmission at 600 nm (FIG. 53B) of Pt-modified ITO electrodes at a scan rate of 20 mV s⁻¹ in DMSO electrolytes containing only (i) 300 mM ZnBr₂ with 200 mM Lithium trifluoroacetate, and 400 mM Lithium acetate, (ii) 300 mM ZnBr₂, 200 mM Lithium trifluoroacetate, and 400 mM Lithium acetate with 2.6 mM MnCl₂, (iii) 300 mM ZnBr₂ with 200 mM Sodium trifluoroacetate, and 400 mM Lithium acetate, and (iv) 300 mM Zinc formate, and 400 mM Lithium formate.

FIGS. 54A and 54B show cyclic voltammograms (FIG. 54A) and corresponding transmission at 600 nm (FIG. 54B) of Pt-modified ITO electrodes at a scan rate of 20 mV s⁻¹ in DMSO electrolytes containing only Zn-DMSO (300 mM ZnBr₂ with 300 mM Zinc acetate, and 400 mM Sodium acetate) with (i) 2.6 mM NiCl₂ (solid line) (ii) 2.6 mM AlCl₃ (dash line) (iii) 2.6 mM Nickel acetate (dot line) and (iv) 2.6 mM SnCl₂ (dash dot line).

FIGS. 55A and 55B show cyclic voltammograms (FIG. 55A) and corresponding transmission at 600 nm (FIG. 55B) of Pt-modified ITO electrodes at a scan rate of 20 mV s⁻¹ in DMSO electrolytes containing only Zn-DMSO (300 mM ZnBr₂ with 300 mM Zinc acetate, and 400 mM Sodium acetate) with (i) 2.6 mM MnCl₂ and 2.6 mM Nickel acetate (solid line), (ii) 2.6 mM MnCl₂ and 2.6 mM SnCl₂ (dash line), (iii) 2.6 mM SnCl₂ and 2.6 mM InCl₃ (dot line), and (iv) 2.6 mM SnCl₂ and 2.6 mM Nickel acetate (dash dot line).

FIGS. 56A and 56B show cyclic voltammograms (FIG. 56A) and corresponding transmission at 600 nm (FIG. 56B) of Pt-modified ITO electrodes at a scan rate of 20 mV s⁻¹ in DMSO electrolytes containing only 300 mM ZnBr₂ with 300 mM Zinc acetate, and 400 mM Sodium acetate with (i) 2.6 mM CoCl₂ (solid line), and (ii) 2.6 mM MnCl₂ (dash line).

FIGS. 57A and 57B show cyclic voltammograms (FIG. 57A) and corresponding transmission at 600 nm (FIG. 57B) of Pt-modified ITO electrodes at a scan rate of 20 mV s⁻¹ in DMSO electrolytes containing only Zn-DMSO (300 mM ZnBr₂ with 300 mM Zinc acetate, and 400 mM Sodium acetate) with (i) 2.6 mM BCl₃ (solid line), (ii) 2.6 mM AlCl₃ (dash line), (iii) 2.6 mM InCl₃ (dot line), (iv) GaCl₃ (dash dot line), and (v) 2.6 mM TiCl₄ (short dash line).

FIG. 58 shows a plot of dissolution time of electrodeposited Zn films at 85° C. at open circuit potential versus the water content in the electrolytes. The Zn electrolyte consists of 300 mM ZnBr₂, 300 mM Zn(CH₃COO)₂, and 400 mM NACH₃COO in DMSO. The other electrolytes contain the same composition with an additional one or two acetate salts of the element(s) listed. Dissolution time is defined as time it takes films with 0.1% transmission to reach ˜30% transmission. The data show that there is no clear relationship between dissolution time and water in the electrolyte, indicating that the enhanced bistability of the films at 85° C. shown is due to the enhanced corrosion resistance of the electrodeposited multimetallic films.

FIG. 59 shows a plot of dissolution time of electrodeposited Zn films at 85° ° C. at open circuit potential versus the Coulombic efficiency of the electrolytes obtained from cyclic voltammetry.

FIGS. 60A and 60B show cyclic voltammograms (FIG. 60A) and corresponding transmission at 600 nm (FIG. 60B) of Pt-modified ITO electrodes at a scan rate of 20 mV s⁻¹ in DMSO electrolytes containing only (i) Zn-DMSO (300 mM ZnBr₂, 300 mM ZnA, 400 mM NaA (solid line); (ii) Zn-DMSO with 2.6 mM Ni Acetate (NiA) (dash line); (iii) Zn-DMSO with 2.6 mM NiA+0.5% PVP (dot line); (iv) Zn-DMSO with 2.6 mM NiA+5% PVP (dash dot line); (v) Zn-DMSO with 2.6 mM NiA+10% PVP (dash dot dot); (vi) Zn-DMSO with 2.6 mM NiA+30% PVP (short dash).

FIGS. 61A and 61B show cyclic voltammograms (FIG. 61A) and corresponding transmission at 600 nm (FIG. 61B) of Pt-modified ITO electrodes at a scan rate of 20 mV s⁻¹ in DMSO electrolytes containing only (i) Zn-DMSO (300 mM ZnBr₂, 300 mM ZnA, 400 mM NaA; (ii) Zn-DMSO with 2.6 mM BCl₃; (iii) Zn-DMSO with 2.6 mM AlCl₃; (iv) Zn-DMSO with 2.6 mM GaCl₃; (v) Zn-DMSO with 2.6 mM InCl₃; (vi) Zn-DMSO with 2.6 mM TiCl₄.

### DETAILED DESCRIPTION

### Overview of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited. Within context, the term “about” may include values of up to 5-10% outside the specific number range enumerated.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “introduce,” “flow,” or “provide” to describe the disclosed methods. These terms are high-level abstractions of the actual operations that are performed. The actual operations that correspond to these terms may vary depending on the particular implementation and are readily discernible by those in the art.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Directions and other relative references (e.g., inner, outer, upper, lower, etc.) may be used to facilitate discussion of the drawings and principles herein, but are not intended to be limiting. For example, certain terms may be used such as “inside,” “outside,” “top,” “down,” “interior,” “exterior,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

In order to facilitate review of the various embodiments of the disclosure, the following explanations of specific terms are provided:

Aliphatic: A hydrocarbon group (e.g., a substantially hydrocarbon-based compound) having at least one carbon atom to 50 carbon atoms (C1-50), such as one to 25 carbon atoms (C1-25), or one to ten carbon atoms (C1-10), or one to six carbon atoms (C1-6), or one to four carbon atoms (C1-4), and which includes alkanes (or alkyl), alkenes (or alkenyl), alkynes (or alkynyl), including cyclic versions thereof, and further including straight- and branched-chain arrangements, and all stereo and position isomers as well. Aliphatic groups may be substituted with one or more groups other than hydrogen.

Alkali Metal: A metal belonging to Group 1 of the periodic table, including lithium, sodium, potassium, rubidium, cesium, and francium.

Carboxylate: A species having a formula RC(O)O⁻, wherein R is selected from hydrogen, aliphatic, or haloaliphatic.

Counter Electrode: The electrode in an electrochemical system that performs an opposite electrochemical process/reaction as to the process/reaction that occurs at the working electrode. In some aspects of the present disclosure, the working electrode functions as an anode.

Directly: This term is used to describe an orientation wherein two components of interest (e.g., an opaque zinc-containing coating and another component, such as a working electrode, conductive metal oxide material, and/or a counter electrode) are physically associated without an intervening structure, material, or component.

Indirectly: This term is used to describe an orientation wherein two components of interest (e.g., an opaque zinc-containing coating and another component, such as a working electrode, conductive metal oxide material, and/or a counter electrode) are not directly physically associated and instead comprise an intervening structure, material, or component between them.

Haloaliphatic: An aliphatic group wherein one or more hydrogen atoms, such as one to 10 hydrogen atoms, independently is replaced with a halogen atom, such as fluoro, bromo, chloro, or iodo. Haloaliphatic groups can be substituted with one or more groups other than hydrogen.

Non-Aqueous: This term is used to describe an electrolyte composition that does not use an aqueous solvent and instead uses a polar aprotic solvent. In some aspects of the disclosure, non-aqueous can mean that the electrolyte composition is free of any aqueous solvent and/or includes little to no extraneous (e.g., less than 30 ppm, such as less than 20 ppm, less than 10 ppm, less than 5 ppm, less than 2 ppm, less than 1 ppm, 0.1 ppm, less than 1 ppb, or at a level which is below a detectable level) water, such as water that might be produced during use of a non-aqueous zinc-based electrolyte under cycling conditions described herein.

Non-Transparent: This term is used to describe a working electrode (or a component thereof) after it has been coated with an opaque zinc-containing coating according to the present disclosure.

Optoelectronically Dynamic Element: A device, material, or other construct that can be transformed between states of transparency and non-transparency. Exemplary devices, materials, or other constructs can include, but are not limited to, windows, films, lenses, flat-panel displays, polymer-based electronics, thin film photovoltaics, glass doors, tools/devices used in X-ray diffraction and scanning electron microscopy analysis, and the like.

Opaque: This term is used to describe a zinc-containing coating that can be formed from the non-aqueous zinc-based electrolyte according to the present disclosure, wherein the zinc-containing coating allows minimal light transmission at 400-750 nm, such as 0% to less than 10%, or 0% to less than 5%, or 0% to less than 1%, or 0% to less than 0.5%, or 0% to less than 0.1% light transmission.

Polar Aprotic Solvent: A solvent that is polar and lacks an acidic proton. Water is not a polar aprotic solvent.

Transparent: This term is used to describe a working electrode before it has been coated with an opaque zinc-containing coating according to the present disclosure. This term also can be used to describe a counter electrode (or a component thereof) according to the present disclosure. In some aspects of the disclosure, a transparent working electrode can allow light transmission at 400-750 nm, such as 600 nm, in percentages ranging from 70% to 100%, or 75% to 100%, or 80% to 100%, or 85% to 100%, or 90% to 100%, or 95% to 100%.

Weakly Coordinating Anion: An ion with a net negative charge that interacts weakly with cations. An anion is weakly coordinating when its charge is delocalized over the entire surface of the anion rather than localized at a specific atom.

Working Electrode: The electrode in an electrochemical system on which a reaction of interest occurs, such as deposition of an opaque zinc-containing coating upon application of a voltage. In some aspects of the present disclosure, the working electrode functions as a cathode.

Zinc Salt: A chemical species comprising zinc ions (Zn²⁺) and at least one negatively charged counterion.

### INTRODUCTION

Over the past five years, there has been significant interest in developing dynamic windows based on reversible metal electrodeposition (RME). Metals block light efficiently, and a metal film only tens of nanometers thick can be opaque. In contrast, common electrochromic materials such as WO₃ must be hundreds or thousands of nanometers thick to reach the same opacity. Furthermore, most metals are intrinsically color neutral, allowing RME windows to switch between clear, grey, and black states, which is most desirable for window applications. In a typical RME device architecture, metal electrodeposition occurs on a transparent electrode such as tin-doped indium oxide (ITO) to darken the window. This reaction is charge balanced by simultaneous oxidation of a metal mesh counter electrode to metal cations.

Devices using electrochromic materials, which change their optical properties upon application of a voltage, are the most common class of dynamic windows; however, an inability to produce electrochromic windows that are simultaneously fast switching, color neutral, durable, and inexpensive has hindered their widespread adoption. Polymer-dispersed liquid crystals (PDLCs) are an alternative dynamic window technology that possesses millisecond switching times. Unfortunately, PDLCs switch between a clear state and a bright, hazy state, which is unacceptable for most applications. Also, dynamic windows and/or other materials in the art typically utilize aqueous electrolytes because metals electrodeposit readily from water due to its high polarity, which limits energetic penalties associated with ion pairing. Such systems, however, can produce H₂ evolution from the reduction of H₂O, and methods typically used to avoid H₂ evolution (e.g., using specific metals in electrolytes in combination with an acid) can lead to poor shelf life. Aqueous Zn dynamic windows that cycle more than a thousand times without degradation have not been constructed. In aqueous electrolytes, the slow and irreversible accumulation of Zn(OH)₂ on ITO is responsible for the poor cyclability.

As indicated above, aqueous electrolytes are most commonly investigated for RME windows because metals electrodeposit readily from water due to its high polarity, which limits energetic penalties associated with ion pairing. To avoid H₂ evolution from the reduction of H₂O, relatively noble metals such as Ag, Bi, and Cu with standard reduction potentials more positive than 0 V vs. standard hydrogen electrode (SHE) are desirable. Bi—Cu electrolytes are among the most successful aqueous systems and have supported dynamic windows that cycle thousands of times without significant degradation in optical contrast or switching speed. Cu electrodeposition is fast and reversible, and the addition of Bi allows for a color-neutral metallic film as opposed to red Cu. However, acid must be added to Bi—Cu electrolytes to solubilize Bi³⁺ ions. The low pH (<2) of these electrolytes causes ITO degradation at rest, which gives many Bi—Cu RME devices poor shelf lives.

The present disclosure is directed to a non-aqueous zinc-based electrolyte composition that comprises a polar aprotic solvent instead of water. Solvents used in aspects of the present disclosure support robust reversible Zn electrodeposition. Because the disclosed electrolyte composition is non-aqueous, Zn(OH)₂ formation is avoided during electrodeposition, which greatly extends the cyclability of the devices. The electrolyte according to aspects of the present disclosure facilitates reversible Zn electrodeposition with high Coulombic efficiency (e.g., 99% and even up to 99.5% or higher) Coulombic efficiency in some aspects and further allows for practical two-electrode dynamic elements (e.g., windows) to switch more than 10,000 times without degradation in optical contrast or switching speed.

As discussed herein, the non-aqueous zinc-based electrolyte of the present disclosure facilitates the reversible electrodeposition of zinc metal on transparent conducting electrodes with excellent optical contrast and enhanced cycle life, typically for at least 1,000 cycles and often for greater than 10,000 cycles in certain aspects. The electrolyte according to aspects of the disclosure are applicable to dynamic windows and other technologies that contain an optoelectronically dynamic (or switchable) materials, such as windows, films, lenses, flat-panel displays, polymer-based electronics, thin film photovoltaics, glass doors, tools/devices used in X-ray diffraction and scanning electron microscopy analysis, among others.

### Non-Aqueous Zinc-Based Electrolyte and Optoelectronically Dynamic Elements

Disclosed herein is a non-aqueous zinc-based electrolyte that can be used in combination with an electrode set-up to provide optoelectronically dynamic elements. Also disclosed are optoelectronically dynamic elements comprising the non-aqueous zinc-based electrolyte of the present disclosure.

In aspects of the disclosure, the non-aqueous zinc-based electrolyte comprises at least one non-aqueous solvent, such as a polar aprotic solvent (or a mixture of such solvents). Exemplary polar aprotic solvents include, but are not limited to, dimethyl sulfoxide (DMSO), dimethylacetamide (DMA), dimethylformamide (DMF), acetonitrile, dimethylpropylene urea (DMPU), ethyl acetate, pyridine, hexamethylphosphoramide (HMPA), hexamethylphosphoric triamide (HMPT), sulfolane, ethyl acetate, dichloromethane, 1,2-dimethoxyethane, 1,1-diethoxyethane, 1,2-diethoxyethane, tetramethylurea, 1-methoxy-2-(2-methoxyethoxy)ethane, 1-ethoxy-2-(2-ethoxyethoxy)ethane, 1,2-bis(2-methoxyethoxy)ethane, bis[2-(2-methoxyethoxy)ethyl] ether, propionitrile, butyronitrile, n-methyl-2-pyrrolidone (NMP), bis(2-ethoxyethyl) ether, bis(2-methoxyethyl) ether, triethylene glycol dimethyl ether, and tetraethylene glycol dimethyl ether, among others. Polar aprotic solvents with higher boiling points (often in excess of 100° C.) may often be used. In particular aspects of the disclosure, the polar aprotic solvent is selected from DMSO, DMA, DMF, acetonitrile, propionitrile, butyronitrile, DMPU, HMPT, or any combination thereof. In yet additional aspects of the disclosure, the polar aprotic solvent is selected from DMSO, DMA, propionitrile, DMF, or any combination thereof. In exemplary aspects of the disclosure, the polar aprotic solvent is selected from DMSO, acetonitrile, propionitrile, or any combination thereof (e.g., DMSO with acetonitrile at varying weight ratios, often 1:1). Without being limited to a single operating theory or intending to limit the present disclosure, it currently is believed that DMSO (and other like solvents) is a desirable non-aqueous solvent for reversible zinc electrodeposition according to aspects of the present disclosure because of its high polarity, which allows for good zinc solubility. The aprotic nature of DMSO, as one example, prevents H₂ formation, which can be a problem in aqueous electrolytes. Additionally, DMSO exhibits good electrochemical stability (e.g., −1.8 V to +1.5 V vs. Zn/Zn²⁺). The standard reduction potential of Zn/Zn²⁺ falls within DMSO's cathodic and anodic voltage limits and thus DMSO is one non-limiting solvent ideally suited for reversible Zn electrodeposition according to aspects of the present disclosure from the perspective of voltage stability.

The zinc-based electrolyte according to aspects of the disclosure also comprises a zinc salt (and/or any ions formed therefrom). In some aspects of the disclosure, the zinc salt is a zinc halide salt, a zinc carboxylate salt, a zinc salt comprising weakly coordinating anion, or any combination thereof. Zinc halide salts comprise zinc and a halide counterion and typically have a formula ZnX₂, wherein each X independently is selected from Cl, F, Br, or I. Exemplary zinc halide salts include, but are not limited to, ZnF₂, ZnCl₂, ZnBr₂, ZnI₂, or combinations thereof. In some exemplary aspects of the disclosure, the zinc halide salt is ZnCl₂, ZnBr₂, ZnI₂, and often preferably is ZnBr₂. Zinc carboxylate salts comprise zinc and a carboxylate counterion and typically have a formula ZnOC(═O)R (or, written another way, ZnRCOO), wherein R independently is selected from H, aliphatic (e.g., methyl, ethyl, propyl, butyl, pentyl, hexyl, heptyl, octyl, nonyl, or decyl), or haloaliphatic (e.g., trifluoromethyl, difluoromethyl, and the like). Exemplary zinc carboxylate salts include, but are not limited to, zinc formate, zinc acetate, zinc propionate, zinc butyrate, zinc pentanoate, zinc hexanoate, zinc trifluoroacetate, or any combination thereof. In some exemplary aspects of the disclosure, the zinc carboxylate salt is selected from zinc formate, zinc acetate, zinc propionate, zinc butyrate, zinc trifluoroacetate, or any combination thereof, and often preferably is zinc formate, zinc acetate, or zinc proprionate. The zinc salt comprising a weakly coordinating anion comprises zinc and a weakly coordinating anion that can be selected from tetrafluoroborate (BF₄⁻), hexafluorophosphate (PF₆⁻), perchlorate (ClO₄⁻), triflate (CF₃SO₃⁻), or the like. In some aspects of the disclosure, the zinc salt is Zn(BF₄)₂, Zn(PF₆)₂, Zn(ClO₄)₂, Zn(CF₃SO₃)₂, or any combination thereof.

In some aspects of the disclosure, the non-aqueous zinc-based electrolyte can comprise additional metal ions in addition to the zinc ions provided by the zinc salt. In some such aspects of the disclosure, the additional metal ions can be provided by a second metal salt comprising iron, nickel, tin, aluminum, cobalt, manganese, gallium, titanium, indium, boron; any ions thereof; and/or or any combination thereof. In some aspects of the disclosure, the additional metal ions are provided by a second metal salt selected from sodium acetate (CH₃COONa), nickel acetate (Ni(CH₃COO)₂), lithium trifluoroacetate (CF₃COOLi), lithium triflate (CF₃S(O)₂OLi), lithium difluoroacetate (CHF₂COOLi), lithium acetate (CH₃COOLi), lithium bromide (LiBr), lithium chloride (LiCl), potassium acetate (CH₃COOK), sodium trifluoroacetate (CF₃COONa), lithium formate (HCOOLi), nickel chloride (NiCl₂), aluminum chloride (AlCl₃), tin chloride (SnCl₂), manganese chloride (MnCl₂), indium chloride (InCl₃), indium acetate (In(CH₃COO)₃), cobalt chloride (CoCl₂), boron trichloride (BCl₃), gallium trichloride (GaCl₃), titanium tetrachloride (TiCl₄), and/or any combinations thereof.

In some aspects of the disclosure, the non-aqueous zinc-based electrolyte can further comprise an alkali metal carboxylate salt, wherein the alkali metal is selected from lithium, sodium, or potassium and the carboxylate comprises an R group that can be hydrogen, aliphatic (e.g., C₁₋₆aliphatic), or haloalkyl. In some such aspects of the disclosure, the alkali metal carboxylate salt can be selected from lithium formate, lithium acetate, lithium propionate, lithium butyrate, lithium pentanoate, lithium hexanoate, sodium formate, sodium acetate, sodium propionate, sodium butyrate, sodium pentanoate, sodium hexanoate, potassium formate, potassium acetate, potassium propionate, potassium butyrate, potassium pentanoate, potassium hexanoate, or any combination thereof. In some exemplary aspects of the disclosure, the alkali metal carboxylate salt is selected from sodium formate, sodium acetate, sodium propionate, potassium formate, potassium acetate, or potassium propionate. In some aspects of the disclosure, the alkali metal carboxylate salt can support high current density and good optical contrast and reversibility of Zn electrodeposition.

In yet additional aspects of the disclosure, the non-aqueous zinc-based electrolyte can further comprise a leveling agent that can be used to facilitate consistent and uniform deposition of an opaque zinc-containing coating as described herein. In some aspects of the disclosure, the leveling agent is selected from polyvinylalcohol (PVA), thiourea, cetyltrimethyl ammonium bromide, sodium dodecyl sulfate, or a combination thereof. The leveling agent can be included in amounts ranging from about 0.05 to 15% by weight, often 0.1 to 10% by weight.

In some independent aspects of the disclosure, the non-aqueous zinc-based electrolyte can further comprise compounds that facilitate forming semi-solid forms of the electrolyte. In some aspects of the disclosure, such compounds can be selected from hydroxyethylcellulose, hydroxypropylcellulose, polyvinylalcohol, and the like.

In representative aspects of the disclosure, the non-aqueous zinc-based electrolyte can comprise a polar aprotic solvent and a zinc salt (or a combination of different zinc salts). In yet additional aspects of the disclosure, the non-aqueous zinc-based electrolyte can comprise a polar aprotic solvent, a zinc salt (e.g., a zinc halide alone or in combination with a zinc carboxylate), and an alkali metal carboxylate salt (or a combination of different alkali metal carboxylate salts). In yet additional aspects of the disclosure, the non-aqueous zinc-based electrolyte can comprise a polar aprotic solvent, a zinc salt (e.g., a zinc halide alone or in combination with a zinc carboxylate), an alkali metal carboxylate salt (or a combination of different alkali metal carboxylate salts), and a second metal salt (or a combination of different second metal salts). In yet further aspects of the disclosure, the non-aqueous zinc-based electrolyte can comprise a polar aprotic solvent, a zinc salt (e.g., a zinc halide alone or in combination with a zinc carboxylate) and a second metal salt (or a combination of different second metal salts). In any or all of the foregoing aspects, the non-aqueous zinc-based electrolyte can further comprise a leveling agent and/or a compound that facilitates forming a semi-solid form of the electrolyte.

In one aspect of the disclosure, the non-aqueous zinc-based electrolyte comprises a non-aqueous solution (a polar aprotic solvent or mixture of polar aprotic solvents) of at least one zinc halide, at least one zinc carboxylate and optionally at least one alkali metal (lithium, sodium, potassium, often sodium) carboxylate, wherein each of the zinc halide(s), zinc carboxylate(s) and alkali metal carboxylate(s) is included in the electrolyte composition at a concentration ranging from 0.01 M to 5.0 M, such as 0.1 M to 0.5 M, or 0.1M to 0.3 M. These salts are completely soluble in the polar aprotic solvent at concentrations ranging from 0.1 M to 5.0 M. In such an aspect of the disclosure, upon application to a cathode of a voltage ranging from −3.0 V to +2.0 V as described herein, the non-aqueous zinc-based electrolyte can transition the cathode in two-electrode devices from transparent (e.g., 75-80% transmission at 400-750 nm, such as 600 nm) to highly opaque (e.g., <0.1% transmission at 400-750 nm, such as 600 nm) at negative voltage or from highly opaque to transparent at positive voltage. These transitions can occur in less than 5 minutes, often between one minute and two minutes, often less than one minute or less than 20-30 seconds.

The zinc salt can be used in an amount that provides a concentration, in the polar aprotic solvent, ranging from 0.01 M to 5 M (or 10 mM to 5,000 mM), such as 0.1 M to 0.5 M, or 0.1 M to 0.3 M. In aspects comprising an alkali metal carboxylate salt, the alkali metal carboxylate salt can be present in similar amounts. In particular aspects of the disclosure, the zinc salt and/or the alkali metal carboxylate salt are present in an amount that provides a concentration, in the polar aprotic solvent, ranging from 0.01 M to 0.5 M, such as 0.05 M to 0.5 M, or 0.1 M to 0.5 M, or 0.1 M to 0.3 M. In some aspects of the disclosure, the non-aqueous zinc-based electrolyte is a solution. In an independent aspect of the disclosure, the non-aqueous zinc-based electrolyte is formulated as a solid or a semi-solid.

The non-aqueous zinc-based electrolyte can be combined with an electrode set-up to provide an optoelectronically dynamic element. In some aspects of the disclosure, the electrode set-up comprises a working electrode and a counter electrode.

The working electrode typically is transparent in its native state and can be made of any suitable material, such as a conductive material or a non-conductive material (e.g., glass and/or polymeric material) that can be combined with a conductive material. In some aspects, the working electrode comprises a conducting glass material, such as a conductive metal oxide material. In particular aspects, the working electrode comprises a glass substrate upon which a conductive metal oxide material has been deposited. Exemplary conductive metal oxide materials can include, but are not limited to, platinum nanoparticle coated indium oxide (Pt-ITO), tin-doped indium oxide (ITO), fluorine-doped tin oxide (FTO), indium zinc oxide (IZO), aluminum-doped zinc oxide (AZO), indium tin zirconium oxide (ITZO), indium gallium oxide (IGO), indium gallium zinc oxide (IGZO), tin oxide (SnO), zinc tin oxide (ZTO), gallium-doped zinc oxide, boron-doped zinc oxide, yttrium-doped zinc oxide, scandium-doped zinc oxide, silicon-doped zinc oxide, germanium-doped zinc oxide, or any combination thereof. In certain aspects of the disclosure, the conductive metal oxide is selected from aluminum-doped zinc oxide (AZO), tin-doped indium oxide (ITO), or fluorine-doped in oxide (FTO). In representative aspects of the disclosure, platinum nanoparticle-coated indium oxide is used. In certain aspects of the disclosure, the working electrode comprises a thin film of the conductive metal oxide material coated onto a substrate made of glass or other transparent (polymeric) surface or backing glass such that the conductive metal oxide material fully or partially covers the substrate.

The counter electrode also can be transparent and may comprise a conductive material, such as a metal. In some aspects of the disclosure, the counter electrode comprises a metal and a non-metal substrate, such as a glass or polymeric substrate. In some aspects, the metal can provide a frame in which the glass substrate can fit. In yet additional aspects, the metal and/or any non-metal structure can form part or all of a frame or support that encloses the electrode set-up. In certain aspects of the disclosure, the counter electrode comprises zinc and a glass substrate, wherein the zinc may be deposited on the glass substrate in any suitable form. The zinc may be in the form of a foil, a wire, woven wires (e.g., a grid comprising zinc), a metal-coated substrate, a metal alloy (e.g., zinc aluminum, brass, or other zinc alloy including zinc silver or zinc gold), or any combination thereof. In particular aspects of the disclosure, the working electrode serves as a cathode and the counter electrode serves as an anode.

The size of the working electrode onto which the opaque zinc-containing coating is deposited will depend upon the application for which the optoelectronically dynamic element containing the electrode is used. Although the dimensions of the working and counter electrodes will vary as a function of the use to which the optoelectronically dynamic element is employed, for best aesthetics, those comprising conductive metal oxides (e.g., ITO and/or FTO) are typically layered onto a glass substrate and the counter electrode comprises a metal material, such as wires, a foil, and/or a woven grid of metal. In some such aspects, wires used with a counter electrode can have a width of 50 microns or less (such as ranging from about 0.05 microns up to about 50 microns, including 1 to 50 microns, or 5-50 microns, or 10-25 microns, or 15-35 microns).

The non-aqueous zinc-based electrolyte is positioned between the working and counter electrodes. The working electrode comprises first and second working electrode surfaces and the counter electrode comprises first and second counter electrode surfaces. The non-aqueous zinc-based electrolyte typically is positioned between the first working electrode surface and the first counter electrode surface. In some aspects of the disclosure, the electrodes and the non-aqueous zinc-based electrolyte are enclosed in a frame or border. In some such aspects, the frame can be metallic and function as the counter electrode and can further include an inert material as insulation. In some other such aspects, the frame can be an inert material such as a polymeric material (e.g., plastic, rubber, or the like) or other appropriate material. The electrodes can be electrically coupled by a power source that links the working and counter electrodes. The power source can be used to provide a voltage to the optoelectronically dynamic element comprising the electrode set-up and the non-aqueous zinc-based electrolyte. In some aspects of the disclosure, the power source is configured to deliver a voltage suitable to allow for electrodeposition of Zn on the surface of the working electrode (usually at a negative voltage) or reversal of the electrodeposition process (usually at a positive voltage) to facilitate stripping Zn from the surface of the working electrode. In some aspects of the disclosure, the voltage provided by the power source ranges from −3.0 V to +2.0 V. In certain aspects, the negative voltage used to promote Zn electrodeposition ranges from −3.0 V to −0.1 V, such as −2.5 V to −0.1 V, or −2.0 V to −0.1 V, or −1.5 V to −0.1 V, or −1.0 V to −0.1 V, or −0.9 V to −0.4 V. In certain aspects, the positive voltage used to promote Zn stripping from the working electrode ranges from +0.1 V to +2.0 V, such as +0.5 V to +2.0 V, or +1.0 V to +2.0 V. Exemplary schematic illustrations of set-ups comprising the non-aqueous zinc-based electrolyte and the two electrodes are provided in FIGS. 1, 2, and 3, which are discussed below in more detail.

FIG. 1 shows components of a set-up 100 that can be used to prepare an optoelectronically dynamic element according to an aspect of the present disclosure. Set-up 100 includes a working electrode 102 (e.g., a cathode), which typically comprises a transparent metal oxide (e.g., a platinum nanoparticle-coated indium tin oxide or “ITO”) deposited on a glass substrate. The working electrode 102 can switch from its natural transparent state to a non-transparent state by formation of an opaque zinc-containing coating comprising zinc metal (and optional related oxidized metal species) formed on a surface of the working electrode. The opaque zinc-containing coating can reversibly be stripped using suitable voltage settings to thereby convert the non-transparent working electrode back to its transparent state. A non-aqueous zinc-based electrolyte solution 104 is positioned such that it contacts a first working electrode surface of the working electrode 102 and a first counter electrode surface of the counter electrode. Non-aqueous zinc-based electrolyte solution 104 provides zinc ions for the reversible opaque zinc-containing coating deposition. Counter electrode 106 functions as an anode and acts as a source for zinc ions according to the electrochemical reaction during switching. Counter electrode 106 also comprises a glass backing 108 and further can provide structural integrity for the optoelectronically dynamic element. In FIG. 1, the counter electrode 106 is fashioned as a frame for the optoelectronically dynamic element.

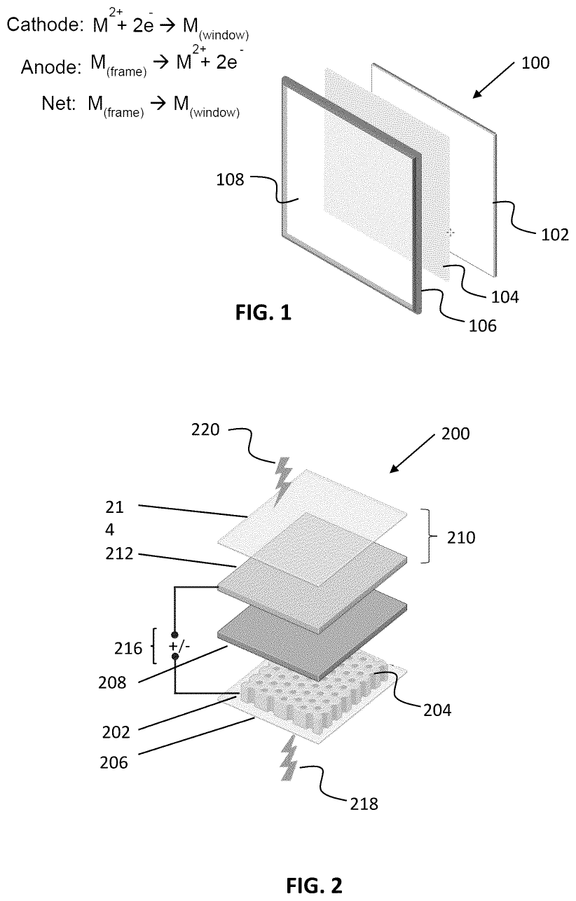

FIG. 2 provides another illustration of an exemplary optoelectronically dynamic element. In FIG. 2, optoelectronically dynamic element 200 comprises working electrode 202, which comprises a Pt-ITO layer 204 on a glass substrate 206. Working electrode 202 switches from its natural transparent state to a non-transparent state as a consequence of electrodeposition of an opaque zinc-containing coating onto the surface of the working electrode. Working electrode 202 switches back to its transparent state by removal/stripping of the opaque zinc-containing coating from the surface of the working electrode. The non-aqueous zinc-based electrolyte solution 208 is provided as a liquid or semi-solid and contains a zinc salt (e.g., a zinc halide salt, zinc carboxylate salt, or a combination thereof) that provides metal ions (Zn²⁺) for deposition. Counter electrode 210, which comprises metal 212 and glass substrate 214, serves as a source for Zn metal ions for deposition onto the working electrode 202. A power source of applied voltage 216 for the window is also illustrated. Outdoor reflectance (with light entering at bottom of window) and indoor reflectance (with light entering at top of window) are represented by light symbols 218 and 220, respectively.

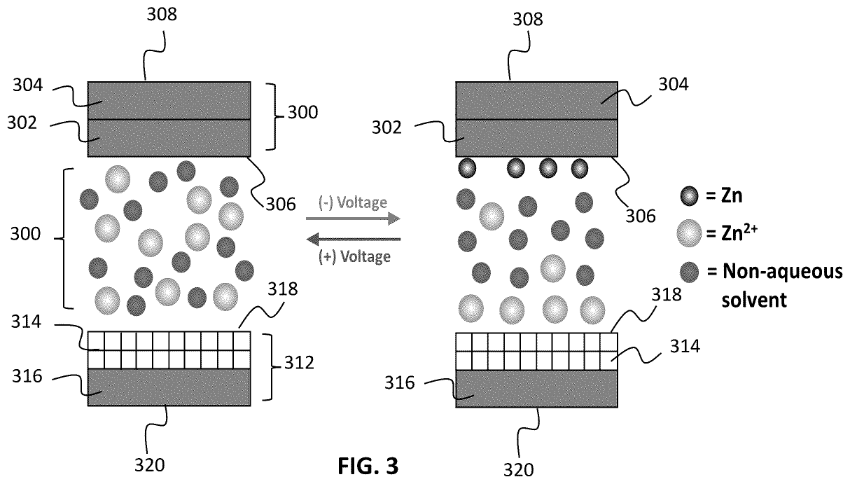

FIG. 3 provides a schematic illustration of the state of the optoelectronically dynamic element and its components when different voltage application events occur, including reversible Zn electrodeposition on a platinum nanoparticle-coated ITO film formed on a glass substrate (providing a working electrode) and a Zn-functionalized glass substrate (providing a counter electrode). With reference to FIG. 3, the working electrode 300 comprises a Pt-ITO layer 302 formed on a glass substrate 304. The working electrode 300 has a first working electrode surface 306 and a second working electrode surface 310. The counter electrode 312 comprises a metal layer 314 (e.g., zinc layer) formed on a glass substrate 316. Counter electrode 312 comprises a first counter electrode surface 318 and a second counter electrode surface 320. A non-aqueous zinc-based electrolyte 322 (comprising Zn²⁺ ions and a non-aqueous solvent, with optional additives) is positioned between first working electrode surface 306 and first conductive electrode surface 318. Upon application of a negative voltage (with respect to the working electrode; represented by the arrow labeled “(−) Voltage” in FIG. 3), the optoelectronically dynamic element switches from transparent to non-transparent due to Zn²⁺ ion reduction to an opaque metallic Zn coating that is electrodeposited (“Zn” as illustrated in FIG. 3) on first working electrode surface 306. Concurrently, the Zn metal included in zinc layer 314 present in counter electrode 312 is oxidized to Zn²⁺. Upon flipping the polarity of the potential (represented by the arrow labeled “(+) Voltage” in FIG. 3), the opposite reactions occur, and the optoelectronically dynamic element switches back to its original transparent state as the opaque zinc layer is stripped from the first working electrode surface 306.

Electrode set-ups comprising the non-aqueous zinc-based electrolyte of the present disclosure can be used to construct optoelectronically dynamic elements, such as windows, films, lenses, flat-panel displays, polymer-based electronics, thin film photovoltaics, glass doors, tools/devices used in X-ray diffraction and scanning electron microscopy analysis, among others. Optoelectronically dynamic elements comprising a non-aqueous zinc-based electrolyte according to the present disclosure exhibit quick switching between transparent and non-transparent states without degradation over the course of up to several months or more, including several years or more. In some aspects of the disclosure, optoelectronically dynamic elements comprising a non-aqueous zinc-based electrolyte according to the present disclosure can exhibit cycle stability of at least 1,000 cycles, often up to 5,000 cycles, or up to 10,000 cycles or more. The high opacity, reversibility, and stability of optoelectronically dynamic elements comprising a non-aqueous zinc-based electrolyte according to the present disclosure represent significant improvements over existing optoelectronically dynamic materials that utilize aqueous electrolyte solutions used in the art.

The non-aqueous zinc-based electrolyte of the present disclosure substantially reduces or eliminates the formation of side products produced during implementation of the electrolyte, such as (but not limited to) H₂ evolution and Zn oxide and/or Zn hydroxide formation, which are side products that have been shown to occur in aqueous solution and hinder the reversibility of Zn electrodeposition and product reliability. The non-aqueous zinc-based electrolyte of the present disclosure also improves efficiency of optoelectronically dynamic elements comprising the electrolyte, especially with respect to switching speed between stages of opaqueness and transparency, and long-term reliability of such elements. Further, the non-aqueous zinc-based electrolytes of the present disclosure facilitate making optoelectronically dynamic elements that exhibit high optical clarity and low values of haze (e.g., often less than 2%) during switching events. In addition to their excellent visible light modulation capabilities, optoelectronically dynamic elements comprising a non-aqueous zinc-based electrolyte according to the present disclosure also dynamically control infrared light, which is important for heat transfer into buildings. For example, a solar heat gain coefficient (SHGC) in an insulated glass unit can be minimized to less than 0.05, often less than 0.025, 0.015 or 0.01 in some aspects.

### Methods

Disclosed herein is a method of using the non-aqueous zinc-based electrolyte disclosed herein to provide optoelectronically dynamic elements that can switch between transparent and non-transparent states. Also disclosed is a method for using optoelectronically dynamic elements comprising the non-aqueous zinc-based electrolyte. In some aspects of the disclosure, the method comprises applying a voltage to the optoelectronically dynamic element to form the opaque zinc-containing coating on the transparent working electrode thereby convert the transparent working electrode to a non-transparent working electrode and applying a different voltage to the optoelectronically dynamic element to remove the opaque zinc-containing coating thereby converting the non-transparent working electrode back to the transparent working electrode. In particular aspects, the method comprises applying a voltage ranging from −3.0V to −0.1V to the optoelectronically dynamic element to form the opaque zinc-containing coating on the transparent working electrode thereby converting the transparent working electrode to a non-transparent working electrode and applying a voltage ranging from +0.1V to +2.0V to the optoelectronically dynamic element to remove the opaque zinc-containing coating thereby converting the non-transparent working electrode back to the transparent working electrode. In particular aspects of the disclosure, the opaque zinc-containing coating has a color that ranges from grey to black.

In some aspects of the disclosure, the voltage used in the method is either a negative voltage or a positive voltage. In certain aspects, a negative voltage, often ranging from −3.0V to −0.1V, such as −2.5V to −0.1V, or −1.5V to −0.1V, or −1.0V to −0.1V, or −0.9V to −0.4V is used to deposit the opaque zinc-containing coating onto the working electrode. In certain aspects, a positive voltage often ranging from +0.1V to +2.0V, often +0.1 V to +1.7 V or +0.1V to +1.0V is used to remove the opaque zinc-containing coating from the working electrode. Current densities for the electrodes typically range from +−0.01 to 10 mA/cm². The voltage is applied through a dynamic voltage source to the optoelectronically dynamic element comprising the electrode set-up. In particular aspects, the voltage is applied through a dynamic voltage source to the working electrode (e.g., cathode) at a voltage input between −3.0V to +2.0V, and is often switchable between at least two predetermined voltages (e.g., a preset negative voltage and a preset positive voltage) to either convert the working electrode from transparent to non-transparent or to convert it from non-transparent to transparent. The potential difference in voltage between the working electrode and the counter electrode facilitates the electrodeposition/stripping of the opaque zinc-based coating. A variable DC power supply with a switch or an alternative power source, such as an optoelectronic cycler, may be used to provide the appropriate voltages. In some aspects of the disclosure, the power source is programmable.

In some aspects of the disclosure, the non-aqueous zinc-based electrolyte can be used with electrode components to provide transparent conducting electrodes exhibiting light transmissibility (e.g., 75-80% or more light transmissibility at 400-750 nm, such as 600 nm) when the working electrode is in its native transparent state and reduced light transmissibility (e.g., <1% light transmissibility at 400-750 nm, such as 600 nm) after formation of the opaque zinc-containing coating formed from the non-aqueous zinc-based electrolyte. In some aspects of the disclosure, the working electrode can switch from its transparent state to a non-transparent state in short time period, such as less than 5 minutes, less than 3 minutes (e.g., 1-2 minutes), less than 2 minutes, or even within a period of seconds (e.g., 20-30 seconds or less). Similar switching times can be observed when converting the working electrode from non-transparent back to transparent. It will be recognized by those in the art with the benefit of the present disclosure that the time period for switching may depend on the size of the optoelectronically dynamic element as smaller elements may switch faster than larger elements.

The present disclosure provides high-performance dynamic materials based on reversible electrodeposition of Zn from non-aqueous zinc-based electrolytes comprising a Zn salt and a polar aprotic solvent. The optoelectronically dynamic materials according to the present disclosure avoid the drawbacks associated with conventional dynamic materials. The Zn salts according to the present disclosure are highly soluble at a pH of 5, which greatly improves device shelf life. Furthermore, the electrodeposition of Zn results in a much more compact metal morphology than Bi—Cu electrodeposits, and therefore dynamic materials (such as windows) based on Zn electrodeposition can reach privacy level opacity (e.g., <0.1% transmission) in less than one minute. The electrolyte according to the present disclosure supports electrochemically (>99% Coulombic efficiency) and optically reversible Zn electrodeposition with high optical contrast (from ˜75% clear-state transmission to <0.1% dark-state transmission). The optoelectronic reversibility of the Zn electrodeposition enables dynamic materials or devices to cycle thousands of times without degradation in optical contrast. Additionally, the electrolyte facilitates the formation of a compact Zn or Zn alloy electrodeposit morphology that blocks light efficiently, which reduces the current needed and makes the electrolyte particularly suitable for materials and devices of large sizes, because of the minimal voltage drop across the transparent working electrode. Further, the noncorrosive nature of the electrolyte allows the dynamic materials and devices to have long-term shelf lives, and dark-state stability in the absence of an applied power.

### Overview of Several Aspects

Disclosed herein is an optoelectronically dynamic element, comprising: a transparent working electrode comprising a first working electrode surface and a second working electrode surface; a counter electrode comprising a metal and a first counter electrode surface and a second counter electrode surface; and a non-aqueous zinc-based electrolyte positioned between the first working electrode surface and the first counter electrode surface, the non-aqueous zinc-based electrolyte comprising (i) a polar aprotic solvent and (ii) a zinc salt and/or ions thereof, wherein (i) the first working electrode surface faces the first counter electrode surface, and (ii) wherein the transparent working electrode comprises an opaque zinc-containing coating deposited directly or indirectly on the first working electrode surface when a voltage ranging from −3.0V to −0.1V is applied to the optoelectronically dynamic element.

In any or all aspects herein, at least a portion of the opaque zinc-containing coating disassociates from the first working electrode surface when a voltage ranging from +0.1V to +2.0V is applied to the optoelectronically dynamic element.

In any or all of the above aspects, the non-aqueous zinc-based electrolyte comprises a second metal salt comprising lithium, sodium, potassium, iron, nickel, tin, aluminum, cobalt, manganese, gallium, titanium, indium, boron; any ions thereof; and/or or any combination thereof.

In any or all of the above aspects, the second metal salt is selected from lithium chloride, nickel acetate, tin chloride, sodium acetate, lithium difluoroacetate, potassium acetate, lithium acetate, lithium bromide, sodium fluoride, cobalt chloride, cobalt acetate, lithium trifluoroacetate, manganese chloride, indium chloride, aluminum chloride, nickel chloride, indium acetate, boron trichloride, gallium chloride, titanium chloride, or any combination thereof.

In any or all of the above aspects, the opaque zinc-containing coating further comprises indium, manganese, nickel, iron, tin, cobalt, aluminum, or any combination thereof.

In any or all of the above aspects, the zinc salt comprises a counterion selected from a carboxylate ion, a halide ion, a weakly coordinating anion, or any combination thereof.

In any or all of the above aspects: the carboxylate ion is selected from formate, acetate, trifluoroacetate, propionate, butyrate, or any combination thereof; the halide ion is selected from fluoride, chloride, bromide, iodide, or any combination thereof; and/or the weakly coordinating anion is selected from tetrafluoroborate (BF₄⁻), hexafluorophosphate (PF₆⁻), perchlorate (ClO₄⁻), triflate (CF₃SO₃⁻), or any combination thereof.

In any or all of the above aspects, the non-aqueous zinc-based electrolyte further comprises at least one alkali metal carboxylate salt, wherein an alkali metal of the alkali metal carboxylate salt is selected from lithium, sodium, or potassium.

In any or all of the above aspects, the zinc salt is present in the non-aqueous zinc-based electrolyte at a concentration ranging from 0.01 M to 5.0 M.

In any or all of the above aspects, the working electrode comprises a conductive metal oxide material disposed directly on the first working electrode surface.

In any or all of the above aspects, the opaque zinc-containing coating is deposited directly on the conductive metal oxide material.

In any or all of the above aspects, the conductive metal oxide material is platinum nanoparticle coated indium oxide (Pt-ITO), tin-doped indium oxide (ITO), fluorine-doped tin oxide (FTO), indium zinc oxide (IZO), aluminum-doped zinc oxide (AZO), indium tin zirconium oxide (ITZO), indium gallium oxide (IGO), indium gallium zinc oxide (IGZO), tin oxide (SnO), zinc tin oxide (ZTO), gallium-doped zinc oxide, boron-doped zinc oxide, yttrium-doped zinc oxide, scandium-doped zinc oxide, silicon-doped zinc oxide, germanium-doped zinc oxide, or any combination thereof.

In any or all of the above aspects, the conductive metal oxide material is platinum nanoparticle coated indium oxide (Pt-ITO), aluminum-doped zinc oxide (AZO), tin-doped indium oxide (ITO), or fluorine-doped in oxide (FTO).

In any or all of the above aspects, the conductive metal oxide material is layered on a substrate.

In any or all of the above aspects, the metal of the counter electrode is in the form of a foil, a wire, a metal coated substrate, or a metal alloy.

In any or all of the above aspects, the metal of the counter electrode is zinc.

In any or all of the above aspects, the non-aqueous zinc-based electrolyte further comprises a leveling agent selected from thiourea, cetyltrimethyl ammonium bromide, sodium dodecyl sulfate, or a combination thereof.

In any or all of the above aspects, the polar aprotic solvent is selected from dimethyl sulfoxide (DMSO), dimethylacetamide (DMA), dimethylformamide (DMF), acetonitrile, dimethylpropylene urea (DMPU), ethyl acetate, pyridine, hexamethylphosphoramide (HMPA), hexamethylphosphoric triamide (HMPT), sulfolane, ethyl acetate, dichloromethane, 1,2-dimethoxyethane, 1,1-diethoxyethane, 1,2-diethoxyethane, tetramethylurea, 1-methoxy-2-(2-methoxyethoxy)ethane, 1-ethoxy-2-(2-ethoxyethoxy)ethane, 1,2-bis(2-methoxyethoxy)ethane, bis[2-(2-methoxyethoxy)ethyl] ether, propionitrile, butyronitrile, N-methyl-2-pyrrolidone (NMP), bis(2-ethoxyethyl) ether, bis(2-methoxyethyl) ether, triethylene glycol dimethyl ether, tetraethylene glycol dimethyl ether, or a combination thereof.

In any or all of the above aspects, the polar aprotic solvent is selected from DMSO, DMA, DMF, acetonitrile, propionitrile, butyronitrile, HMPA, bis(2-ethoxyethyl) ether, triethylene glycol dimethyl ether, tetraethylene glycol dimethyl ether, or a combination thereof.

In any or all of the above aspects, the non-aqueous zinc-based electrolyte further comprises an ammonium salt selected from tetramethylammonium chloride, tetrabutylammonium hexafluorophosphate, or a combination thereof.

Also disclosed herein is a method of using the optoelectronically dynamic element according to any or all of the above aspects, the method comprising: applying a voltage ranging from −3.0V to −0.1V to the optoelectronically dynamic element to form the opaque zinc-containing coating on the transparent working electrode thereby convert the transparent working electrode to a non-transparent working electrode; and applying a voltage ranging from +0.1V to +2.0V to the optoelectronically dynamic element to remove the opaque zinc-containing coating thereby converting the non-transparent working electrode back to the transparent working electrode.

In any or all of the above aspects, the non-transparent working electrode allows less than 0.1% light transmission at 400-750 nm and wherein the transparent working electrode allows at least 80% light transmission at 400-750 nm.

In any or all of the above aspects, the transition from the transparent working electrode to forming the non-transparent working electrode takes place in two minutes or less.

Also disclosed herein is a non-aqueous zinc-based electrolyte composition for use in preparing an optoelectronically dynamic element, the non-aqueous zinc-based electrolyte composition comprising a polar aprotic solvent and a zinc salt and/or ions thereof.

### EXAMPLES

General Procedures—All chemicals were purchased from commercial suppliers and used without further purification unless specified otherwise. Electrolytes and devices were prepared in an Ar-filled glove box maintained at <0.1 ppm O₂ and <0.1 ppm H₂O. Anhydrous DMSO was obtained from Millipore-Sigma and was further dried for at least one week using successive rounds of 4 Å molecular sieves (Oakwood Chemical). All salts used in non-aqueous zinc-based electrolytes were nominally anhydrous and stored in the glove box. Sodium acetate (99.99%), ZnCl₂ (99.99%), and sodium formate (99%) were obtained from Oakwood Chemical. Zinc acetate (99.99%) was procured from ProChem, Inc. ZnBr₂ (99.999%) was purchased from Alfa Aesar. Zinc formate (98%) and sodium propionate (99%) were obtained from Thermo Fischer.

The anhydrous salts used in the Zn—PrCN electrolytes according to examples described below were stored in an Ar-filled glove box (<1 ppm O₂ and <0.1 ppm H₂O). Anhydrous PrCN and MeCN were acquired from Millipore-Sigma and further dried over 4 Å molecular sieves from Oakwood Chemical for at least a week. LiCl (99.99%) and ZnCl₂ (99.99%) were obtained from Oakwood Chemical, while sodium propionate (99%) and sodium formate (98%) were acquired from Thermo Fisher Scientific Chemicals. ZnBF₄, LiPF₆, and tetra-n-butylammonium hexafluorophosphate were obtained from Thermo Fisher Scientific Chemicals, each with a purity of 99%. LiCF₃SO₃, tetramethylammonium chloride, and tetrabutylammonium chloride were also sourced from Oakwood Chemical. Additionally, PEG with an average Mn of 1,500 was procured from Sigma-Aldrich. LiClO₄ and NaCl were obtained from Alfa Aesar and Ward's Science, respectively.

Electrochemical Methods—Electrochemical methods were powered by a VSP-300 Biologic potentiostat. Cyclic voltammograms were measured using a three-electrode setup with a transparent conducting working electrode and separate pieces of Zn foil (99.99%, Leishent) as the counter and reference electrodes. The transparent working electrodes comprise ITO on glass (Xin Yan, 10 Ω/sq) modified with Pt nanoparticles (3 nm in diameter) and were prepared by following literature protocols. The Pt nanoparticles serve as inert seed layers that increase the uniformity of nucleation during RME. Transmission measurements were performed in conjunction with cyclic voltammetry in a 2 cm by 2 cm glass cuvette with a working electrode area of 2.4 cm². Long-term cycling experiments were conducted with a custom-built optoelectronic cycler.

Materials Characterization—All visible light transmission measurements were recorded using an Ocean Insight FLAME-S-VIS-NIR spectrometer and an Ocean Insight HL2000-FHSA light source. For two-electrode device measurements, 100% transmission was set equal to the transmission of open air. For certain windows, the transmission data were recorded at the center of the device through an open space in the Zn grid; however, some light was still blocked by the grid lines, which explains why the maximum transmissions of certain examples windows are lower than the clear-state values in the three-electrode measurements. For other certain examples, the transmission values reported account for any opacity of the grid and thus are indicative of the transmission of the entire device stack. Reflection and infrared light transmission data were measured using a Cary 50000 UV-VIS-NIR spectrometer with a universal measurement accessory. Haze was quantified using a VTSYIQI haze meter using ASTM D1003 measurement protocols and standard D65 lighting. Photographs were taken with a Google Pixel 5a cellular phone. SEM and energy-dispersive X-ray (EDX) analyses were conducted using a JEOL JSN-7100F field emission SEM at an acceleration voltage of 15 kV. AFM images were collected using a Nanosurf EasyScan 2 microscope operated in contact mode using silicon tips coated with aluminum (ContAl-G, TedPella, Inc.). The water content in the electrolytes was determined using a Mettler Toledo C10S coulometric Karl Fischer titrator.

Finite-difference Time-domain Calculations—Finite-difference time-domain calculations were performed with the program Lumerical Solutions. A planewave light source was orthogonally injected into a Zn thin film, and the refractive index of Zn was taken from Werner et al. Periodic and perfectly matched layer boundary conditions were adopted for the x, y, and z dimensions. A mesh volume of 1×1×1 nm³ was used for structural modeling of the Zn thin film.

### Example 1

In this example, non-aqueous zinc-based electrolytes based on nonaqueous solvents that support robust reversible Zn electrodeposition were developed. A seed layer of Pt nanoparticles on the ITO was used to promote uniform metal electrodeposition. Because these electrolytes are dry (˜30 ppm H₂O), Zn(OH)₂ formation is avoided during electrodeposition, which greatly extends the cyclability of the devices. It was demonstrated that properly designed non-aqueous zinc-based electrolytes facilitate reversible Zn electrodeposition with up to 99.5% Coulombic efficiency and allow for practical two-electrode dynamic windows to switch thousands of times without degradation in optical contrast or switching speed. Dynamic windows were constructed, which achieved uniform clear-to-black switching across the entire windows. Taken together, these results demonstrate that Zn-based dynamic windows with non-aqueous zinc-based electrolytes are promising for commercial applications.

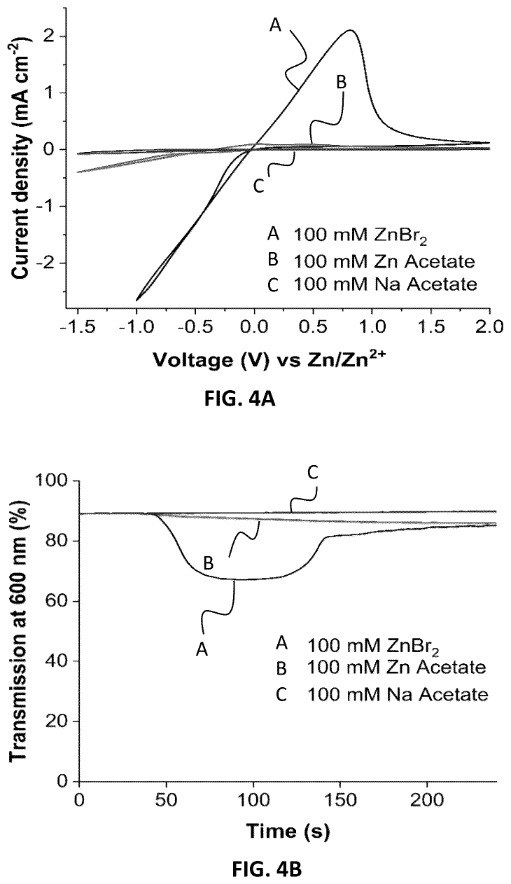

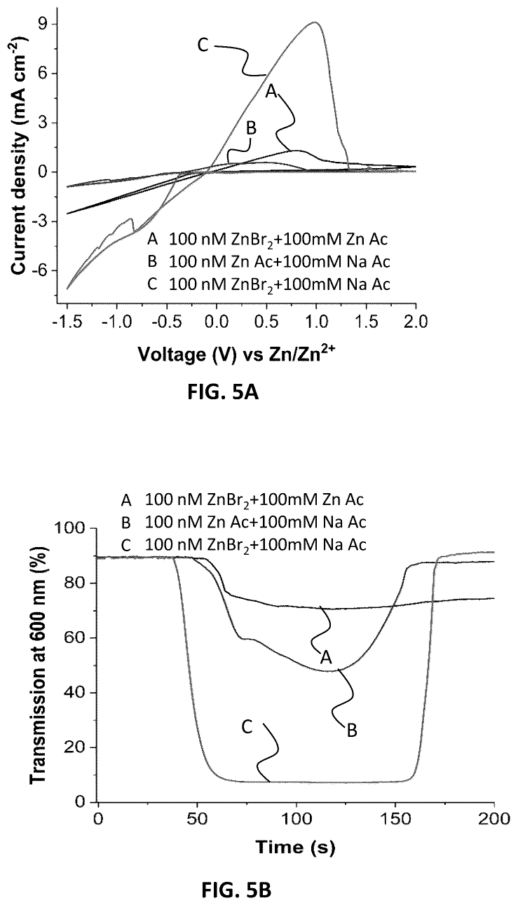

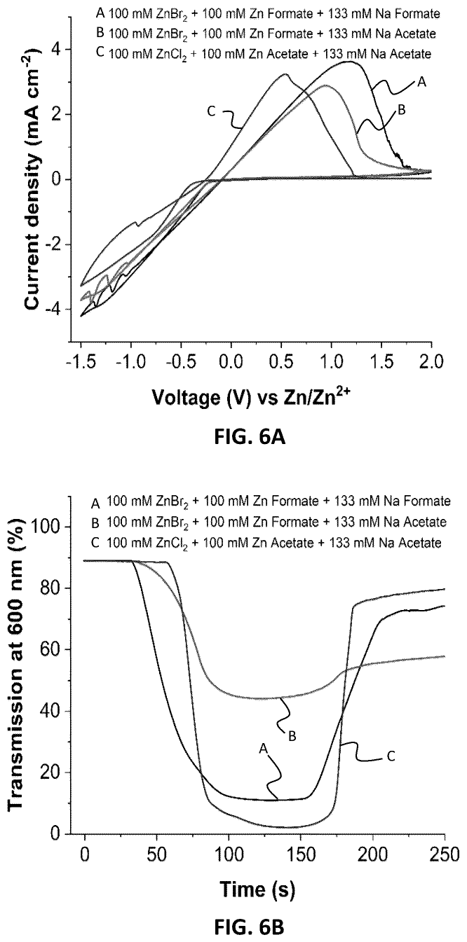

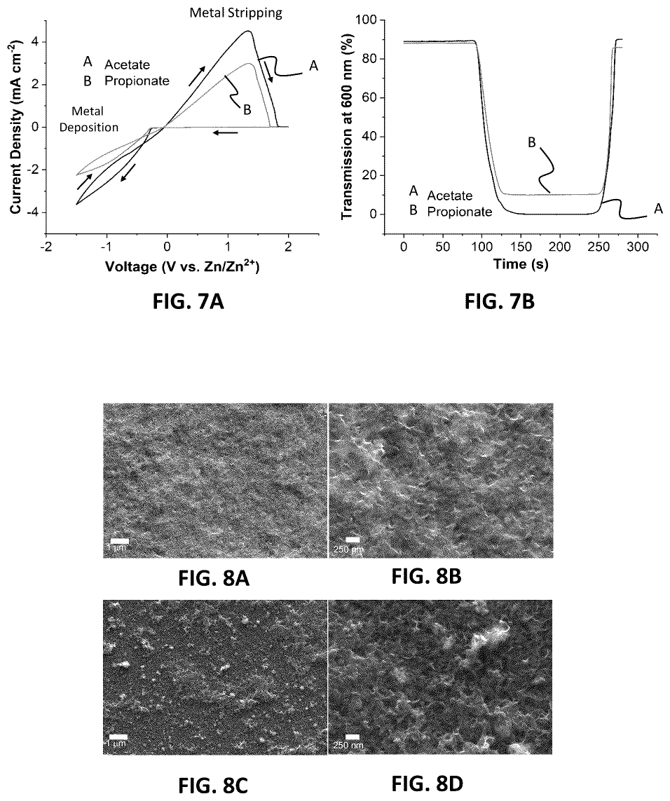

Electrolytes comprising different Zn halides, Zn carboxylates, sodium carboxylates, or a combination thereof were evaluated for reversible Zn electrodeposition. Different non-aqueous zinc-based electrolytes compositions were prepared and evaluated, with results shown in FIGS. 4A, 4B, 5A, 5B, 6A, and 6B. Cyclic voltammograms (CVs) (obtained using a three-electrode system) and corresponding transmission curves are shown in FIGS. 7A and 7B, respectively. As can be seen, the electrolytes systems demonstrated excellent electrochemical and optical reversibility. The electrolytes in FIGS. 7A and 7B comprise ZnBr₂, Zn acetate, and either sodium acetate or sodium propionate. When sweeping in the negative direction, cathodic current begins with Zn metal electrodeposition at an onset potential of −0.26 V vs. Zn/Zn²⁺ for both electrolytes (FIG. 7A). Moreover, during the positive-going sweep, both CVs exhibit a metal stripping peak at +1.3 V vs. Zn/Zn²⁺. The transmissions of the electrodes correspondingly decrease during metal electrodeposition before returning to their original values after the completion of metal stripping (FIG. 7B). These results demonstrate that both electrolytes support optically reversible Zn electrodeposition on ITO. The Coulombic efficiencies, which are indicative of the degree of electrochemical reversibility, are 94.3% and 99.5% for the acetate and propionate electrolytes, respectively. The high Coulombic efficiencies of both electrolytes show that these systems support fairly reversible Zn electrodeposition. Despite the higher Coulombic efficiency of the propionate electrolyte, the minimum transmission at 600 nm of the electrode does not decrease past 10% (FIG. 7B, line B) due to the three-dimensional and nonuniform growth behavior of the Zn electrodeposits (FIGS. 8A-8D). In contrast, the minimum transmission of the electrode in the acetate electrolyte is less than 1% (FIG. 7B, line A) because of a much smoother Zn electrodeposit morphology. The ability of the acetate electrolyte to produce highly opaque Zn films is highly desirable.

### Example 2

With optically and electrochemically reversible Zn DMSO electrolytes in hand, two-electrode dynamic windows were constructed. Two-electrode dynamic windows were constructed using a Pt-modified ITO on glass working electrode and a Zn grid counter electrode on a glass backing. Conductive Cu tape was used along the perimeter of the working electrode to establish electrical connection. A commercially available Zn grid (Kwikmesh) with a ˜1 cm interwire spacing and a 3 mm wire diameter was used. For all windows, butyl rubber (Solargain, Quanex, Inc.) was placed on the perimeter of the electrodes and used for device sealing. The polymer hydroxyethylcellulose (1.0% w/v, average Mᵥ˜90,000) was added to the electrolytes to increase their viscosity and limit electrolyte leakage. Electrolyte was injected into devices through the butyl rubber sealant using a syringe and 22-gauge needle. The thickness of electrolyte in the sealed devices was about 1.5 mm.

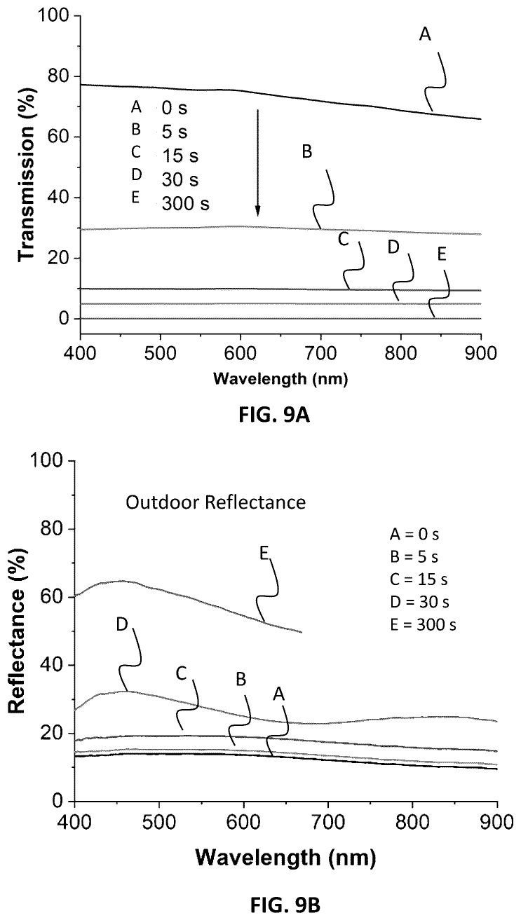

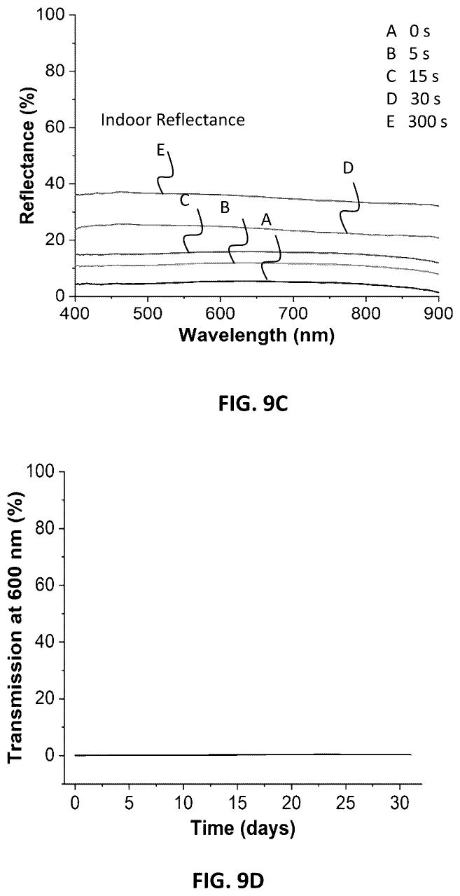

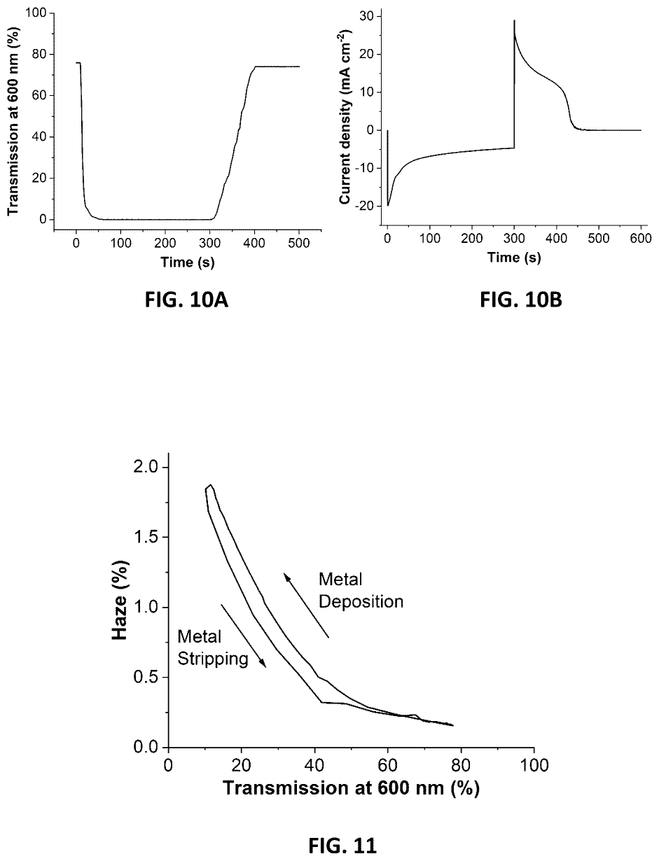

At a tinting voltage of −0.9 V, these windows switch from a ˜75% transmission clear state in the visible spectrum (400 nm to 700 nm) to a ˜5% dark state after 30 seconds and a <0.1% dark state after 300 seconds (FIG. 9A). Starting from a <0.1% dark state, the original clear state of the window is restored within 100 seconds by applying +1.0 V (FIGS. 10A and 10B). During the growth of the metal film, the reflection of the dynamic windows increases, but there is still significant absorption, giving rise to a black appearance. The magnitude of the reflection differs depending upon the orientation of the device stack with respect to the incoming light. In particular, reflection when light first shines through the Pt-ITO side of the device is greater than when light first shines through the metal mesh side of the device (FIGS. 9B and 9C). This orientation-dependent reflection has been observed in other RME windows and arises because the rougher top of the metal electrodeposits increases scattering and absorption compared to the base of the electrodeposits where the metal nucleates. To enhance the energy saving potential of dynamic windows in buildings, practical RME windows would be oriented to maximize reflection of light and heat (outdoor vs. indoor reflection, FIGS. 9B and 9C).

### Example 3

Color is an additional optical metric of dynamic windows, and color neutral switching from clear to grey to black is desired for most applications. In this example, the color of the RME windows during switching was quantified using the L*a*b* color space under standard clear-sky lighting conditions (D65 10° standard). The L*a*b* color space uses a scale that is linear with respect to the sensitivity of the human eye with a lightness (L*) value ranging from 0 (black) to 100 (white), a green-red value ranging from −128 (red) to +128 (green), and a blue-yellow value ranging from −128 (blue) to +128 (yellow). The distance away a color is from the (a*, b*)=(0, 0) origin is called chroma (C*) and is a quantitative measure of color neutrality. C* values less than 10 are generally considered grey and color neutral to the human eye. Table 1 shows L*a*b*C* values, and the best red, green, blue (RGB) color representations of the transmission of a Zn DMSO dynamic window during tinting. As shown, the C* value of the transmitted light consistently remains below 5 during tinting of the window, indicating high color neutrality (Table 1).

TABLE 1

| | | Green-red | Blue-yellow | Color | Best |
|---|---|---|---|---|---|
| Deposition | Lightness | coordinate | coordinate | neutrality | RGB |
| Time (s) | (L*) | (a*) | (b*) | (C*) | representation |
| 0 | 76.6 | −1.1 | −2.0 | 2.3 | [symbol] |
| 10 | 29.8 | 0.8 | 0.04 | 0.8 | [symbol] |
| 20 | 10.0 | 1.0 | −4.7 | 4.8 | [symbol] |
| 30 | 5.1 | 1.7 | −4.1 | 4.4 | [symbol] |

To completely characterize the aesthetics of dynamic windows, the optical clarity of the windows must also be assessed. Haze, which is a quantitative measure of optical clarity, is the percentage of transmitted light that is scattered. Because there is little diffuse transmittance in the Zn DMSO windows, they possess low values of haze (<2%) during switching, which indicates that the windows exhibit excellent optical clarity (FIG. 11).

For dynamic windows to be energy-efficient devices, their power consumption should be minimal. To achieve 5% transmission in the visible range, the Zn DMSO dynamic windows could use an average power ranging from 1-10 W m⁻² (e.g., 5 W m⁻²) during tinting, which is about equivalent to the power requirement of one household LED light bulb for a 1 m² window. Furthermore, the dynamic windows exhibit outstanding bistability, which means that energy is not required to keep the windows in a clear or dark state. For example, the transmission of a window after 300 seconds of tinting remains low at <0.5% even after 30 days of leaving the device unplugged (FIG. 9D). Taken together, these results demonstrate that it takes very little power to operate Zn DMSO dynamic windows, which increases their ability to save energy in buildings.

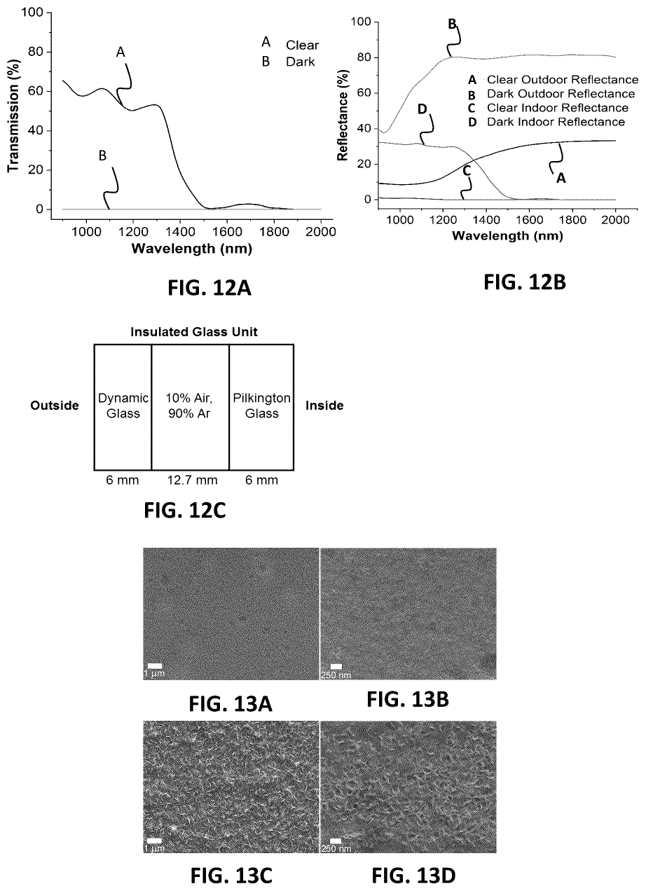

In addition to their excellent visible light modulation capabilities, the Zn DMSO dynamic windows also dynamically control infrared light, which is important for heat transfer into buildings (FIGS. 12A-12C). To quantify the ability of the Zn windows to modulate heat into a building, the solar heat gain coefficients (SHGCs) of the Zn windows were calculated in a modeled insulated glass unit (IGU). The WINDOW 7.7 software published by Lawrence Berkeley National Laboratory was used to model dynamic windows in insulated glass units (IGUs), which utilizes modeling methods according to the industry standards including ASHRAE SPC 142, ISO15099, and the NFRC. Standard dimensions of the IGUs were used and as shown in FIG. 12C. Pilkinton's Optifloat™ Clear glass was used as the interior IGU pane because of its neutral color and high transmission. The IGU interior was modeled as containing 90% Ar and 10% air, which is typical for energy-efficient IGUs. The emissivities of the glasses were set to 0.84 except for a low-emissivity coating at the interface of the dynamic glass and gas, which was set to 0.159. Table 2 shows visible light transmissions and SHGCs of IGUs modeled with the commercially available View Inc.'s Generation 4 dynamic glass, or the Zn DMSO dynamic glass of the present disclosure. All optical data for the View Inc.'s glass were obtained from Version 77 of the International Glazing Database. As shown in Table 2, the SHGC of the present Zn window in its opaque or dark state in an IGU is only 0.012, meaning that almost all of the solar heat gain is rejected by the present Zn window in its opaque or dark state. Under analogous conditions, the SHGC of a Generation 4 dynamic window in its darkest operation mode is much larger at 0.091.

TABLE 2

| | Visible Light | Solar Heat |
|---|---|---|
| | Transmission | Gain Coefficient |
| View Generation 4 Clear | 0.622 | 0.444 |
| View Generation 4 Dark | 0.01 | 0.091 |
| Zinc DMSO Metal Clear | 0.684 | 0.652 |
| Zinc DMSO Metal Dark | 0.001 | 0.012 |

These findings indicate that Zn DMSO materials and devices according to the present disclosure outperform the heat-shielding capabilities of the latest commercial dynamic windows.

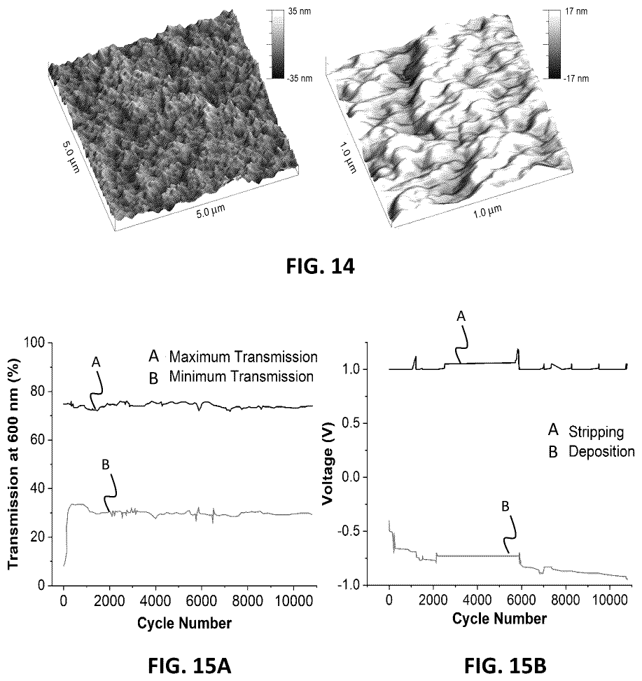

Scanning electron microscopy (SEM) images (FIGS. 13A-13D) and atomic force microscopy (AFM) images (FIG. 14) indicate that the Zn electrodeposits form a relatively smooth morphology when a Zn DMSO window is tinted to 10% transmission. This smooth morphology with hardly any nanoscale openings allows the window to efficiently block light, which explains how the devices can achieve such high opacity. At lower transmissions, a layer of nanowires grows on top of the smooth underlayer (FIGS. 13C and 13D). Regardless, the relatively low amount of charge required to switch the windows is indicative of the excellent light-blocking ability of the electrodeposited film. For example, only 17 mC cm⁻² are required for the device to attain 10% transmission. By comparison, windows based on an aqueous Bi—Cu electrolyte, even in the presence of a polymer additive to increase film smoothness, require 50 mC cm⁻² to switch to 10% transmission. Zn DMSO windows requiring about three times less charge to switch than existing RME devices facilitates uniform switching in large-area devices.

Interestingly, these results suggest that less electrodeposited Zn than as theoretically predicted will form a uniform thin film to afford a 10% transmission of the device. Calculations of theoretically predicted values are explained as follows. Because the clear-state transmission at 600 nm of the device is ˜75%, the Zn thin film needs to have a transmission of about 13.3% for the entire device stack to have 10% transmission at 600 nm. Beer's law is used to calculate the thickness of a perfectly uniform Zn film that possesses 13.3% transmission:

$$T = {e}^{\frac{- 4 πκ t}{λ}}$$

where T is transmission, K is the extinction coefficient, λ is the wavelength of light, and tis the thickness of the film. At λ=600 nm, K for Zn is 5.45, and so when T=0.133, t=17.7 nm. Therefore, a 17.7 nm uniform Zn thin film possesses 13.3% transmission at 600 nm. Using Faraday's law, the amount of charge required to electrodeposit the Zn per cm² of electrode area can be determined as follows:

$$\frac{17.7 nm Zn}{{cm}^{2} electrode} * \frac{1 cm}{{10}^{7} nm} * \frac{7.13 g}{{cm}^{3}} * \frac{1 mol Zn}{65.38 g} * \frac{2 mol {e}^{-}}{1 mol Zn} * \frac{96485 C}{1 mol {e}^{-}} = 37 mC {cm}^{- 2}$$

The equation

$$T = {e}^{\frac{- 4 πκ t}{λ}}$$

neglects additional attenuation from external and multiple internal reflections in the Zn thin film. Therefore, an accurate theoretical value of charge required is less than that obtained by Beer's law. Using finite-difference time-domain (FDTD) calculations, a more accurate theoretical value is achieved that accounts for additional optical interactions inside the Zn film. These calculations reveal that the Zn film can only be 12.3 nm thick to achieve T=0.133, which corresponds to 26 mC cm⁻² of charge required. Both the values obtained for a perfectly thin film from Beer's law and FDTD calculations are greater than the experimentally-determined charge of 17 mC cm⁻². This larger amount of charge density for a perfectly smooth Zn film means that the electrodeposited film in the Zn DMSO dynamic windows block light more efficiently than is expected by Beer's law and FDTD simulations, suggesting that other factors such as the nanostructure of the Zn film contribute to its opacity.

### Example 4

A grand challenge for dynamic window technology is cyclability. If a dynamic window is cycled between clear and dark states once a day for twenty years, it would switch over 7,000 times. Existing literature on practical two-electrode RME dynamic windows report a maximum of a few thousand cycles without substantial degradation in performance. In this example, it is demonstrated that the Zn DMSO window cycles more than 10,000 times with a relatively stable contrast ratio (FIG. 15A). This long cycle life is enabled by the excellent electrochemical and optical reversibility of the Zn DMSO electrolyte along with a varying applied voltage. During cycling, the switching speed of the window is kept constant at a 30-seconds deposition time and a 60-seconds stripping time. The applied voltages during each cycling segment are altered to maintain a stable contrast ratio (FIG. 15B). The applied voltages are controlled by an optoelectronic cycler that establishes feedback between device transmission and applied voltage.

Over the course of 10,000 cycles, the deposition voltage fairly steadily decreases from −0.5 V to −0.9 V (FIG. 15B, line B). The more negative applied voltage allows for the device to maintain a relatively constant minimum transmission at 600 nm of 30% during each cycle while keeping the device tinting speed constant at 30 seconds (FIG. 15A, line B). In contrast, the optoelectronic cycler keeps the device stripping voltage more or less consistent at +1.0 V throughout cycling to maintain a ˜75% clear-state transmission (FIGS. 15A and 15B, lines A).

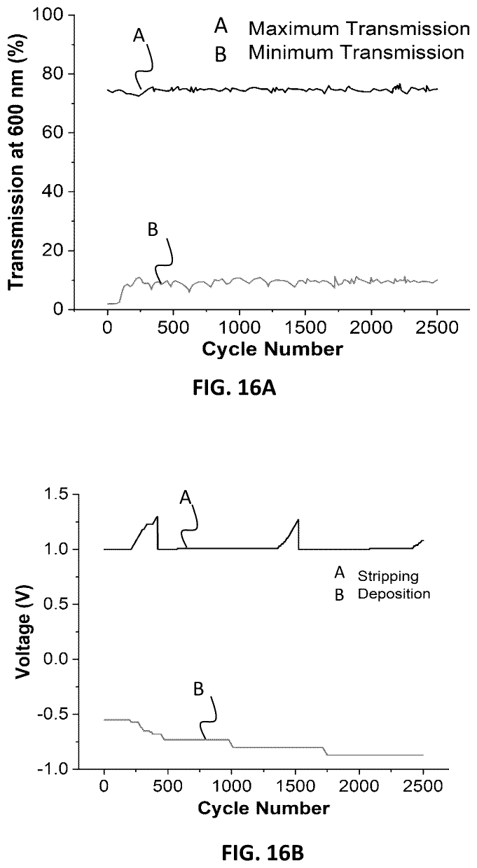

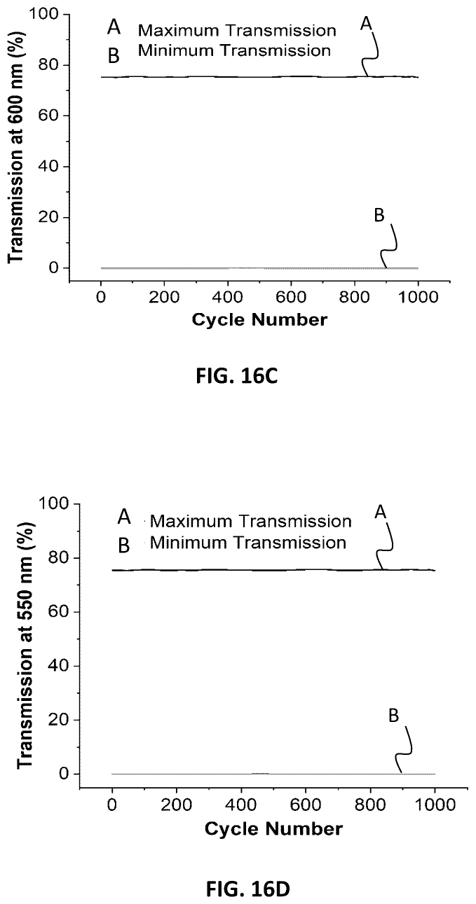

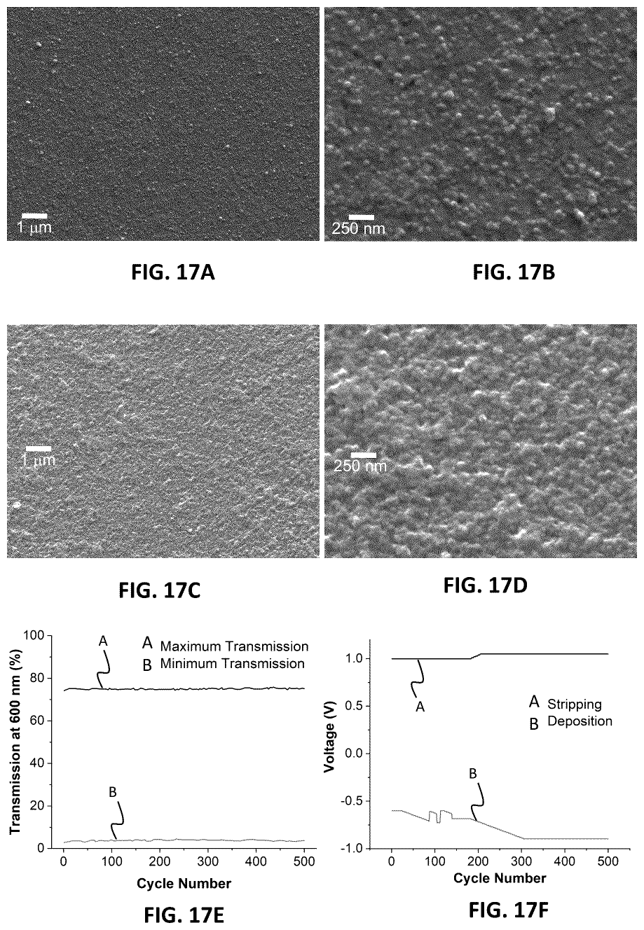

Deeper optoelectronic cycling to a minimum transmission of 10% or 0.1% is also feasible for 2,500 cycles or 1,000 cycles, respectively (FIGS. 16A-16D). The cycle life of dynamic windows is highly dependent upon the contrast ratio selected for cycling, and cycling dynamic windows to a darker state is known to accelerate degradation in a manner analogous to the deep cycling of batteries. Although the chemistries of the two devices can be substantially different, in both batteries and dynamic windows, the greater amount of charge passed during deeper cycling increases degradation. To interrogate further the origin of degradation during cycling, SEM images of the Zn electrodeposits were obtained and ¹H nuclear magnetic resonance (NMR) of the electrolyte after cycling was conducted. SEM images of the Zn electrodeposits at 10% transmission after cycling 500 times to 3% transmission or 10,800 times to 30% transmission indicate that the morphology of the Zn electrodeposits significantly changes after cycling (FIGS. 17A-17F). In both cases, the Zn electrodeposits coarsen and become less compact than before cycling (FIGS. 13A and 13B). Because less uniform particles block light less efficiently, the optoelectronic cycle must apply progressively more negative voltages to achieve the same transmission level during cycling. Furthermore, the electrodeposits produced after cycling 500 times to 3% transmission are less uniform than those produced 10,800 times to 30% transmission.

These results suggest that deeper cycling of the dynamic windows facilitates nonuniform growth of the electrodeposits on the microscale during cycling, which accelerates degradation. Significant changes in electrolyte composition also occur after cycling as indicated by 1H NMR spectroscopy. Under both cycling conditions, Zn hydroxyacetate complexes form in the electrolyte after cycling, which could also contribute to decreased switching times of the dynamic windows and thus necessitate the application of more negative voltages to achieve a constant optical contrast during optoelectronic cycling. Taken together, these results indicate that there are changes in both the Zn electrodeposit morphology and electrolyte composition during cycling.

In principle, the applied deposition voltage can be decreased to values more negative than −0.9 V to extend device cycle life beyond 10,000 cycles without sacrificing switching speed. However, H₂ bubbles were observed to slowly evolve from the ITO electrode in some examples when the device undergoes long-term cycling with a deposition voltage more negative than −0.9 V. The H₂ originates from reduction of residual water in the DMSO electrolyte, which despite rigorous drying, still has a nominal water content of about 30 ppm. Ideal gas law calculations show that this low concentration of water is still high enough to result in the quantity of observed bubble formation. The volume of water in the electrolyte (V_{H}_{₂}_{O}) is equal to the percentage of water in the electrolyte (χ_{H}_{₂}_{O}) multiplied by the volume of the electrolyte (Vₑ):

$${V}_{{H}_{2} O} = {ϰ}_{{H}_{2} O} {V}_{e}$$

The number of moles of water (n_{H}_{₂}_{O}) in the electrolyte is calculated from the volume of water, the density of water (d_{H}_{₂}_{O}), and the molar mass of water (m_{H}_{₂}_{O}):

$${n}_{{H}_{2} O} = \frac{{V}_{{H}_{2} O} {d}_{{H}_{2} O}}{{m}_{{H}_{2} O}}$$

Two moles of H₂O are required per mole of H₂ gas generated (n_{H}_{₂}):

$$2 {H}_{2} O + 4 {e}^{-} \to {H}_{2} + 2 {OH}^{-}$$

$${n}_{{H}_{2}} = \frac{{n}_{{H}_{2} O}}{2}$$

The volume of H₂ (V_{H}_{₂}) is calculated from the number of moles of H₂ using the ideal gas law:

$${V}_{{H}_{2}} = \frac{{n}_{{H}_{2}} RT}{{P}_{{H}_{2}}}$$

The fraction of H₂ (F_{H}_{₂}) evolved in the device's electrolyte is equal to the volume of H₂ divided by the electrolyte volume:

$${F}_{{H}_{2}} = \frac{{V}_{{H}_{2}}}{{V}_{e}}$$

Through a series of substitutions, the following relationship is obtained:

$${F}_{{H}_{2}} = \frac{{n}_{{H}_{2}} RT}{{P}_{{H}_{2}} {V}_{e}} = \frac{{n}_{{H}_{2} O} RT}{2 {P}_{{H}_{2}} {V}_{e}} = \frac{{V}_{{H}_{2} O} {d}_{{H}_{2} O} RT}{2 {P}_{{H}_{2}} {V}_{e} {m}_{{H}_{2} O}} = \frac{{ϰ}_{{H}_{2} O} {V}_{e} {d}_{{H}_{2} O} RT}{2 {P}_{{H}_{2}} {V}_{e} {m}_{{H}_{2} O}} = \frac{{ϰ}_{{H}_{2} O} {d}_{{H}_{2} O} RT}{2 {P}_{{H}_{2}} {m}_{{H}_{2} O}}$$

By setting

$${d}_{{H}_{2} O} = 1 , 000 \frac{g}{L} , R = 0.08206 \frac{L \cdot atm}{mol \cdot K} , T = 298 K , {P}_{{H}_{2}} = 1 atm , and {m}_{{H}_{2} O} = 18.016 \frac{g}{mol} ,$$

the following final expression is obtained:

$${F}_{{H}_{2}} = 679 {ϰ}_{{H}_{2} O}$$

when the concentration of water in the electrolyte is 30 ppm (χ_{H}_{₂}_{O}=3×10⁻⁵), F_{H}_{₂}=0.02. In other words, 2% of the electrolyte volume will contain H₂ bubbles, which is certainly visually noticeable. This 2% volume of H₂ gas is similar to the volume observed experimentally after cycling.

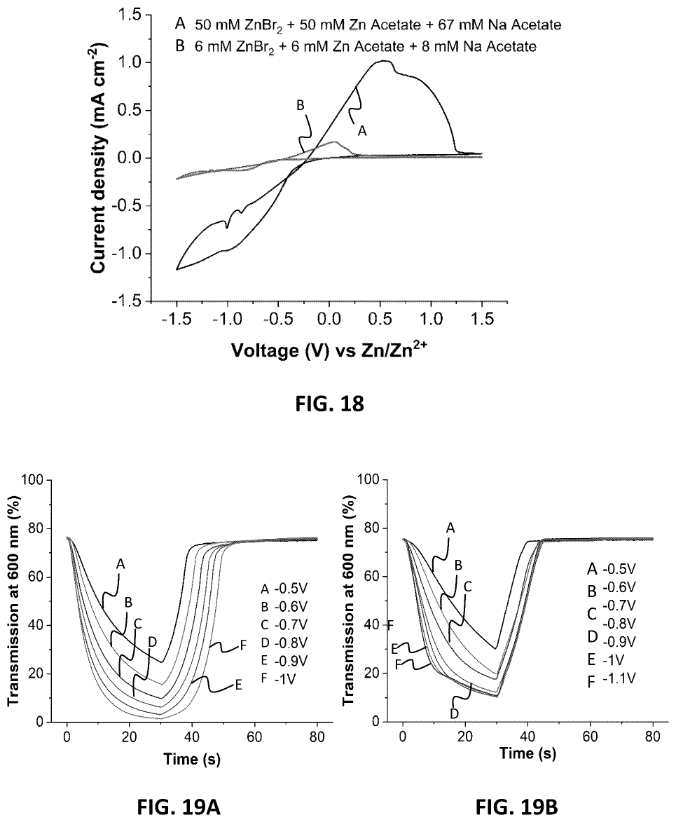

A secondary reductive feature at voltages more negative than −0.9 V in a CV of a diluted Zn DMSO electrolyte (to reduce background Zn electrodeposition) is consistent with H₂ evolution (FIG. 18, line B). The observation that bubble formation is accelerated when water is added to the electrolyte further suggests that water is responsible for the H₂ formation. Taken together, these experiments demonstrate that −0.9 V is the effective deposition voltage limit for long-term cycling of Zn DMSO dynamic windows and that the devices switch 10,000 times before reaching this voltage limit.

### Example 5

The construction of large-area windows with uniform switching is another key issue hindering device commercialization both for electrochromic windows and RME windows. For RME devices, uniform metal electrodeposition can facilitate preparing aesthetically pleasing variable transmission control. To elicit uniform metal electrodeposition across a large-area transparent electrode, the rate of metal electrodeposition must be constant at each point on the electrode despite the presence of a voltage drop that is established when current is drawn from the device edges. When the rate of metal electrodeposition is limited by metal ions diffusion from the bulk electrolyte to the electrode, the rate of metal electrodeposition does not vary with applied voltage. This situation allows the device to switch uniformly in the presence of a voltage drop.

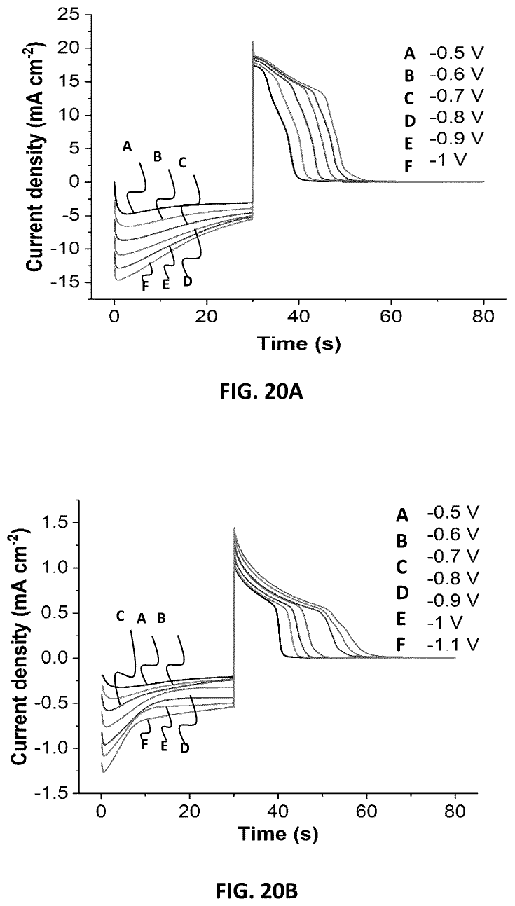

With the highly concentrated Zn DMSO electrolyte, which contains a total Zn²⁺ ion concentration of 600 mM, the tinting speed of a window depends upon the applied voltage. More negative voltages result in faster Zn electrodeposition, which results in faster tinting (FIG. 19A and FIG. 20A). With a dilute electrolyte containing six times fewer Zn²⁺ ions, however, the relationship between applied voltage and tinting speed is much different. In this case, the tinting speed increases when the voltage becomes progressively more negative from −0.5 V to −0.8 V. Strikingly, from −0.8 V to −1.1 V the tinting speed does not significantly change (FIG. 19B and FIG. 20B). These data indicate that from −0.8 V to −1.1 V, Zn electrodeposition is limited by diffusion of Zn²⁺ ions to the electrode and thus is insensitive to the magnitude of electrode polarization. This interpretation is confirmed by a diffusion-limited peak in a CV of the diluted electrolyte around −0.8 V vs. Zn/Zn²⁺ (FIG. 18, line A).

The diffusion-limited nature of the diluted electrolyte facilitates uniform tinting over a large area. By considering the sheet resistance of the transparent electrode (10 Ω/sq) and the average current density needed to switch the device (0.56 mA cm⁻²) at −0.9 V, the voltage drop across a larger electrode can be calculated using a previously established voltage distribution equation. A voltage of −0.9 V is selected for switching the device because at more negative voltages, H₂ evolution commences (vide supra). The voltage distribution calculations indicate that when −0.9 V is applied to the edges of the window, the effective voltage that goes toward Zn electrodeposition at the center of the window is −0.83 V due to Ohmic drop. Because the dilute Zn DMSO electrolyte is diffusion-limited at both −0.8 V and −0.9 V, uniform switching across an electrode should occur.

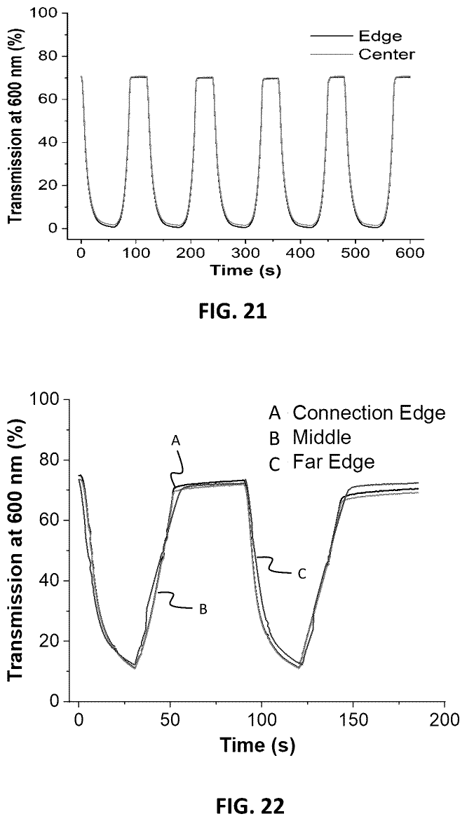

Indeed, optical data at the edge and center of a device (FIG. 21A) demonstrate that Zn DMSO windows exhibit excellent switching uniformity. Furthermore, the switching uniformity of the window did not noticeably change after sitting at rest for two months, which is indicative of the excellent shelf life of the Zn DMSO devices.

Device scale up while maintaining uniform switching is achievable through a variety of approaches. One strategy is to simply increase the voltage applied during metal electrodeposition. For example, an experiment that mimics a 28 cm by 28 cm device switches uniformly at −1.1 V (FIG. 22). However, this voltage may not be suitable for long-term device cycleability in all aspects of the present disclosure due to slow H₂ formation. Another strategy is to further lower the Zn²⁺ concentration in the electrolyte. This approach decreases the current density of the device and hence the voltage drop across the ITO electrode, but this strategy also decreases switching times (c.a. 10-30 minutes for 1 m² devices). In certain aspects, non-aqueous zinc-based electrolytes of the present disclosure can be compatible with patterned electrodes that facilitate device scale up.

In summary, devices based on reversible Zn electrodeposition from DMSO electrolytes are a promising strategy for commercial windows with electronically controlled transmission. The Zn DMSO electrolytes exhibit outstanding electrochemical and optical reversibility. The formation of compact Zn electrodeposits on the transparent working electrode allows for a large range of modulation of visible and infrared light when paired with a transparent Zn grid counter electrode. In contrast to previous Bi—Cu films in RME windows produced from aqueous electrolytes that can suffer from stress corrosion cracking, the Zn DMSO windows possess long-term stability in their opaque state without the application of external power. Furthermore, unlike acidic Bi—Cu aqueous electrolytes that etch ITO, the Zn DMSO electrolytes are noncorrosive, resulting in devices with excellent shelf lives.

Due to the relatively negative standard reduction potential of Zn (−0.76 V vs. SHE), H₂ gas evolution, which must be avoided in practical devices, occurs in wet DMSO electrolytes. For this reason, production lines for the assembly of commercial Zn windows would likely operate under a dry and inert atmosphere in a manner similar to Li-ion batteries. Devices with nominally dry DMSO electrolytes do not evolve H₂ even after 10,000 cycles. This long-term cyclability is impressive for RME windows.

### Example 6

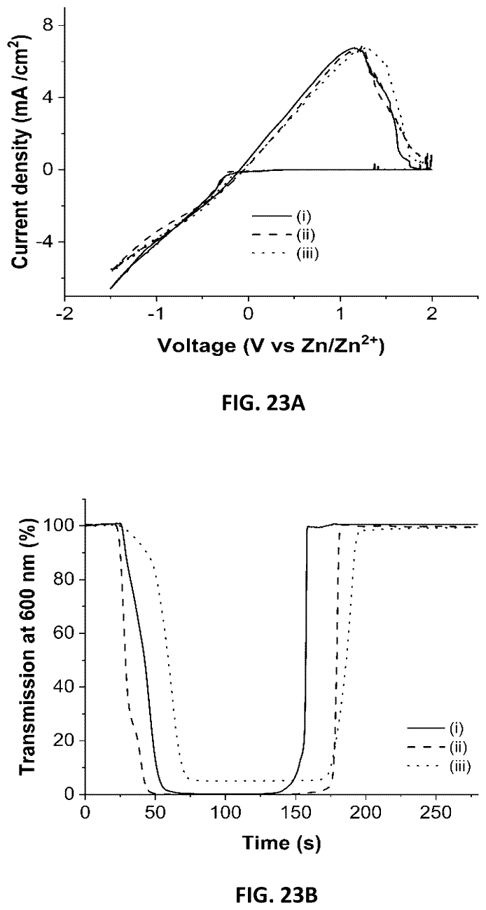

In this example, different non-aqueous zinc-based electrolytes comprising DMF as a polar aprotic solvent were evaluated for use in optoelectronically dynamic elements. The non-aqueous zinc-based electrolytes further included: (i) 100 mM ZnBr₂ and 100 mM Zn(CH₃COO)₂ with 100 mM NACH₃COO; (ii) 300 mM ZnBr₂, 300 mM Zn(CH₃COO)₂, and 400 mM NACH₃COO; and (iii) 100 mM ZnBr₂, 100 mM ZnCl₂, 100 mM Zn(CH₃COO)₂, and 100 mM HCOONa. A Pt-modified ITO electrode was used in combination with the electrolyte and cycled at a scan rate of 25 mVs⁻¹. Cyclic voltammograms and transmission results are shown in FIGS. 23A and 23B, respectively.

### Example 7

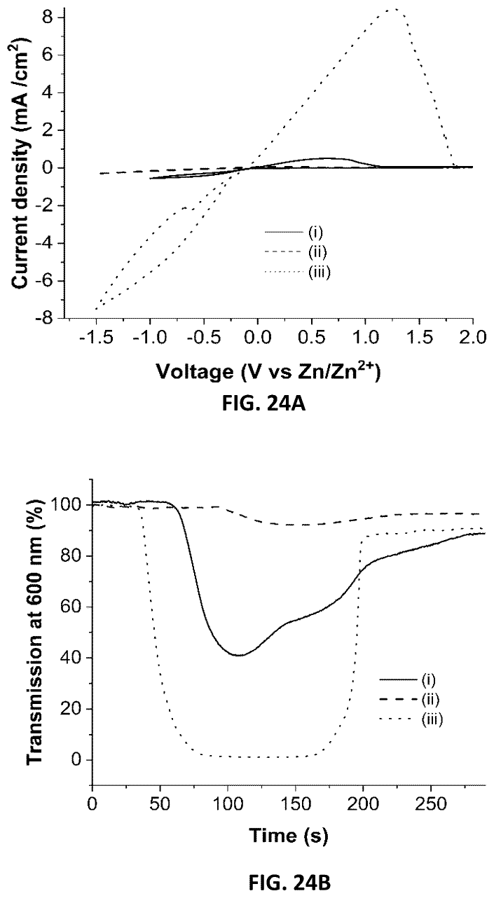

In this example, different non-aqueous zinc-based electrolytes comprising (1) DMF or (2) a mixture of DMSO and DMF (1:1) as polar aprotic solvents were evaluated for use in optoelectronically dynamic elements. Non-aqueous zinc-based electrolyte (1) with DMF further included either (i) 20 mM ZnSO₄; or (ii) 100 mM Zn(CH₃COO)₂. Non-aqueous zinc-based electrolyte (2) included 300 mM ZnBr₂, 300 mM Zn(CH₃COO)₂, and 400 mM NACH₃COO with 1% Hydroxyethylcellulose (HEC). A Pt-modified ITO electrode was used in combination with the electrolyte and cycled at a scan rate of 25 mVs⁻¹. Cyclic voltammograms and transmission results are shown in FIGS. 24A and 24B, respectively.

### Example 8

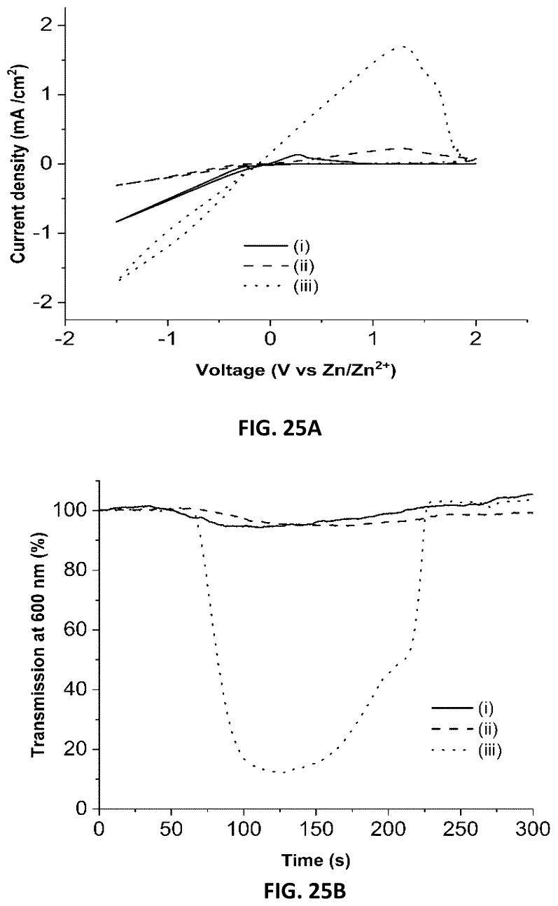

In this example, different non-aqueous zinc-based electrolytes comprising (1)N-methyl-2-pyrrolidone or (2) sulfolane as polar aprotic solvents were evaluated for use in optoelectronically dynamic elements. Non-aqueous zinc-based electrolyte (1) further included 100 mM ZnBr₂, 100 mM Zn (CH₃COO)₂, and 100 mM Zn(HCOO)₂; and non-aqueous zinc-based electrolyte (2) further included either (i) 100 mM ZnBr₂, or (ii) 300 mM ZnBr₂, 300 mM Zn(CH₃COO)₂, and 400 mM NACH₃COO. A Pt-modified ITO electrode was used in combination with the electrolyte and cycled at a scan rate of 25 mVs⁻¹. Cyclic voltammograms and transmission results are shown in FIGS. 25A and 25B, respectively.

### Example 9

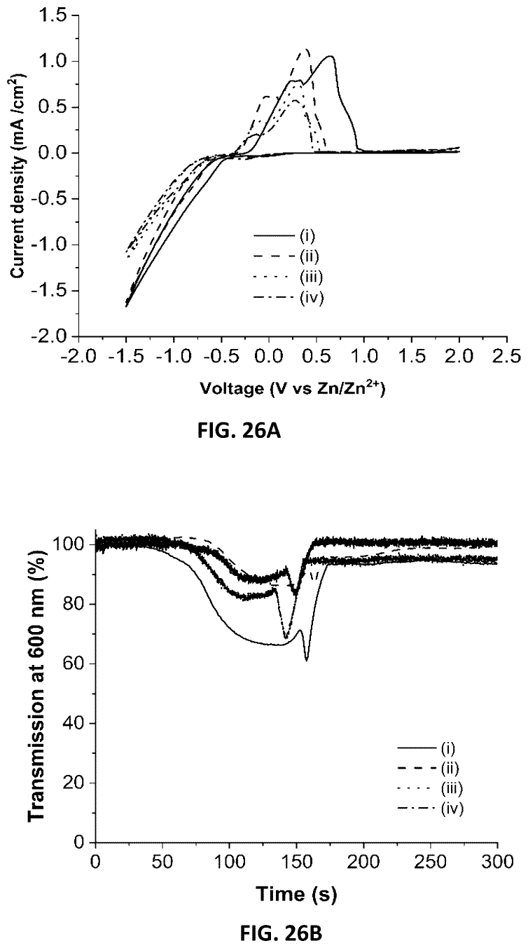

In this example, different non-aqueous zinc-based electrolytes comprising hexamethylphosphoramide (HMPA) as a polar aprotic solvent were evaluated for use in optoelectronically dynamic elements. The non-aqueous zinc-based electrolytes further included: (i) 300 mM ZnBr₂, 100 mM Zn(CH₃COO)₂, and 400 mM Na(HCOO); (ii) 300 mM ZnBr₂, 100 mM Zn(CH₃COO)₂, and 400 mM NACH₃COO; (iii) 300 mM ZnBr₂, 100 mM Zn(CH₃COO)₂, and 400 mM NaCH₃CH₂COO; or (iv) 300 mM ZnBr₂, 100 mM Zn(CH₃COO)₂, and 400 mM NaCH₃CH₂CH₂COO. A Pt-modified ITO electrode was used in combination with the electrolyte and cycled at a scan rate of 25 mVs⁻¹. Cyclic voltammograms and transmission results are shown in FIGS. 26A and 26B, respectively.

### Example 10

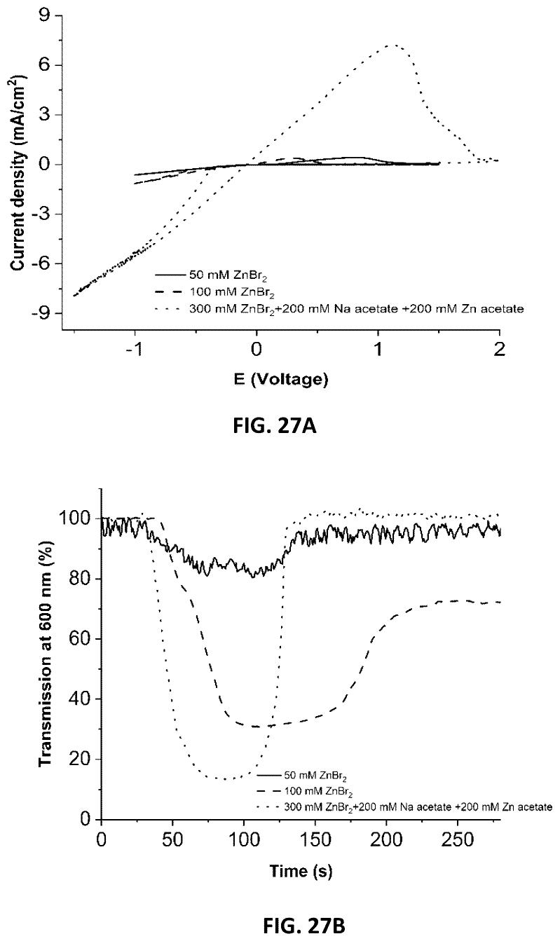

In this example, different non-aqueous zinc-based electrolytes comprising dimethoxyethane (DME) as a polar aprotic solvent were evaluated for use in optoelectronically dynamic elements. The non-aqueous zinc-based electrolytes further included: 50 mM ZnBr₂ (solid line), 100 mM ZnBr₂ (dash line) and 300 mM ZnBr₂, 200 mM Na acetate with 200 mM Zn acetate (dot line). A Pt-modified ITO electrode was used in combination with the electrolyte and cycled at a scan rate of 25 mVs⁻¹. Cyclic voltammograms and transmission results are shown in FIGS. 27A and 27B, respectively. With reference to FIGS. 27A and 27B, electrolyte (i)=solid line; electrolyte (ii)=dash line; and electrolyte (iii)=dot line.

### Example 11

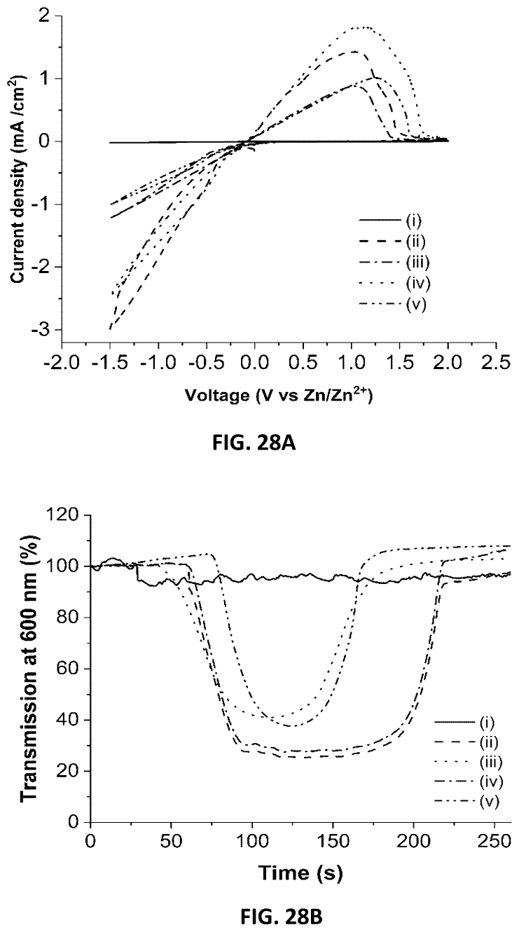

In this example, different non-aqueous zinc-based electrolytes comprising bis(2-methoxyethyl) ether as a polar aprotic solvent were evaluated for use in optoelectronically dynamic elements. The non-aqueous zinc-based electrolytes further included: (i) 300 mM ZnBr₂, (ii) 300 mM ZnBr₂ and 400 mM Na(CH₃COO), (iii) 100 mM ZnBr₂, 100 mM Zn(CH₃COO)₂, and 100 mM Na(HCOO), (iv) 300 mM ZnBr₂, 300 mM Zn(CH₃COO)₂, and 400 mM Na(HCOO), or (v) 100 mM ZnBr₂, 100 mM ZnCl₂, 100 mM Zn(CH₃COO)₂, 50 mM NaCl, and 300 mM Na(HCOO). A Pt-modified ITO electrode was used in combination with the electrolyte and cycled at a scan rate of 25 mVs⁻¹. Cyclic voltammograms and transmission results are shown in FIGS. 28A and 28B, respectively.

### Example 12

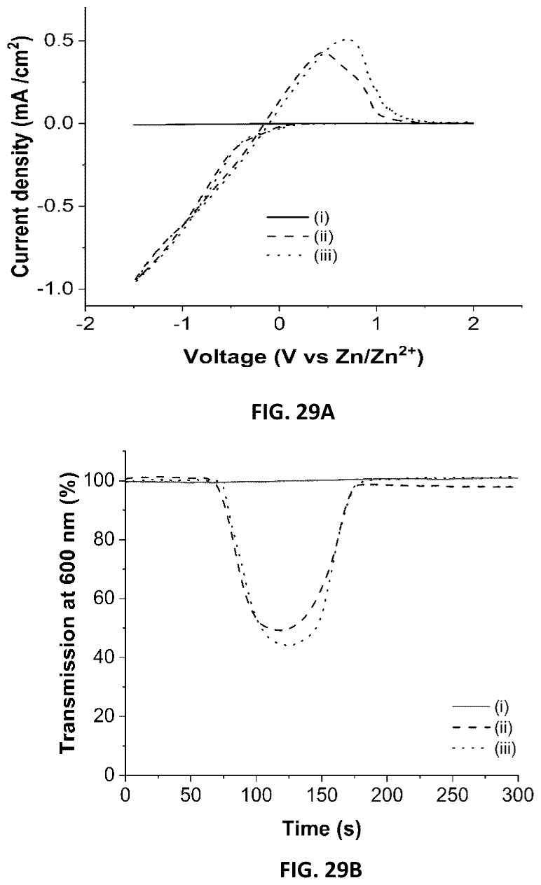

In this example, different non-aqueous zinc-based electrolytes comprising triethylene glycol dimethyl ether as a polar aprotic solvent were evaluated for use in optoelectronically dynamic elements. The non-aqueous zinc-based electrolytes further included: (i) 100 mM ZnBr₂, (ii) 100 mM ZnCl₂, 100 mM Zn(CH₃COO)₂, and 100 mM NACH₃COO, and (iii) 100 mM ZnBr₂, 100 mM Zn(CH₃COO)₂, and 100 mM NACH₃COO. A Pt-modified ITO electrode was used in combination with the electrolyte and cycled at a scan rate of 25 mVs⁻¹. Cyclic voltammograms and transmission results are shown in FIGS. 29A and 29B, respectively.

### Example 13

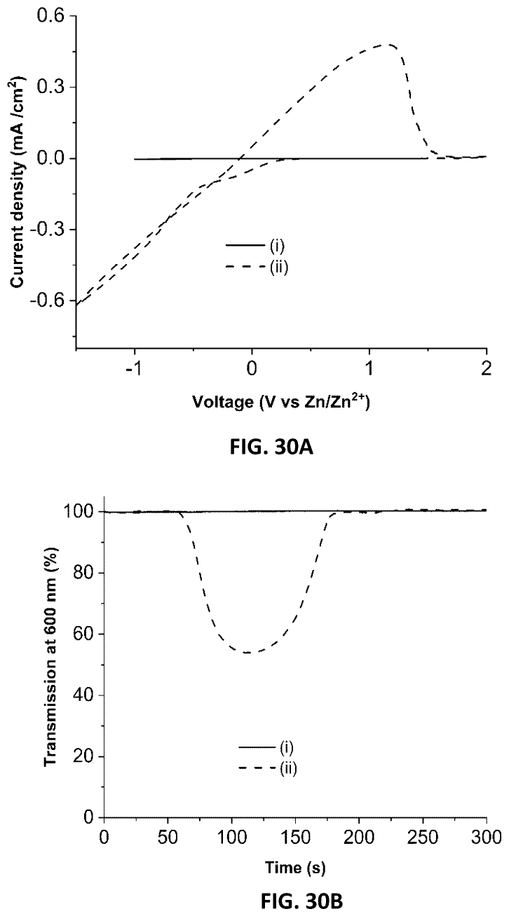

In this example, different non-aqueous zinc-based electrolytes comprising tetraethylene glycol dimethyl ether electrolyte as a polar aprotic solvent were evaluated for use in optoelectronically dynamic elements. The non-aqueous zinc-based electrolytes further included: (i) 100 mM ZnBr₂, and (ii) 100 mM ZnBr₂, 100 mM Zn(CH₃COO)₂, and 100 mM NACH₃COO. A Pt-modified ITO electrode was used in combination with the electrolyte and cycled at a scan rate of 25 mVs⁻¹. Cyclic voltammograms and transmission results are shown in FIGS. 30A and 30B, respectively.

### Example 14

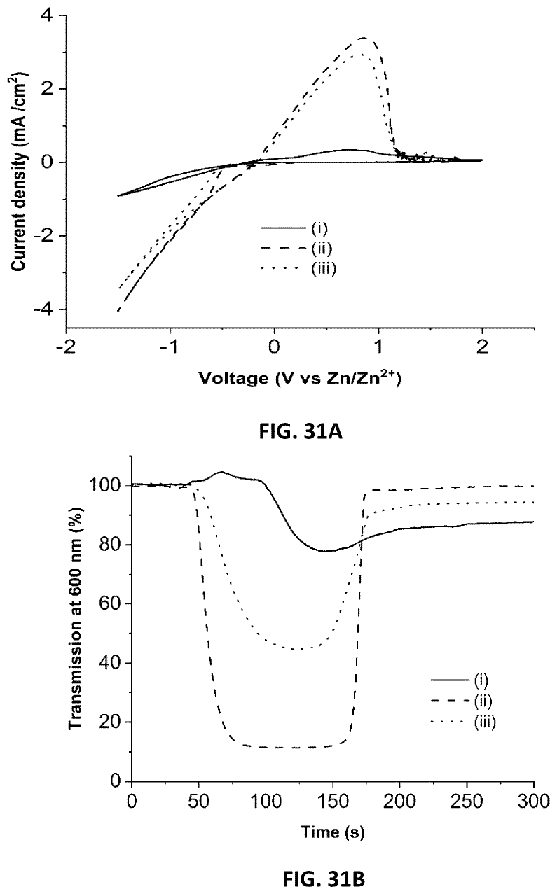

In this example, different non-aqueous zinc-based electrolytes comprising tetramethylurea as a polar aprotic solvent were evaluated for use in optoelectronically dynamic elements. The non-aqueous zinc-based electrolytes further included: (i) 300 mM ZnBr₂ and 100 mM Zn(CH₃COO)₂, (ii) 300 mM ZnBr₂, 300 mM Zn(CH₃COO)₂, and 400 mM NaCH₃COO, or (iii) 300 mM ZnBr₂, 300 mM Zn(CH₃COO)₂, and 400 mM NACH₃COO. A Pt-modified ITO electrode was used in combination with electrolyte (i) and (ii) and cycled at a scan rate of 25 mVs⁻¹. A Pt-modified FTO electrode was used in combination with electrolyte (iii) and cycled at a scan rate of 25 mVs⁻¹. Cyclic voltammograms and transmission results are shown in FIGS. 31A and 31B, respectively.

### Example 15

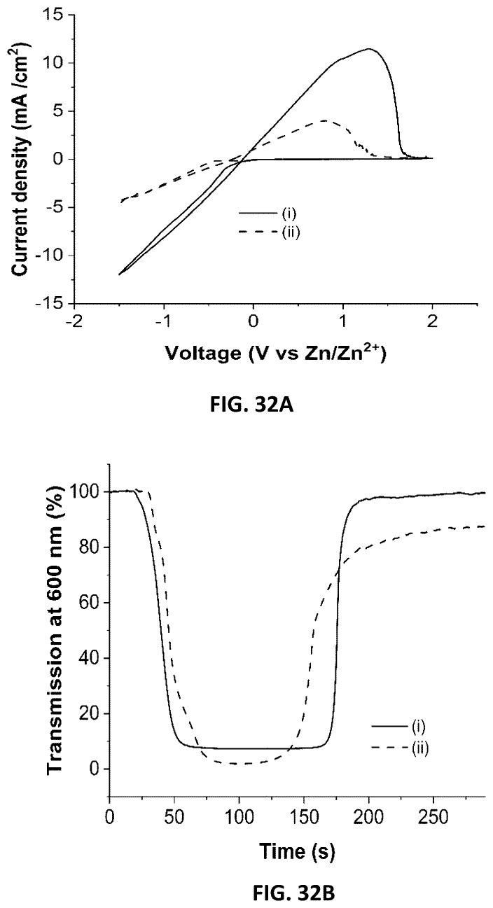

In this example, different non-aqueous zinc-based electrolytes comprising (1) acetonitrile or (2) a mixture of DMSO and acetonitrile (1:1) as polar aprotic solvents were evaluated for use in optoelectronically dynamic elements. Non-aqueous zinc-based electrolyte (1) with acetonitrile further included 100 mM ZnBr₂, 100 mM Zn(CH₃COO)₂, and 100 mM NACH₃COO. Non-aqueous zinc-based electrolyte (2) included 50 mM ZnBr₂, 50 mM Zn(CH₃COO)₂, and 100 mM NACH₃COO. A Pt-modified ITO electrode was used in combination with the electrolyte and cycled at a scan rate of 25 mVs⁻¹. Cyclic voltammograms and transmission results are shown in FIGS. 32A and 32B, respectively.

### Example 16

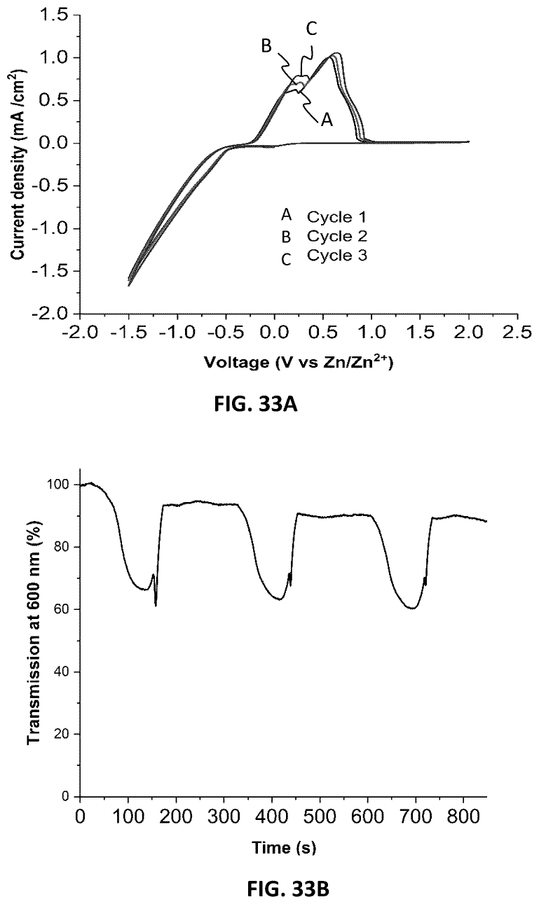

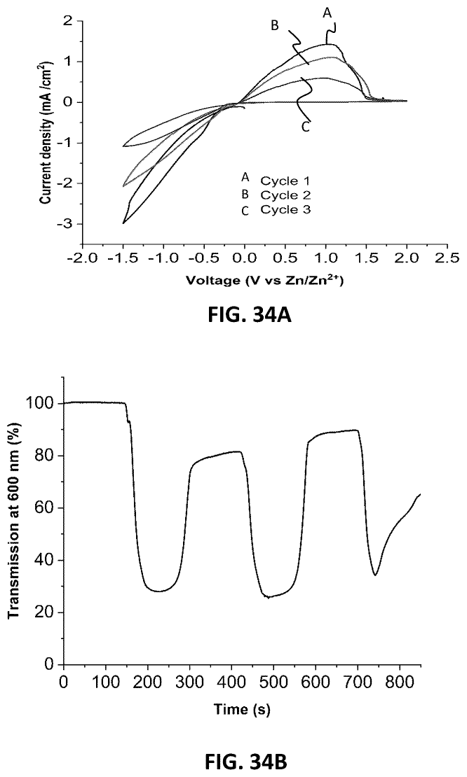

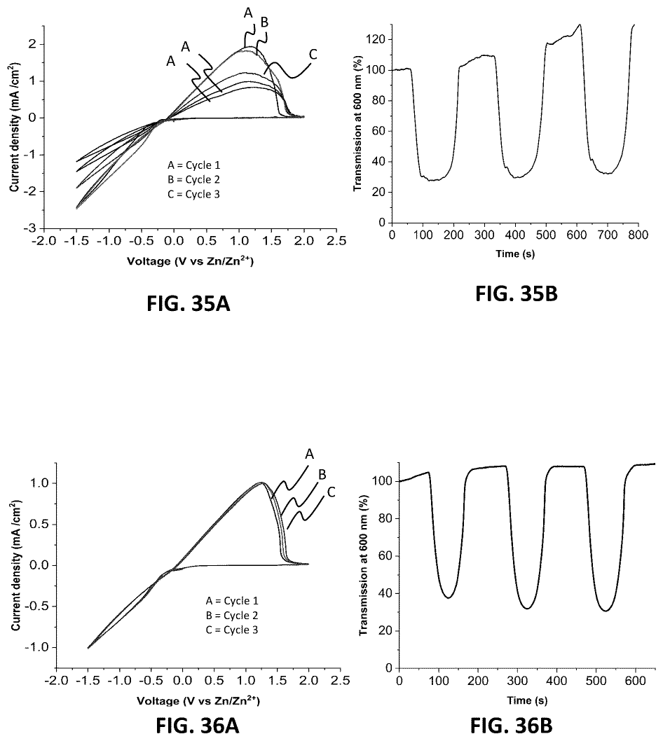

In this example, different non-aqueous zinc-based electrolytes comprising bis(2-ethoxyethyl) ether as a polar aprotic solvent were evaluated for use in optoelectronically dynamic elements. The non-aqueous zinc-based electrolytes further included different zinc salts in combination with other salt additives (e.g., metal carboxylates and/or metal halides). A Pt-modified ITO electrode was used in combination with the electrolyte and cycled at a scan rate of 25 mVs⁻¹. FIGS. 33A and 33B show cyclic voltammograms and transmission results, respectively, for an electrolyte comprising bis(2-ethoxyethyl) ether electrolyte containing 300 mM ZnBr₂, 100 mM Zn(CH₃COO)₂, and 400 mM Na(HCOO). FIGS. 34A and 34B show cyclic voltammograms and transmission results, respectively, for an electrolyte comprising bis(2-ethoxyethyl) ether electrolyte containing 300 mM ZnBr₂ and 400 mM Na(CH₃COO). FIGS. 35A and 35B show cyclic voltammograms and transmission results, respectively, for an electrolyte comprising bis(2-ethoxyethyl) ether electrolyte containing 300 mM ZnBr₂, 300 mM Zn(CH₃COO)₂, and 400 mM Na(CH₃COO). FIGS. 36A and 36B show cyclic voltammograms and transmission results, respectively, for an electrolyte comprising bis(2-ethoxyethyl) ether electrolyte containing 100 mM ZnBr₂, 100 mM ZnCl₂, 100 mM Zn(CH₃COO)₂, 50 mM NaCl, and 300 mM Na(HCOO).

### Example 17

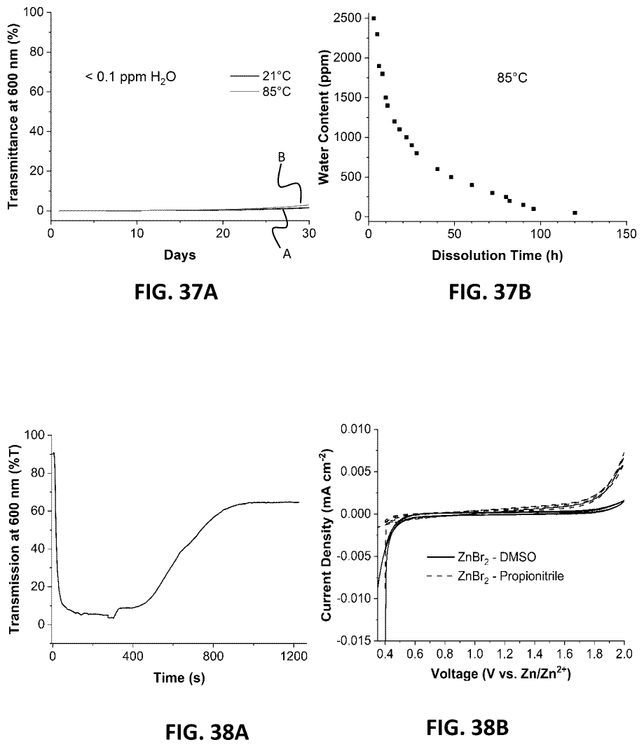

In this example, a PrCN electrolyte containing 300 mM ZnCl₂, 200 mM LiCl, 25 mM NaCH₃CH₂COO, and 0.5 wt. % PEG was evaluated. The electrolyte was dried to below the limit of detection of Karl-Fischer titration (<0.1 ppm H₂O) using molecular sieves. With this Zn PrCN electrolyte, devices exhibit remarkable 1-month dark-state bistability at both 21° C. and 85° C. (FIG. 37A). This 1-month dark-state bistability at 85° C. is more than a seventyfold improvement over the 10 hour device bistability of certain Zn DMSO electrolytes at 85° C. Furthermore, systematic studies with this Zn PrCN electrolyte with varying concentrations of added water reveal that the film dissolution rate at 85° C. occurs exponentially faster with higher water concentrations (FIG. 37B).

The Zn PrCN electrolyte in this example utilized zinc chloride salts. It was determined that in some aspects, Br⁻ electrolytes can impact bistability if the correct conditions are met. Without being limited to a single theory, it currently is believed that Br⁻ may oxidize to Br₃⁻ with a standard reduction potential of 1.54 V vs. Zn/Zn²⁺. Br₃⁻ can go on to oxidize the electrodeposited Zn film to Zn²⁺, resulting in film dissolution and compromised dark-state bistability under specific conditions using PrCN as a polar aprotic solvent. When the chronoamperometry is halted with the electrodeposited Zn film on the working electrode, the film may spontaneously and rapidly dissolve at room temperature, likely due to reaction with the generated Br₃⁻ (FIG. 38A). This dissolution phenomenon is not observed in electrolytes comprising ZnBr₂ in DMSO. In one example, cyclic voltammetry (CV) experiments for DMSO/ZnBr₂-containing and PrCN/ZnBr₂-electrolytes were conducted, with results shown in FIG. 38B. In these CVs, the voltages were kept positive of the Zn/Zn²⁺ redox couple to avoid convolution with Zn electrodeposition and stripping processes. Although both CVs exhibit oxidative current associated with Br₃⁻ production, the onset potential for Br₃⁻ formation in PrCN is near the 1.54 V standard reduction potential, while Br₃⁻ generation does not commence until about 1.8 V in the DMSO electrolyte. These results indicate that it is more difficult to oxidize Br⁻ to Br₃⁻ in DMSO compared to PrCN and explains why the presence of Br⁻ in the DMSO electrolyte does not adversely affect the dark-state bistability of devices, while Br⁻ in PrCN electrolytes can result in poor bistability in certain situations.

### Example 18

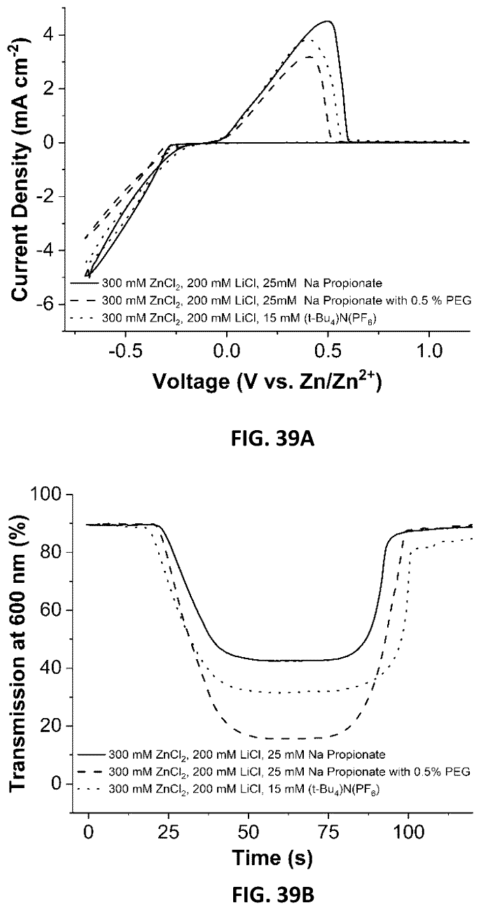

In this example, three different electrolytes were evaluated for electrochemical and optical reversibility for Zn metal electrodeposition using CVs combined with in situ transmission measurements (results shown in FIGS. 39A and 39B). For all three electrolytes, cathodic current initiates Zn metal electrodeposition at an onset potential of −0.26 V vs. Zn/Zn²⁺, and the electrodeposited Zn is anodically stripped to Zn²⁺ during the reverse positive going sweep. The first electrolyte comprised 300 mM ZnCl₂, 200 mM LiCl, and 25 mM NaCH₃CH₂COO. The second electrolyte is the same as the first, but contained 0.5 wt. % polyethylene glycol (PEG) as an additional component. The second electrolyte, with the addition of PEG, achieved less than 20% transmission during the CV (FIG. 39B, dashed line) as compared to only ˜45% transmission obtained without PEG (FIG. 39B, solid line). The third electrolyte comprised 300 mM ZnCl₂, 200 mM LiCl, and 15 mM (t-Bu₄)N(PF₆) (TBAPFs) and possessed intermediate optical contrast during the CV compared to the other two electrolytes (FIG. 39B, dotted line).

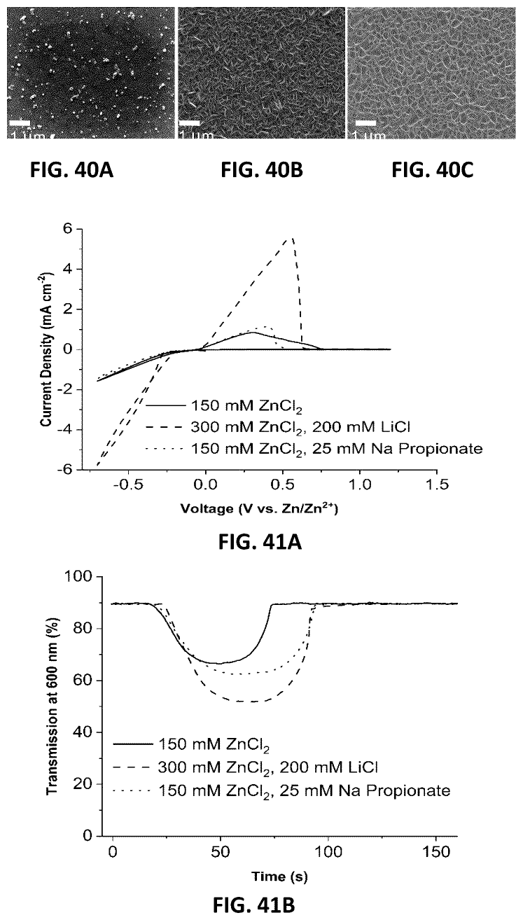

FIGS. 40A-40C presents scanning electron microscopy (SEM) of Zn electrodeposits from the three electrolytes described above. The electrodeposits produced from a 300 mM ZnCl₂, 200 mM LiCl, and 25 mM NaCH₃CH₂COO electrolyte without PEG consist of nonuniform particles (FIG. 40A). The irregularity of these electrodeposits explains the relatively poor optical contrast measured during the CV using this electrolyte (FIG. 39B, solid). With PEG, however, the electrodeposits are comprised of a layer of relatively monodispersed nanowires (FIG. 40B), which form a more compact layer that blocks light more effectively, resulting in increased optical contrast (FIG. 39B, dashed line). Lastly, the electrodeposits produced from the TBAPF₆ electrolyte consist of a network of nanofilaments with void spaces (FIG. 40C). The lateral surface coverage of this electrodeposit structure is in between that of the other two electrodeposits, explaining why a CV in this electrolyte produces intermediate optical contrast (FIG. 39B, dotted line). Together, these results demonstrate that there is a correlation between the uniformity of the Zn electrodeposits and the minimum transmission attained by the electrode during RME.

### Example 19

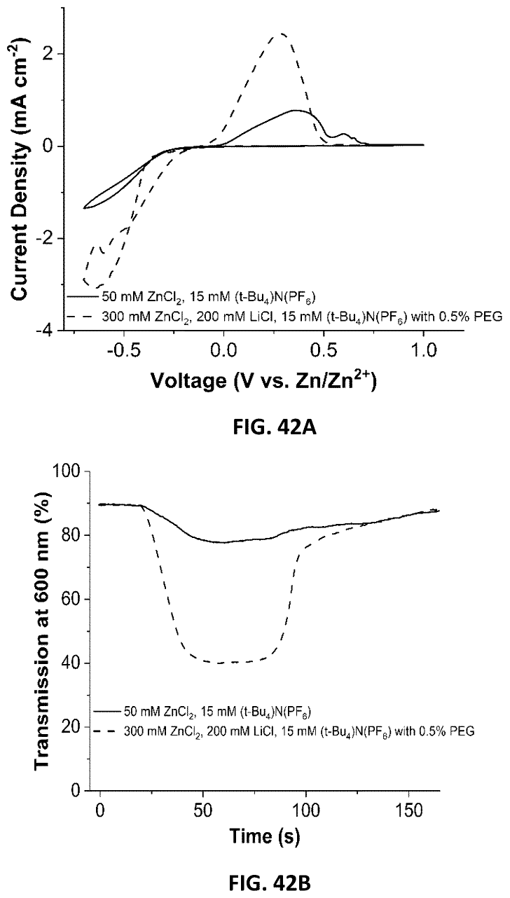

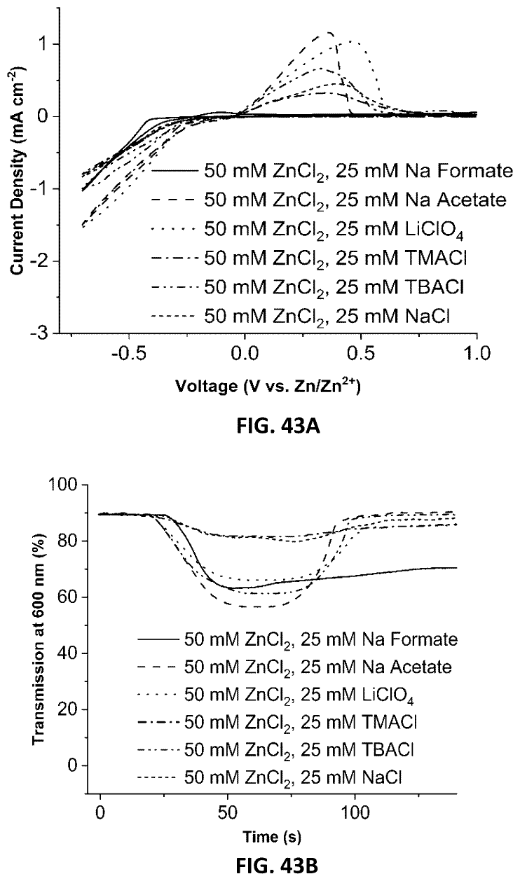

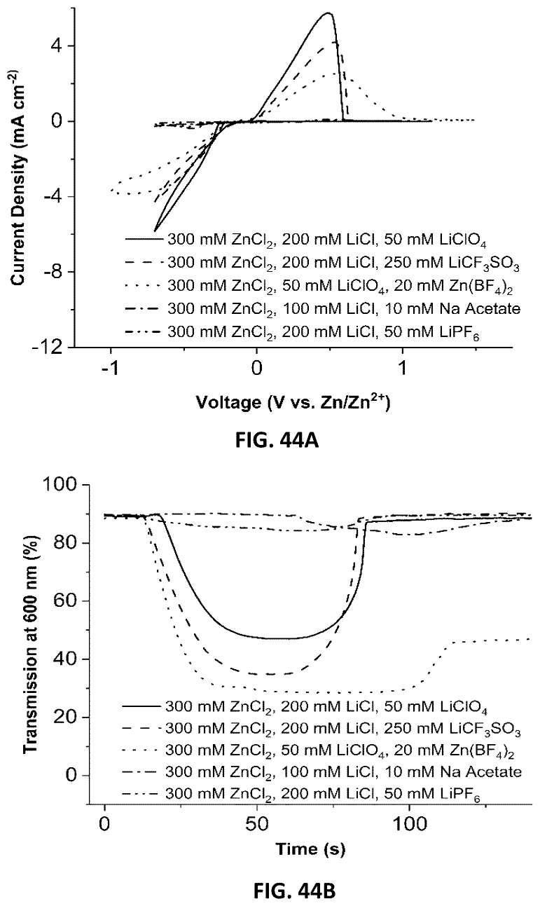

In this example, comparative non-aqueous zinc-based electrolytes containing only ZnCl₂, ZnCl₂ and LiCl, and ZnCl₂ and NaCH₃CH₂COO, were evaluated. Results are shown in FIGS. 41A and 41B. TBAPF₆-containing electrolytes without LiCl or with PEG also were evaluated. Results are shown in FIGS. 42A and 42B. Further examples comprising ZnCl₂ in combination with different supporting salts were evaluated, with results shown in FIGS. 43A, 43B, 44A, and 44B.

### Example 20

In this example, two-electrode dynamic windows were constructed using the 300 mM ZnCl₂, 200 mM LiCl, 25 mM NaCH₃CH₂COO, and 0.5 wt. % PEG PrCN electrolyte discussed in Example 18 above. To construct two-electrode dynamic windows, a working electrode comprising Pt-modified ITO on glass paired with a Zn grid counter electrode on a glass backing was used. A commercially available Zn grid (Kwikmesh) with approximately 1 cm interwire spacing and a 3 mm wire diameter was used. In all windows, butyl rubber (Solargain, Quanex, Inc.) was used to seal the perimeter of the electrodes effectively. The final step involved injecting the electrolyte into the devices through the butyl rubber sealant using a syringe and a 22-gauge needle. The thickness of the electrolyte in the sealed devices was approximately 1.5 mm.

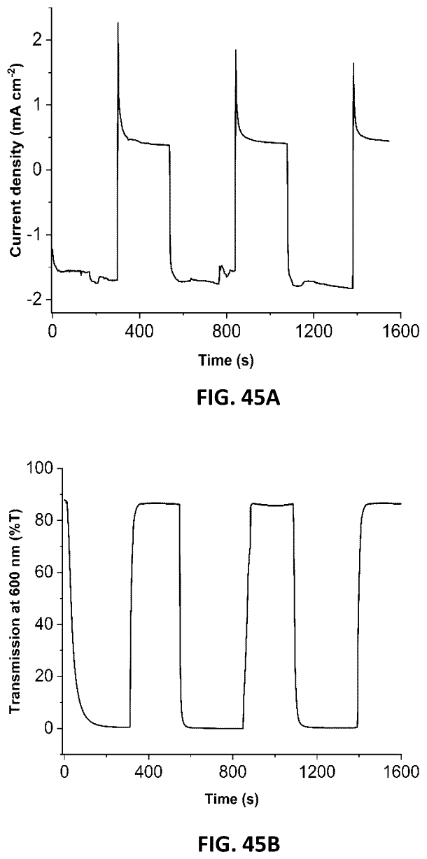

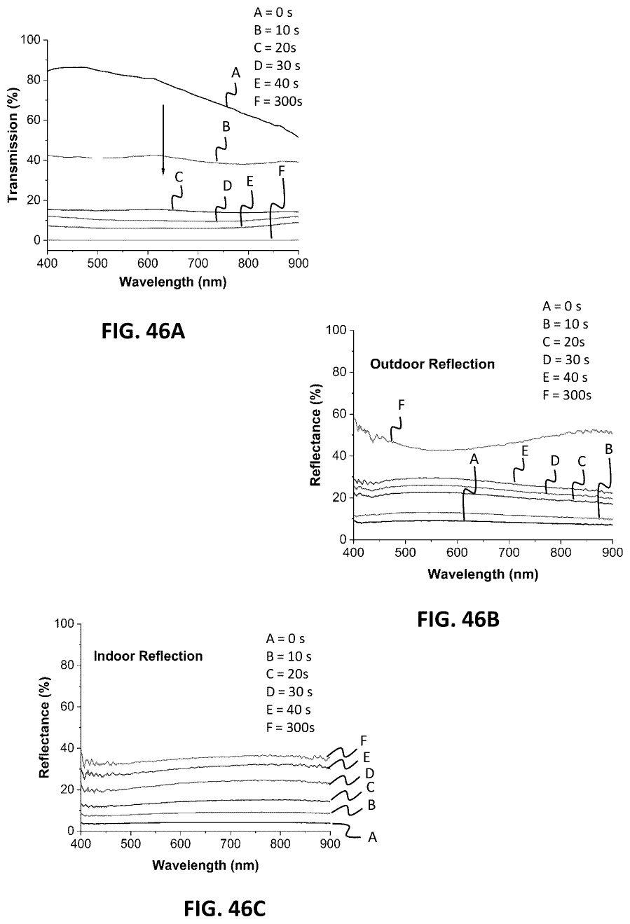

These windows exhibited excellent optical performance, transitioning from a clear state with 70-85% transmission in the visible spectrum (400 nm to 700 nm) to a dark state with around 7% transmission within 40 seconds and less than 0.1% transmission after 300 s. The original clear state of the window could be restored within 100 seconds by applying a voltage of +1.8 V (FIGS. 45A and 45B). Transmission, outdoor reflectance, and indoor reflectance results are shown in FIGS. 46A-46C.

During the growth of the metal film, the dynamic windows exhibited increased reflection, resulting in a dark mirror appearance. The magnitude of reflection varied depending on the orientation of the device stack relative to the incident light. Specifically, the reflection was greater when light first passed through the ITO working electrode side of the device (outdoor reflection, FIG. 46B) compared to the metal mesh side (indoor reflection, FIG. 46C). This orientation-dependent reflection, observed in other RME windows, occurs because of the rougher top surface of the metal electrodeposits encountered first during indoor reflection, which increases scattering and absorption, in contrast to the smoother base of the electrodeposits where the metal nucleates. In buildings, the energy savings properties of the windows would be maximized by orienting the working electrode towards the outside to maximize reflection and reject heat, while the less reflective indoor face is likely more desirable aesthetically.

An additional aesthetic consideration for dynamic windows is color neutrality. The L*a*b* color space was used to quantify color, which accounts for the sensitivity of the human eye and uses standardized lighting conditions. The Zn—PrCN windows exhibit high color neutrality, as indicated by chroma (C*) values consistently near or below 5 during tinting for both the transmitted and reflected light (Table 3). C* values less than 10 are generally considered grey and color neutral to the human eye. The clear to grey to black switching colors of these windows therefore meet what is needed for typical commercial applications.

TABLE 3

| | | | | | |
|---|---|---|---|---|---|
| | | Green-red | Blue-yellow | Color | Best |
| Deposition | Lightness | coordinate | coordinate | neutrality | RGB |
| Time (s) | (L*) | (a*) | (b*) | (C*) | representation |

Transmission Color

| | | | | | |
|---|---|---|---|---|---|
| 0 | 82.0 | −1.01 | −2.01 | 2.25 | [symbol] |
| 10 | 41.7 | 0.82 | 0.04 | 0.82 | [symbol] |
| 20 | 15.2 | 0.80 | 0.03 | 0.80 | [symbol] |
| 30 | 10.0 | 0.99 | −4.72 | 4.82 | [symbol] |
| 40 | 6.1 | 1.71 | −4.06 | 4.41 | [symbol] |
| 300 | 0.04 | 17.37 | −27.47 | 32.50 | [symbol] |
| | (The | | | | |
| | transmission is | | | | |
| | so low that it | | | | |
| | does not | | | | |
| | meaningfully | | | | |
| | contribute to | | | | |
| | overall window | | | | |
| | color.) | | | | |

Indoor Reflection Color

| | | | | | |
|---|---|---|---|---|---|
| 0 | 4.1 | 0.28 | 3.86 | 3.87 | [symbol] |
| 10 | 8.5 | 1.15 | 4.90 | 5.03 | [symbol] |
| 20 | 13.7 | 1.64 | 4.95 | 5.21 | [symbol] |
| 30 | 22.2 | 1.62 | 4.73 | 5.00 | [symbol] |
| 40 | 29.3 | 1.46 | 2.80 | 3.16 | [symbol] |
| 300 | 34.2 | 1.07 | 1.77 | 2.07 | [symbol] |
| 0 | 9.0 | −1.38 | 2.13 | 2.54 | [symbol] |
| 10 | 12.9 | −1.91 | 2.55 | 3.19 | [symbol] |
| 20 | 22.4 | −1.70 | 2.10 | 2.70 | [symbol] |
| 30 | 25.7 | −1.66 | 2.12 | 2.69 | [symbol] |
| 40 | 29.2 | −1.56 | 2.10 | 2.62 | [symbol] |
| 300 | 43.3 | 1.67 | −4.90 | 5.18 | [symbol] |

### Example 21

Scalability is another consideration when considering the practical utility of both electrochromic and RME windows. For RME devices, uniform deposition of metal across the transparent electrode should occur over a large area to facilitate uniform switching. Uniform metal electrodeposition is most readily achieved by ensuring diffusion-limited current density across the device area. Diffusion-limited current occurs when two conditions are met. First, the local supply of metal ions should be equal across the electrode area. Second, the magnitude of the voltage used to elicit metal electrodeposition should be high enough to induce diffusion-limited current in spite of the voltage drop that occurs between the edge and center of the ITO working electrode.

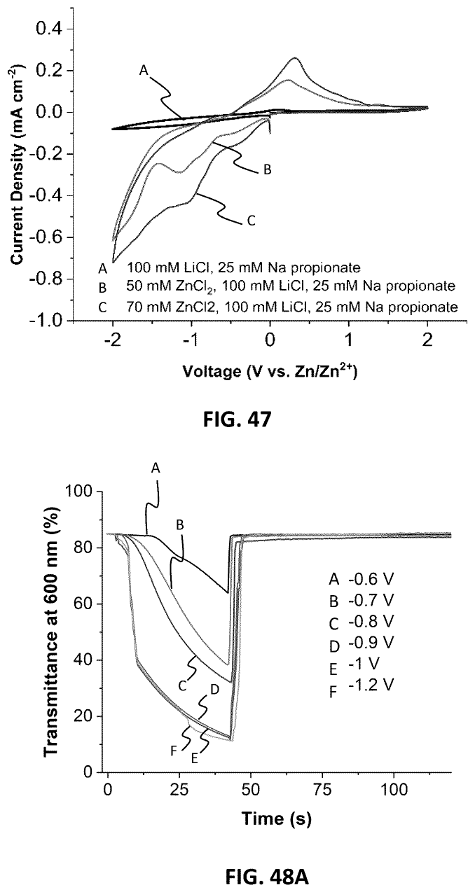

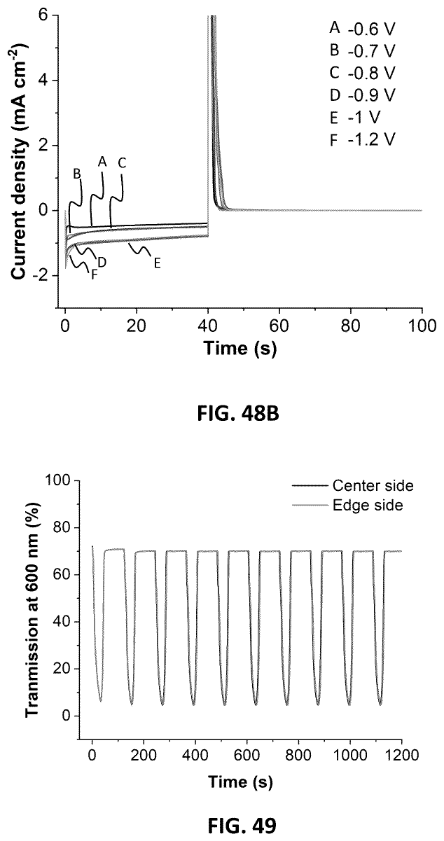

Taking into account the transparent electrode's sheet resistance (10 Ω/sq) and the requisite average current density for device switching (−1.2 mA cm⁻²) at −1.2 V, the voltage drop across an electrode can be computed using a voltage distribution formula. The voltage distribution computations reveal that when −1.2 V is administered at the edge of the window, the effective voltage directed towards Zn electrodeposition on the window center is −1.05 V due to Ohmic losses. A CV of a diluted Zn PrCN electrolyte exhibits a diffusion-limited peak at −0.9 V (FIG. 47, line C). Given the diffusion-limited nature of the diluted Zn—PrCN electrolyte at voltages more negative than −0.9 V, uniform switching across an electrode should be achievable if −1.2 V is applied to the device as the effective voltage across the electrode would range from −1.2 V to −1.05 V, voltages that would elicit diffusion-limited electrodeposition. Further confirmation of this analysis comes from spectroelectrochemical data of the dynamic windows obtained at different switching voltages (FIGS. 48A and 48B). At switching voltages more positive than −0.9 V, the position of the diffusion-limited peak in the CV (FIG. 47, line C), the transmission of the electrode after 40 seconds of Zn electrodeposition (FIG. 48A) becomes progressively lower with increasingly negative voltages as the magnitude of the current increases (FIG. 48B). In contrast, at switching voltages more negative than −0.9 V, the transmission of the electrode after 40 seconds of Zn electrodeposition and the magnitude of the current remain do not significantly change. At voltage voltages more negative than −0.9 V, the current and switching speed of the device are controlled by diffusion of Zn²⁺ ions to the working electrode and thus do not depend upon the electrodeposition overpotential.

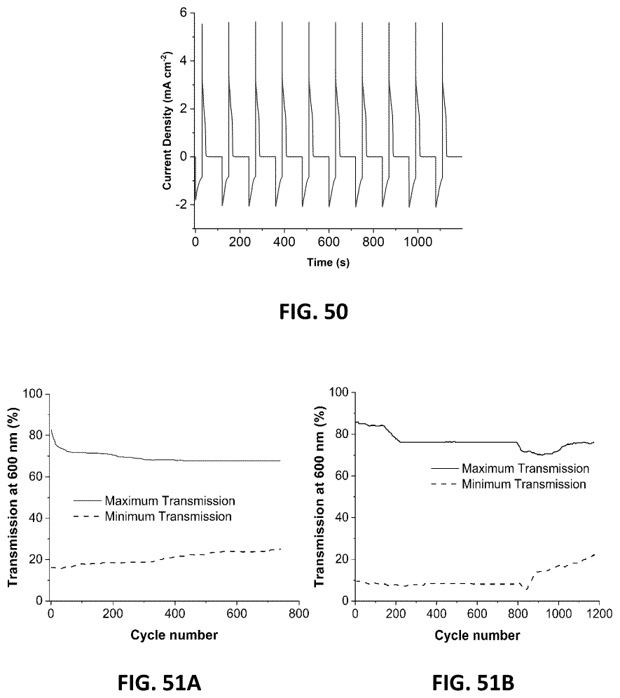

This situation, in which the Zn electrodeposition rate is independent of device switching voltage, allows for the construction of a large-area device that switches uniformly in spite of a voltage drop across the working electrode. Indeed, a device switches uniformly as evidenced by photographs and transmission profiles at the center and the edge of the device during switching (FIG. 49). The device achieves less than 10% transmission after 30 seconds of electrodeposition at −1.2 V (FIG. 50).

### Example 22

Cycleability is a grand challenge that hinders the commericilization of dynamic windows. ASTM E2141 standards for dynamic windows require 50,000 switching cycles at 85° C. There are currently no RME windows that pass these rigorous ASTM standards, and to the best of the inventors' current knowledge, there are no published reports of RME windows switching at 85° C. Transmission data for the Zn PrCN window during ˜1,200 cycles at 21° C. (FIG. 51A) and ˜800 cycles at 85° C. (FIG. 51B) also is disclosed. At 21° C., the minimum transmission attained after 20 seconds of switching at −1.0 V remains relatively constant, but then degrades with further cycling. At 85° C., the contrast ratio of the device steadily declines during cycling.

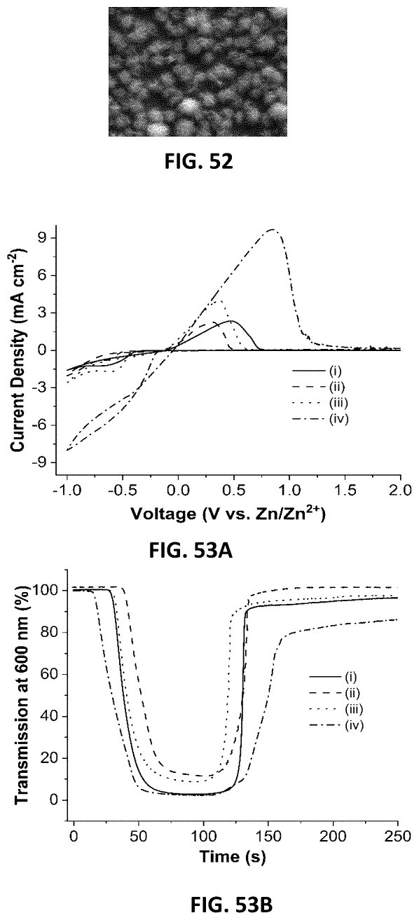

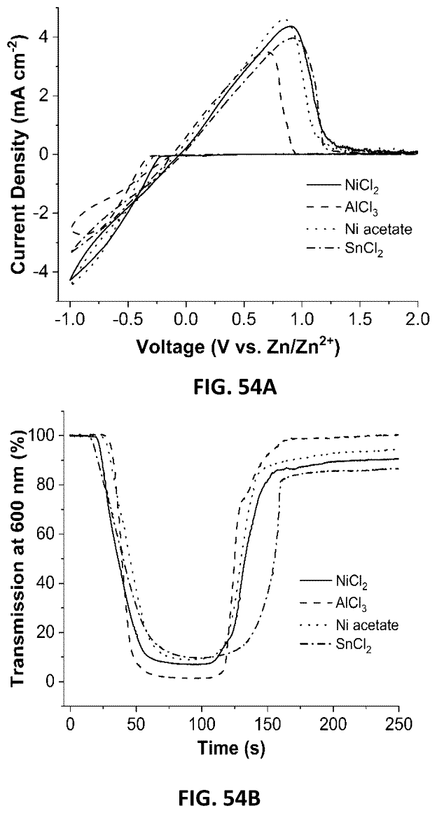

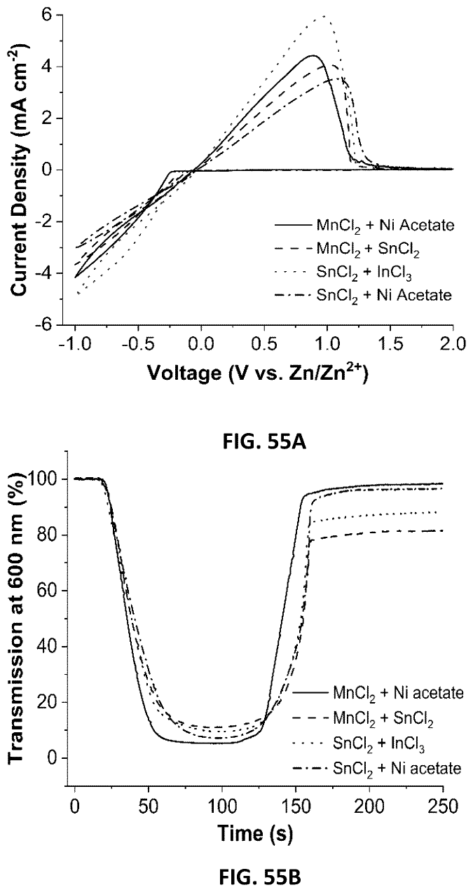

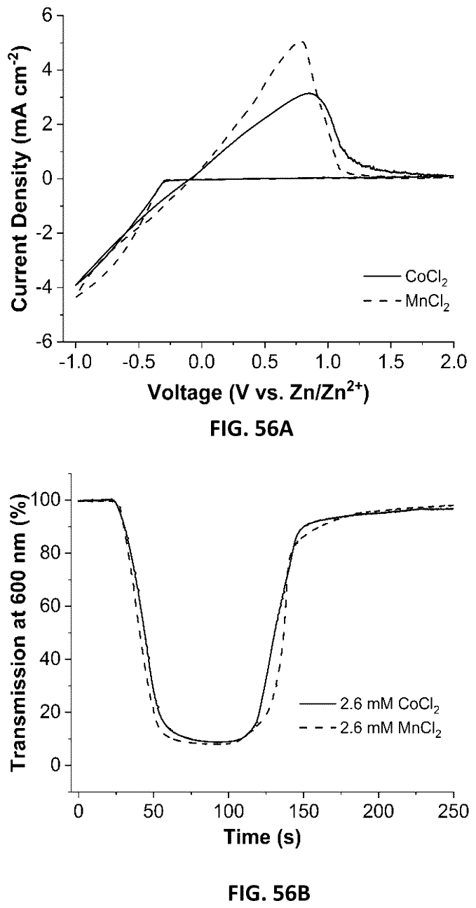

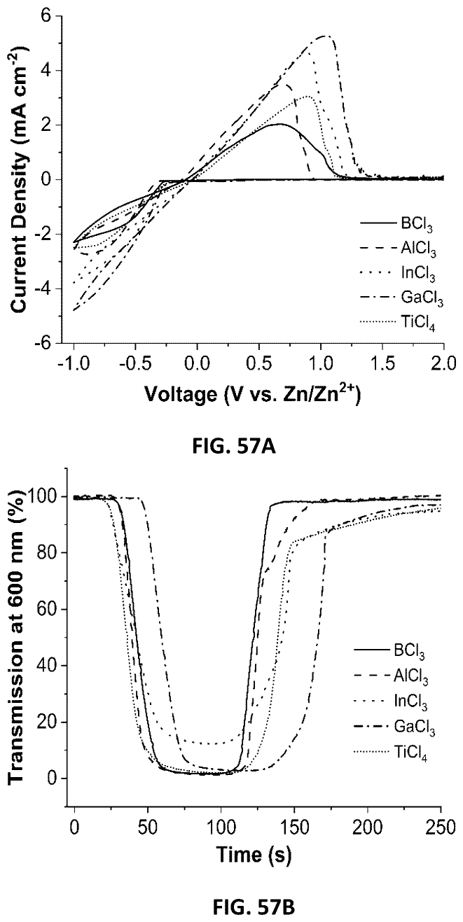

The morphological changes of the working electrode after prolonged cycling also were evaluated. SEM imaging of the working electrode after cycling revealed the presence of surface irregularities, including holes and isolated dendrites (FIG. 52). This morphology is dramatically different from and less compact than the original Zn electrodeposits deposited from this electrolyte (FIG. 40C). The evolution of this less compact morphology explains why the minimum transmission obtained after 20 seconds of darkening increases with cycling. Furthermore, the dendritic nature of the electrodeposits hinders metal stripping speed, which explains why the maximum transmission obtained during the stripping portion of the cycle also degrades. Future work will focus on improving the cycleability of Zn RME windows using PrCN electrolytes. A variety of approaches will be pursued including the use of different voltage profiles for switching and further electrolyte design.

### Example 23

In this example, different non-aqueous zinc-based electrolyte alloy-based compositions were evaluated. The electrolytes comprised DMSO as the polar aprotic solvent and further comprised a zinc salt (e.g., ZnBr₂, zinc formate, or zinc acetate, or a combination thereof) in combination with one or more additional metal salts, including sodium acetate (CH₃COONa), nickel acetate (Ni(CH₃COO)₂), lithium trifluoroacetate (CF₃COOLi), lithium triflate (CF₃S(O)₂OLi), lithium difluoroacetate (CHF₂COOLi), lithium acetate (CH₃COOLi), lithium bromide (LiBr), lithium chloride (LiCl), potassium acetate (CH₃COOK), sodium trifluoroacetate (CF₃COONa), lithium formate (HCOOLi), nickel chloride (NiCl₂), aluminum chloride (AlCl₃), tin chloride (SnCl₂), manganese chloride (MnCl₂), indium chloride (InCl₃), indium acetate (In(CH₃COO)₃), cobalt chloride (CoCl₂), boron trichloride (BCl₃), gallium trichloride (GaCl₃), titanium tetrachloride (TiCl₄), and/or any combinations thereof. Various concentrations of the zinc salt and the additional metal salt were evaluated. Evaluated compositions are outlined in Tables 4 and 5 and cyclic voltammogram and transmission results for certain formulations are shown in FIGS. 53A/B-57A/B, 60A/B, and 61A/B.

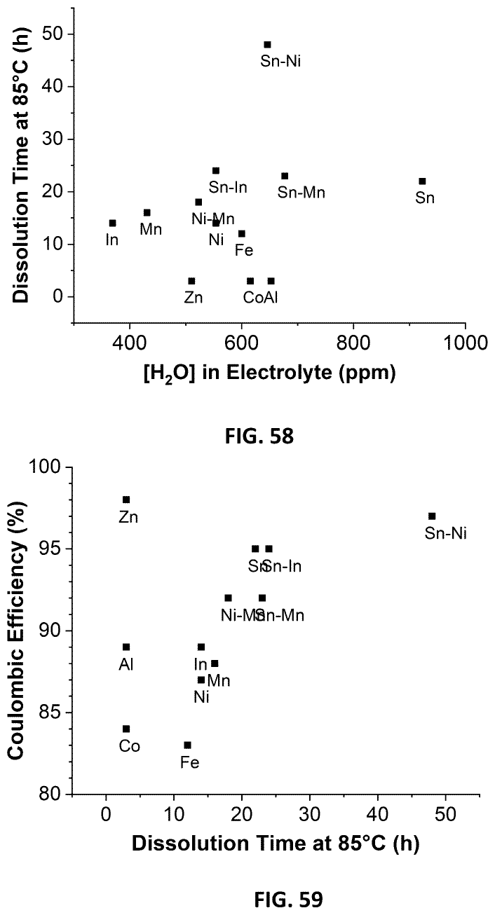

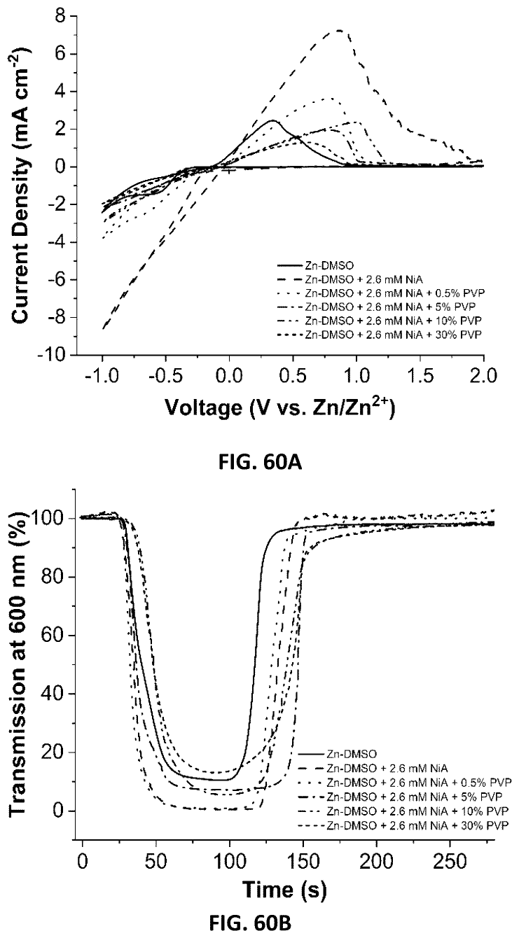

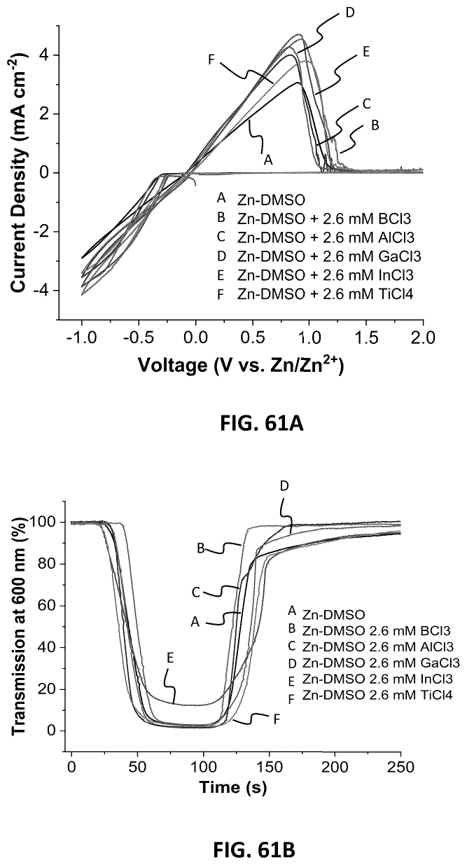

FIG. 58 shows a plot of dissolution time of electrodeposited Zn films at 85° C. at open circuit potential versus the water content in certain electrolytes according to this example. The Zn electrolyte included 300 mM ZnBr₂, 300 mM Zn(CH₃COO)₂, and 400 mM NACH₃COO in DMSO and the other electrolytes contained the same composition with an additional one or two acetate salts of the element(s) listed in the plot. Dissolution time is defined as time it takes films with 0.1% transmission to reach ˜30% transmission. The data show that there is no clear relationship between dissolution time and water in the electrolyte, indicating that the enhanced bistability of the films at 85° C. shown is due to the enhanced corrosion resistance of the electrodeposited multimetallic films. FIG. 59 shows a plot of dissolution time of electrodeposited Zn films at 85° C. at open circuit potential versus the Coulombic efficiency of the electrolytes obtained from cyclic voltammetry. The electrolytes were the same as those used to generate the plot of FIG. 58.

TABLE 4

| Example | Composition |
|---|---|
| 1 | 300 mM ZnBr₂_300 mM ZnA 400_NaA_20 mM NiA |
| 2 | 300 mM ZnBr₂_200 mM LiCl_100 mM SnCl2 |
| 3 | 300 mM ZnBr₂_400 mM NaA_100 mM SnCl2 |
| 4 | 300 mM ZnBr₂_200 mM LiDFA_400 mM KA |
| 5 | 300 mM ZnBr₂_200 mM LiDFA_400 mM NaA |
| 6 | 300 mM ZnBr₂_400 mM LiA_400 mM NaA |
| 7 | 300 mM ZnBr₂_400 mM LiA_400 mM NaA |
| 8 | 300 mM ZnBr₂_400 mM LiA_400 mM LiBr |
| 9 | 300 mM ZnBr₂_200 mM LiDFA_400 mM KA |
| 10 | 300 mM ZnBr₂_200 mM LiDFA_400 mM NaA |
| 11 | 300 mM ZnBr₂_400 mM LiA_400 mM LiBr |
| 12 | 300 mM ZnBr₂_400 mM LiA_400 mM LiCl |
| 13 | 300 mM ZnBr₂_300 mM LiDFA_400 mM LiA_2.6 mM NiA |
| 14 | 300 mM ZnBr₂_300 mM LiDFA_400 mM LiA_2.6 mM NiA_0.2% PVP |
| 15 | 300 mM ZnBr₂_300 mM LiDFA_400 mM LiA_2.6 mM NiA_0.2% PVP |
| 16 | 300 mM ZnBr₂_300 mM LiDFA_400 mM LiA_2.6 mM NiA_0.2% PVP |
| 17 | 300 mM ZnBr₂_300 mM LiDFA_400 mM LiA_2.6 mM NiA_0.2% PVP_1% HEC |
| 18 | 300 mM ZnBr₂_300 mM LiDFA_400 mM LiA_1.3 mM NiA_1% PVP |
| 19 | 300 mM ZnBr₂_300 mM LiDFA_400 mM LiA_1.3 mM NiA_0.5% HEC |
| 20 | 300 ZnBr₂_300 mM LiDFA_400 mM NaA_1.3 mM NiA_1% PVP |
| 21 | 300 ZnBr₂_300 mM LiDFA_400 mM NaA_1.3 mM NiA_1% HEC |
| 22 | 300 ZnBr₂_300 mM LiDFA_400 mM LiA_1.3 mM NiA_1% HEC |
| 23 | 300 mM ZnBr₂_200 mM LiDFAc_400 mM NaA_2.6 mM CoCl₂ |
| 24 | 300 mM ZnBr₂_300 mM LiAc_400 mM NaAc_2.6 mM NiA |
| 25 | 300 mM ZnBr₂_300 mM LiDFAc_400 mM NaAc_2.6 mM NiA |
| 26 | 300 mM ZnBr₂_300 mM LiTFAc_400 mM NaAc_2.6 mM NiA |
| 27 | 300 mM ZnBr₂_200 mM LiTFA_400 mM NaA |
| 28 | 300 mM ZnBr₂_200 mM LiTFA_400 mM LiA |
| 29 | 300 mM ZnBr₂_300 mM ZnA_400 mM NaA_30% PVP |
| 30 | 300 mM ZnBr₂_300 mM ZnA_400 mM NaA_5% PVDF |
| 31 | 300 mM ZnBr₂_300 mM ZnA_400 mM NaA_15% PVA |
| 32 | 300 mM ZnBr₂_300 mM ZnA_400 mM Li TFAc |
| 33 | 300 mM ZnBr₂_300 mM ZnA_200 mM LiTFA_200 mM LiA |
| 34 | 300 mM ZnBr₂_300 mM LiTFA_400 mM LiAc |
| 35 | 300 mM ZnBr₂_300 mM ZnA 400 mM NaA_2.6 mM MnCl₂ |
| 36 | 300 mM ZnBr₂_200 mM LiTFA 400 mM LiA_2.6 mM MnCl₂ |
| 37 | 300 mM ZnBr₂_300 mM ZnA 400 mM NaA |
| 38 | 300 mM ZnBr₂_300 mM Zn Acetate_400 mM Na Acetate _2.6 mM CoCl₂ |
| 39 | 300 mM ZnBr₂_300 mM Zn Acetate_400 mM Na Acetate _2.6 mM InCl₃ |
| 40 | 300 mM ZnBr₂_300 mM Zn Acetate_400 mM Na Acetate _2.6 mM AlCl₃ |
| 41 | 300 mM ZnBr₂_300 mM Zn Acetate_400 mM Na Acetate _2.6 mM MnCl₂ |
| 42 | 300 mM ZnBr₂_300 mM Zn Acetate_400 mM Na Acetate _2.6 mM MnCl₂ |
| 43 | 300 mM ZnBr₂_300 mM Zn Acetate_400 mM Na Acetate _2.6 mM SnCl₂ |
| 44 | 300 mM ZnBr₂_300 mM Zn Acetate_400 mM Na Acetate _2.6 mM NiAcetate |
| 45 | 300 mM ZnBr₂_300 mM Zn Acetate_400 mM Na Acetate _2.6 mM NiCl₂ |
| 46 | 300 mM ZnBr₂_300 mM Zn Acetate_400 mM Na Acetate _2.6 mM SnCl₂_2.6 mM NiA |
| 47 | 300 mM ZnBr₂_300 mM Zn Acetate_400 mM Na Acetate _2.6 mM MnCl₂_2.6 mM NiA |
| 48 | 300 mM ZnBr₂_300 mM Zn Acetate_400 mM Na Acetate _2.6 mM MnCl₂_2.6 mM SnCl2 |
| 49 | 300 mM ZnBr₂_300 mM Zn Acetate_400 mM Na Acetate _2.6 mM SnCl₂_2.6 mM InCl3 |
| 50 | 300 mM ZnBr₂_200 mM LiTFA_400 mM Li Formate |
| 51 | 300 mM ZnBr₂_200 mM LiTFA_400 mM LiFrm_2.6 mM NiA |
| 52 | 300 mM ZnBr₂_200 mM LiTFA_400 mM LiFrm_2.6 mM InCl₃ |
| 53 | 300 mM ZnBr₂_200 mM LiTFA_400 mM LiFrm_10 mM AlCl₃ |
| 54 | 300 mM ZnBr₂_200 mM LiTFA_400 mM LiFrm_2.6 mM AlCl₃ |
| 55 | 300 mM ZnBr₂_200 mM LiTFA_400 mM LiFrm_2.6 mM CoCl₂ |
| 56 | 300 mM ZnBr₂_200 mM LiTFA_400 mM LiFrm_2.6 mM MnCl₂ |
| 57 | 300 mM ZnBr₂_200 mM LiTFA_400 mM LiFrm_2.6 mM NiCl₂ |
| 58 | 300 mM ZnBr₂_200 mM LiTFA_400 mM LiFrm_2.6 mM SnCl₂ |
| 59 | 300 mM ZnBr₂_200 mM LiTFA_400 mM LiFrm_2.6 mM InAc |
| 60 | 300 mM ZnBr₂_200 mM LiTFA_400 mM LiFrm_2.6 mM InAc |
| 61 | 300 mM ZnBr₂_200 mM LiTFA_400 mM LiFrm_2.6 mM NiA_2.6 mM MnCl₂ |
| 62 | 300 mM ZnBr₂_200 mM LiTFA_400 mM LiFrm_2.6 mM SnCl₂_2.6 mM MnCl₂ |
| 63 | 300 mM ZnBr₂_200 mM LiTFA_400 mM LiFrm_2.6 mM SnCl₂_2.6 mM InCl₃ |
| 64 | 300 mM ZnBr₂_200 mM LiTFA_400 mM LiFrm_2.6 mM SnCl₂_2.6NiA |
| 65 | 300 mM ZnBr₂_200 mM LiTFA_400 mM LiFrm_2.6 mM SnCl₂_2.6 mM InAc |
| 66 | 300 mM ZnBr₂_200 mM LiTFA_400 mM LiFrm_2.6 mM SnCl₂_2.6 mM AlCl₃ |
| 67 | 300 mM ZnBr₂_200 mM LiTFA_400 mM LiFrm_2.6 mM MnCl₂_2.6 mM InAc |
| 68 | 300 mM ZnBr₂_200 mM LiTFA_400 mM LiFrm_2.6 mM MnCl₂_2.6 mM InCl₃ |
| 69 | 300 mM ZnBr₂_200 mM LiTFA_400 mM LiA |
| 70 | 300 mM ZnBr₂_200 mM LiTFA_400 mM LiA |
| 71 | 300 mM ZnBr₂_300 mM LiTFA_400 mM Li Ac_4% PVA |
| 72 | 300 mM ZnBr₂_300 mM LiTFA_400 mM Li triflate |
| 73 | 300 mM ZnBr₂_300 mM ZnA_400 mM NaA |
| 74 | 300 mM ZnBr₂ + 300 mM ZnA + 400 mM NaAc + 2.6 mM BCl₃ |
| 75 | 300 mM ZnBr₂ + 300 mM ZnA + 400 mM NaAc_2.6 mM AlCl₃ |
| 76 | 300 mM ZnBr₂ + 300 mM ZnA + 400 mM NaAc + 2.6 mM GaCl₃ |
| 77 | 300 mM ZnBr₂ + 300 mM ZnA + 400 mM NaAc _2.6 mM InCl₃ |
| 78 | 300 mM ZnBr₂ + 300 mM ZnA + 400 mM NaAc + 2.6 mM TiCl₄ |
| 79 | 300 mM ZnBr₂ + + 200 mM LiTFA + 400 mM LiFrm + 2.6 mM BCl₃ |
| 80 | 300 mM ZnBr₂ + 200 mM LiTFA + 400 mM LiFrm + 2.6 mM GaCl₃ |
| 81 | 300 mM ZnBr₂_200 mM LiTFA_400 mM LiFrm_2.6 mM InCl₃ |
| 82 | 300 mM ZnBr₂ + 200 mM LiTFA + 400 mM LiFrm + 2.6 mM TiCl₄ |
| 83 | 300 mM ZnBr₂ + 300 mM ZnAc + 400 mM NaAc + 2.6 mM FeAc |

“A” and/or “Ac” = Acetate
Frm = Formate
TFA = trifluoroacetate
DFA and DFAc = difluoroacetate

TABLE 5

| | Time (h) at 85° C. in | Time (h) at 85° C. in |
|---|---|---|
| Electrolyte combination | Regular DMSO | Treated DMSO |
| 300 mM ZnBr₂_400 mM LiCl_400 mM LiA | 11 h | 24 h |
| 300 mM ZnBr₂_200 mM LiDFA_400 mM LiA | 2 h | 13 h |
| 300 mM ZnBr₂_400 mM LiDFA_400 mM LiA | 2.5 h | 18 h |
| 300 mM ZnBr₂_200 mM LiCl_20 mM NiA | ~24 h | 30 h |
| 300 mM ZnBr₂_200 mM LiDFA_400 mM NaA_10 | ~24 h | 26 h |
| mM NiA | | |
| 300 mM ZnBr₂_200 mM LiDFA_100 mM ZnA_10 mM | 16 h | 21 h |
| NiA | | |
| 300 mM ZnBr₂_200 mM LiDFA_400 mM | 5 h | 17 h |
| LiA_0.5% HEC | | |
| 300 mM ZnBr₂_300 mM LiDFA_400 mM LiA_2.6 mM | ~14 h | ~23 h |
| NiA_0.5% PVP_0.1% HEC | | |
| 300 mM ZnBr₂_300 mM ZnA_400NaA_20 mM NiA | ~24 h | 26 h |
| 300 mM ZnBr₂_300 mM ZnA_400 mM NaA | 4 h | 13 h |
| 300 mM ZnBr₂_300 mM ZnA_400 mM | ~6 h | ~15 h |
| NaA_0.5% PVP | | |
| 300 mM ZnBr₂_300 mM ZnA_400 mM NaA_2.6 mM | ~13 h | ~24 h |
| NiA | | |
| 300 mM ZnBr₂_300 mM ZnA_400 mM NaA_2.6 mM | ~17 h | ~25 h |
| NiA_0.5% PVP | | |
| 300 mM ZnBr₂_300 mM ZnA_400 mM NaA_2 mM | ~4 h | |
| CoCl₂ (hydrous) | | |
| 300 mM ZnBr₂_300 mM ZnA_400 mM NaA_5 mM | ~6 h | |
| CoAcetate (hydrous) | | |
| 300 mM ZnBr₂_300 mM ZnA_400 mM NaA_2 mM | 5 h 20 minutes | ~10 h |
| CoCl₂ | | |
| 300 mM ZnBr₂_300 mM LiDFA_400 mM NaA_10 | | ~19 h |
| mM CoCl₂ | | |
| 300 mM ZnBr₂_200 mM LiDFA_400 mM NaA_2.6 | | ~15 h |
| mM CoCl₂ | | |

In view of the many possible embodiments to which the principles of the present disclosure may be applied, it should be recognized that the illustrated embodiments are only preferred examples of the present disclosure and should not be taken as limiting the scope of the disclosure. Rather, the scope is defined by the following claims. We therefore claim as our invention all that comes within the scope and spirit of these claims.

We claim:

1. An optoelectronically dynamic element, comprising:
a transparent working electrode comprising a first working electrode surface and a second working electrode surface;
a counter electrode comprising a metal and a first counter electrode surface and a second counter electrode surface; and
a non-aqueous zinc-based electrolyte positioned between the first working electrode surface and the first counter electrode surface, the non-aqueous zinc-based electrolyte comprising (i) a polar aprotic solvent and (ii) a zinc salt and/or ions thereof,
wherein (i) the first working electrode surface faces the first counter electrode surface, and (ii) wherein the transparent working electrode comprises an opaque zinc-containing coating deposited directly or indirectly on the first working electrode surface when a voltage ranging from −3.0V to −0.1V is applied to the optoelectronically dynamic element.

2. The optoelectronically dynamic element of claim 1, wherein at least a portion of the opaque zinc-containing coating disassociates from the first working electrode surface when a voltage ranging from +0.1V to +2.0V is applied to the optoelectronically dynamic element.

3. The optoelectronically dynamic element of claim 1, wherein the non-aqueous zinc-based electrolyte comprises a second metal salt comprising lithium, sodium, potassium, iron, nickel, tin, aluminum, cobalt, manganese, gallium, titanium, indium, boron; any ions thereof; and/or or any combination thereof.

4. The optoelectronically dynamic element of claim 1, wherein the second metal salt is selected from lithium chloride, nickel acetate, tin chloride, sodium acetate, lithium difluoroacetate, potassium acetate, lithium acetate, lithium bromide, sodium fluoride, cobalt chloride, cobalt acetate, lithium trifluoroacetate, manganese chloride, indium chloride, aluminum chloride, nickel chloride, indium acetate, boron trichloride, gallium chloride, titanium chloride, or any combination thereof.

5. The optoelectronically dynamic element of claim 3, wherein the opaque zinc-containing coating further comprises indium, manganese, nickel, iron, tin, cobalt, aluminum, or any combination thereof.

6. The optoelectronically dynamic element of claim 1, wherein the zinc salt comprises a counterion selected from a carboxylate ion, a halide ion, a weakly coordinating anion, or any combination thereof.

7. The optoelectronically dynamic element of claim 5, wherein:
the carboxylate ion is selected from formate, acetate, trifluoroacetate, propionate, butyrate, or any combination thereof;
the halide ion is selected from fluoride, chloride, bromide, iodide, or any combination thereof; and/or
the weakly coordinating anion is selected from tetrafluoroborate (BF₄⁻), hexafluorophosphate (PF₆⁻), perchlorate (ClO₄⁻), triflate (CF₃SO₃⁻), or any combination thereof.

8. The optoelectronically dynamic element of claim 1, wherein the non-aqueous zinc-based electrolyte further comprises at least one alkali metal carboxylate salt, wherein an alkali metal of the alkali metal carboxylate salt is selected from lithium, sodium, or potassium.

9. The optoelectronically dynamic element of claim 1, wherein the zinc salt is present in the non-aqueous zinc-based electrolyte at a concentration ranging from 0.01 M to 5.0 M.

10. The optoelectronically dynamic element of claim 1, wherein the working electrode comprises a conductive metal oxide material disposed directly on the first working electrode surface.

11. The optoelectronically dynamic element of claim 10, wherein the opaque zinc-containing coating is deposited directly on the conductive metal oxide material.

12. The optoelectronically dynamic element of claim 10, wherein the conductive metal oxide material is platinum nanoparticle coated indium oxide (Pt-ITO), tin-doped indium oxide (ITO), fluorine-doped tin oxide (FTO), indium zinc oxide (IZO), aluminum-doped zinc oxide (AZO), indium tin zirconium oxide (ITZO), indium gallium oxide (IGO), indium gallium zinc oxide (IGZO), tin oxide (SnO), zinc tin oxide (ZTO), gallium-doped zinc oxide, boron-doped zinc oxide, yttrium-doped zinc oxide, scandium-doped zinc oxide, silicon-doped zinc oxide, germanium-doped zinc oxide, or any combination thereof.

13. The optoelectronically dynamic element of claim 10, wherein the conductive metal oxide material is platinum nanoparticle coated indium oxide (Pt-ITO), aluminum-doped zinc oxide (AZO), tin-doped indium oxide (ITO), or fluorine-doped in oxide (FTO).

14. The optoelectronically dynamic element of claim 10, wherein the conductive metal oxide material is layered on a substrate.

15. The optoelectronically dynamic element of claim 1, wherein the metal of the counter electrode is in the form of a foil, a wire, a metal coated substrate, or a metal alloy.

16. The optoelectronically dynamic element of claim 1, wherein the metal of the counter electrode is zinc.

17. The optoelectronically dynamic element of claim 1, wherein the non-aqueous zinc-based electrolyte further comprises a leveling agent selected from thiourea, cetyltrimethyl ammonium bromide, sodium dodecyl sulfate, or a combination thereof.

18. The optoelectronically dynamic element of claim 1, wherein the polar aprotic solvent is selected from dimethyl sulfoxide (DMSO), dimethylacetamide (DMA), dimethylformamide (DMF), acetonitrile, dimethylpropylene urea (DMPU), ethyl acetate, pyridine, hexamethylphosphoramide (HMPA), hexamethylphosphoric triamide (HMPT), sulfolane, ethyl acetate, dichloromethane, 1,2-dimethoxyethane, 1,1-diethoxyethane, 1,2-diethoxyethane, tetramethylurea, 1-methoxy-2-(2-methoxyethoxy)ethane, 1-ethoxy-2-(2-ethoxyethoxy)ethane, 1,2-bis(2-methoxyethoxy)ethane, bis[2-(2-methoxyethoxy)ethyl] ether, propionitrile, butyronitrile, N-methyl-2-pyrrolidone (NMP), bis(2-ethoxyethyl) ether, bis(2-methoxyethyl) ether, triethylene glycol dimethyl ether, tetraethylene glycol dimethyl ether, or a combination thereof.

19. The optoelectronically dynamic element of claim 1, wherein the polar aprotic solvent is selected from DMSO, DMA, DMF, acetonitrile, propionitrile, butyronitrile, HMPA, bis(2-ethoxyethyl) ether, triethylene glycol dimethyl ether, tetraethylene glycol dimethyl ether, or a combination thereof.

20. The optoelectronically dynamic element of claim 1, wherein the non-aqueous zinc-based electrolyte further comprises an ammonium salt selected from tetramethylammonium chloride, tetrabutylammonium hexafluorophosphate, or a combination thereof.

21. A method of using the optoelectronically dynamic element of claim 1, comprising:
applying a voltage ranging from −3.0V to −0.1V to the optoelectronically dynamic element to form the opaque zinc-containing coating on the transparent working electrode thereby convert the transparent working electrode to a non-transparent working electrode; and
applying a voltage ranging from +0.1V to +2.0V to the optoelectronically dynamic element to remove the opaque zinc-containing coating thereby converting the non-transparent working electrode back to the transparent working electrode.

22. The method of claim 21, wherein the non-transparent working electrode allows less than 0.1% light transmission at 400-750 nm and wherein the transparent working electrode allows at least 80% light transmission at 400-750 nm.

23. The method of claim 21, wherein the transition from the transparent working electrode to forming the non-transparent working electrode takes place in two minutes or less.
